(19) United States
(12) Patent Application Publication
(10) Pub. No.: US 2006/0235714 A1
(43) Pub. Date: Oct. 19, 2006

(54) Enabling flexible scalable delivery of on demand datasets

(76) Inventors: Ronald Emmett Adinolfi, Yardley, PA (US); Edward Patrick Calusinski JR., Bartlett, IL (US); Cornelius Edward Crowley, Morristown, NJ (US); Teresa Anne Glasser, New York, NY (US); Jennifer Susan Gromada, Princeton, NJ (US); Max Hrabrov, Brooklyn, NY (US); Guerney Douglass Holloway Hunt, Yorktown Heights, NY (US); Sugandh Mehta, Wayne, NJ (US); Francis Nicholas Parr, New York, NY (US); Matthew Adam Rice, Medway, MA (US)

Correspondence Address: David Aker, 23 Southern Road, Hartsdale, NY, 10530, US

(21) Appl. No.: 11/318,426

(22) Filed: Dec. 22, 2005

Related U.S. Application Data
(60) Provisional application No. 60/644,045, filed on Jan. 14, 2005.
(60) Provisional application No. 60/648,497, filed on Jan. 31, 2005.
(60) Provisional application No. 60/654,376, filed on Feb. 18, 2005.
(60) Provisional application No. 60/694,815, filed on Jun. 28, 2005.

(51) Int. Cl. G06Q 99/00

(52) U.S. Cl. 705/1

(57) ABSTRACT

A method, apparatus and software for responding to a request for an on demand dataset by configuring and then executing a workflow process tailored to the requester's needs. The generated workflow gathers identified information from a repository, organizes its format and delivers it to the requester. The on demand dataset request specification is structured to allow independent specification of (1) data to be included, (2) policy on which value sources to use; (3) delivery mode—including real-time, batched, and one-time query modes, (4) output format, and (5) delivery and communications protocols and other on demand dataset properties. This separation of concerns allows a wide variety of on demand data set requirements from different requesters to be met. Delivery of information from an outsourced multi-source multi-tenant data repository to its tenants is a context in which the method is useful.

### PRIORITY

This application claims priority, under 35 U.S.C. §119(e), from provisional application Ser. No. 60/644,045 filed on Jan. 14, 2005; Ser. No. 60/648,497 filed on Jan. 31, 2005; Ser. No. 60/654,376 filed on Feb. 18, 2005; and Ser. No. 60/694,815 filed on Jun. 28, 2005. These applications are incorporated herein by reference in entirety, for all purposes.

### CROSS REFERENCE TO RELATED APPLICATIONS

This application is related to applications assigned to the same assignee as the present invention having attorney docket numbers YOR920040645US2, YOR920040646US2, and YOR920040647US2, filed of even date herewith, and incorporated herein by reference.

### FIELD OF INVENTION

This invention is directed to the field of data management utility services, and more particularly to enabling on demand receipt, cleansing, enhancement, storage, tracking and provision of business data in the context of a multi-source multi-tenant data utility. More specifically, it is directed to flexible, scalable delivery of on demand data sets.

### BACKGROUND

Financial markets reference data includes the descriptive information about financial instruments, market evaluations, interested parties, and the corporate actions that impact financial instruments. Reference data forms the shared basis for financial transaction processing, decision making, risk measurement, instrument and portfolio pricing, and the functioning of financial markets trading operations. Included are thousands of data items, ranging from name and address information and tax identification to contingent claim schedules, transfer agent details, depository eligibility and tax treaty implications. One of the problems the industry faces is the absence of standards in naming, extending to how the different types of reference data are described. Financial instrument data comprises the items that describe what the instrument is, when, how and where it is traded, what is needed to settle and clear transactions in the instrument, and the various regulatory and client reporting requirements. Included in the alternate labels for financial instrument data are securities instrument data, product data, and indicative data (indicative is also use by some as a term to refer to indicative pricing data). Party data describes entities involved in financial transactions, e.g. corporations, counterparties, clients, trading partners and individual investors. Included in the alternate labels for party data is business data, legal entity hierarchy data, client data, and counter party data. Corporate actions data reflects changes that are made to the legal structure or financial instruments of a corporation, such as ownership changes or stock splits. Here again alternate include corporate events and mandated events.

Financial market reference data may define characteristics of public entities, such as stock quotes, financial instrument definitions, corporate address and press releases, or of private entities including client identification, model-derived analytics and risk calculations.

Firms acquire reference data either by delivery via an exchange or data services vendor or by derivation through the application of calculations or models. Firms needing this data typically contract with a number of data vendors and pay licensing fees for access to the vendor's product. In addition to the capture and provision of raw data, many firms, including financial services firms, specialize in the creation of analytic data that is in turn propagated through the industry.

Financial markets reference data is horizontally embedded throughout the lifecycle of business processes conducted by financial firms and, as such, timely, accurate, high quality reference data has great value to these firms. Without it, a firm would be unable to process even the simplest of transactions for their clients or their internal financial management processes.

As an example, for a trade to be executed completely and accurately between financial organizations, all parties to the trade must have equivalent views of relevant reference data. A stock trade requires agreement on: (1) the definition and description of the instrument being traded; (2) the details of the trade and formal documentation of the transaction; and (3) counterparties participating in the process and delivery instructions. Organizations with incompatible reference data will require additional time and resources to resolve differences on each affected trade execution. The need for agreement on reference data is heightened in automated trading environments and during high trading volume periods.

Consequently, each financial firm requires ready access to a high quality reference database, where base reference data may be augmented with the results of higher level analytic and pricing computations and additional information, such as contact details and account information. This information must be in a format that is easily and fully integrated across their portfolio of business applications. Historically, firms have each built and maintained their own stores of information or data in isolation from other firms. As firms grow, whether organically or through acquisition, additional data silos are established or acquired. These databases are typically maintained through a combination of automated data feeds from external vendors, internal applications, and manual entries and adjustments.

Advances in technology and the availability of vendor data sources have significantly increased the amount of information available to firms. As a result, firms have to sift through large amounts of information that might differ depending on the source and timing of the updates.

The fragmented ingestion and maintenance of financial markets reference data, decentralized approaches to data management, multiple or redundant quality assurance activities, and duplicative data stores have led to increased costs and operational inefficiency in the acquisition and maintenance of reference data. Thus, at the corporate level, the data management challenge is one of cost and quality arising from the overwhelming quantity of data. Redundant purchases and validation, different formats/tools, inconsistent formats/standards/data, and difficulties in changing and/or managing vendors all contribute to inefficiencies.

This could cause decisions to be made on inaccurate information or differences in data used by trading counterparties. These impacts are clearly exemplified in the findings of the Tower Group resulting from their 2002 study of reference data in financial markets. For example, in the area of trades processing, where on average, 16.4% of trades are rejected from automated processing routines, Tower Group found that 45% of the exceptions (e.g. trades rejected from automated processing routines) are due to faulty (incomplete, nonstandard, or inaccurate) reference data (“TowerGroup Survey: Is the Securities Industry Making Progress on Reference Data Management?” September 2002). In fact, failed trades resulting from inaccurate reconciliation cost the domestic securities industry in excess of $ 100 million per year (IBM Institute for Business Value analysis). Although reference data comprise a minority of the data elements in trade record, problems with the accuracy of this data contribute to a disproportionate number of exceptions, clearly degrading straight through processing (STP) rates.

Data inconsistency encountered by financial firms is discernable as erroneous or inconsistent information. In many cases, data provided by external vendors contains errors, a fact which a company may uncover by comparing data from multiple vendors or which may be revealed as the result of using this data in an internal business process or in a transaction with an external entity. Each data vendor has proprietary ways of representing data, due largely to a lack of industry standards governing the representation of data. As well, financial services firms utilize a variety of formats, including vendor or exchange-specific and proprietary definitions, to define data within the enterprise.

While various data standardization initiatives are underway across the industry to agree on standards for some data, none of the initiatives are mature. Although financial services firms could realize significant improvements in transaction processing efficiencies from the implementation of clear data standards, both vendors and securities firms have historically viewed the anticipated retrofitting or adapting of existing applications to accept new data formats as an impediment to widespread adoption.

Due to the overwhelming quantity and uneven quality of financial market data, financial firms are obligated to commit significant attention and resources to the management of data that, in many cases, provides them with no discernable competitive advantage.

In addition, recent regulatory changes require firms to store and track financial information more diligently. For example, the Sarbanes-Oxley Act specifies strict requirements on the transfer of information between financial services businesses, even within the departments of a single firm.

As an industry, inconsistent levels of quality and lack of standards for financial markets reference data reduce the efficiency and accuracy of communications between firms, resulting in increased costs and higher levels of risk for all transaction participants. When compounded by the multiple number of parties involved in the end-to-end execution of a financial transaction, it is apparent that issues of data quality and standardization have tremendous detrimental impact on the ability of the financial services industry to accomplish straight through processing to a significant degree. The effect of this complexity is exacerbated by the increasingly international scope of the business, as issues of cross-border sovereignty; regulation and currency introduce incremental data elements as well as additional variations of existing data.

All of these factors are providing additional impetus for financial firms to seek automated assistance in gathering high quality data, tracking origin and data modification history, as well as storing and managing access to that data and any additional information that may have been created using the data.

Within financial services there are many current practices employed in organizing and maintaining high quality reference data. Historically, firms have each built and maintained their own stores of information or data in isolation from other firms.

Financial instrument descriptions and associated data are generally stored in databases referred to as the Product or Security Master File. Party and customer data are generally stored in databases referred to as the Customer Master File. A majority of Security and Customer master files are similar in nature and content across firms.

Many financial service firms currently have decentralized, often incompatible, and fragmented data stores. As firms grow, whether organically or through acquisition, additional data silos are established or acquired. These data silos are populated by a variety of data from multiple vendors through efforts that are rarely coordinated. A lack of enterprise-wide integration prevents many business functions from fully realizing the value of much in-house data. Further, this decentralized approach to data management frequently produces redundant stores of identical data that are often created and updated by duplicate data feeds paid for by separate organizations within a firm.

As a result of attempts to address such data management problems, some support for data management outsourcing is available in the marketplace as a service to individual clients. Some specific reference data management components, including repositories, are available as well. However the current state-of-the-art of these offerings is:
applicable only to a particular subset of reference data;
not developed with multi-tenancy/multi-client support in mind;
delivered as a one-off service to a single client; or
implemented and priced as a stand-alone service for a single client.

Yet, a large portion of the work performed by, or on behalf of the above mentioned organizations to manage their reference data, is in fact rather generic. As such, a lot of effort associated with reference data management is duplicated across the financial industry sector, as well as other industries. There remains therefore a need to establish a multi-tenant reference data utility which could provide best practice data management and processing and reduce costs to individual organizations through economies of scale. However, the technology to build such a utility while properly dealing with certain complexities inherent in the centralized utility approach (such as multi-source multi-tenant entitlement management) is not currently available in the marketplace, and only single-client, localized approaches exist.

Specific examples of localized technologies applicable include:
standardization of base reference data model within one organization for use by its internal departments;
models and standardized formats for particular areas of financial reference data; and
tools and automation to assist the entry of data into a data model for use by a single organization.

There are a number of companies with existing technology and services offerings in the financial services reference data management area which use this localized approach. The solutions that these companies offer are generally targeted at solving the reference data management problem of a single enterprise or a department within an enterprise, usually within the domain of a narrowly defined problem. The software and services they provide are normally installed, configured, customized and operated for a single client/department. As a result, each customer implementation is effectively a dedicated, custom product installation. As such, these offerings may be considered individual solutions to internal reference data management problems and cannot provide economies of scale at the same level that a multi-tenant capable solution can. Further, these solutions do not provide the additional benefits afforded by a shared utility environment, such as turn-key data vendor switching, on-demand billing, leveraged human capital, etc.

Isolated attempts have been made to use single client solutions to support multi-client installations. However, in prior art, leveraging these solutions for multiple clients has essentially required multiple duplication of single-client operations. These attempts have generally not been successful within the financial services industry.

### SUMMARY OF THE INVENTION

One aspect of the invention is directed to an information delivery method for satisfying at least one on-demand dataset request, comprising: processing the at least one on-demand dataset request from at least one requester; producing at least one parsed on-demand dataset request specification; configuring at least one on demand dataset production process to produce at least one on-demand dataset satisfying the at least one on-demand dataset request; and executing the at least one on demand dataset production process to return the at least one on-demand dataset to the at least one requester; wherein the on-demand dataset is limited to data derived from sources and data enhancements to which the requester is entitled.

The on demand dataset request can comprise at least one on demand dataset request specification enabling the requester to specify characteristics taken from a group of characteristics comprising: information items to be returned; selection of information items to be returned; sourcing preference to select between alternate available values; delivery mode; delivery timing; transport protocol; transport protocol ports; security tokens; preferred data format; data transformation rules; custom functions to be invoked; custom filtering rules; exception handling instructions; annotation instructions; data delivery feedback mechanism instructions; delivery endpoint; delivery intermediaries; metadata handling instructions; logging instructions; routing instructions; data merging instructions; and data splitting instructions. The method can further comprise receiving information assembled in an on demand dataset from a multi-source multi-tenant data repository.

The at least one requester can be taken from a group of requesters comprising: a tenant of a multi-source multi-tenant repository; an agent acting on behalf of the tenant; an agent acting on behalf of the repository; a program acting on behalf of the repository; and a program acting on behalf of the tenant.

The method can further comprising using a delivery mode to deliver the at least one on demand dataset, the delivery mode including at least one delivery modality from a group of delivery modalities comprising: quasi real time delivery; scheduled batch delivery; datamart delivery; one time query delivery; e-mail delivery; fax delivery; online delivery; printed hard copy delivery; automated voice delivery; magnetic tape delivery; optical disc delivery; digital media delivery; video delivery; and condition triggered delivery.

The configuring of the at least one on demand dataset production process can be enabled by employing at least one activity building block for separable steps of the at least one on demand dataset production process.

The at least one activity building block can be taken from a collection of activity building blocks wherein each block enables at least one function taken from a group of functions comprising: information element selection; sourcing selection; entitlement enforcement; data assembly; delivery scheduling; transfer protocol handling; standard format transformation; database load; custom data transformation; logging; function execution; filtering; annotating; routing; data splitting; data merging; and data transmission.

The configuring of at least one on demand dataset production process can comprise: employing the at least one parsed on demand dataset request specification; selecting at least one activity building block for inclusion in the on demand dataset production process, wherein the at least one activity building block satisfies at least one characteristic of the at least one parsed on demand dataset request specification; parameterizing any selected activity building block with execution parameters; and assembling selected parameterized activity blocks into the at least one on demand dataset production process.

The executing of the on demand dataset production process can include at least one step taken from a group of steps comprising: executing logic of an assembly flow included within the on demand dataset production process; executing each parameterized activity building block of the on demand dataset production process as many times as indicated by the logic; transmitting the at least one on demand dataset to the at least one requester; recording aspects of actions taken in response to the at least one request to enable repetition of the step of executing at a later time; and logging at least one aspect of delivery taken from a group of aspects. The aspects can include: time of delivery; date of delivery; contents of delivery; requester of the delivery; mode of the delivery; size of the delivery; execution time of the delivery process; identifier of the delivery; any error of the delivery process; any warning of the delivery process; success of the delivery process; feedback of the delivery process; non-repudiation information associated with the delivery process; security features of the delivery; and the at least one on demand dataset request.

The on demand dataset request can be initiated by an action taken from a group of actions comprising: a manually initiated request; an automatically initiated request; a one-time request; a data arrival event; a data availability event; a data deletion event; a data change event; a data temporal event; a scheduled request; a request received through an intermediary; and an on-line initiated request.

Significantly, the method is scalable to permit delivery of information via multiple delivery requests from multiple requesters. The method can utilize automated handling of information delivery requests, and can be specifically configured for needs of each delivery request.

The invention is also directed to a method for returning reference data from a multi-source multi-tenant data repository in response to requests from requesters, comprising: receiving at least one request from a requester; parsing the at least one request to extract the request specification; configuring at least one workflow to deliver the requested reference data based on entitlements of the requester, as well as the selection criteria, sourcing preferences and other preferences contained in requester's request; and executing the workflow and delivering the requested reference data to the requester.

The request specification includes at least one preference taken from a group of preferences comprising: selection criteria; sourcing preferences; data format preferences; delivery transport preferences; and preferences particular to the requester.

The configuring can include at least one action taken from a group of actions comprising: retrieving the requested reference data; filtering the requested reference data; and formatting the requested reference data.

The invention is also directed to an article of manufacture comprising a computer usable medium having computer readable program code means embodied therein for causing information processing, the computer readable program code means in the article of manufacture comprising computer readable program code means for causing a computer to effect the any or all of the methods mentioned above and described in more detail below.

The invention is also directed to an information processing apparatus for satisfying at least one on demand dataset request, comprising: a processor for processing the at least one on demand dataset request from at least one requester; a computer program component executable for producing at least one parsed on demand dataset request specification; a program configuration means for configuring at least one on demand dataset production process to produce at least one on-demand dataset satisfying the at least one on demand dataset request; and computer code for executing the at least one on demand dataset production process to return the at least one on-demand dataset to the at least one requester; wherein the on-demand dataset is limited to data derived from sources and data enhancements to which the requester is entitled.

The processor processes an on demand dataset request comprises at least one on demand dataset request specification enabling the requester to specify characteristics taken from a group of characteristics comprising: information items to be returned; selection of information items to be returned; sourcing preference to select between alternate available values; delivery mode; delivery timing; transport protocol; transport protocol ports; security tokens; preferred data format; data transformation rules; custom functions to be invoked; custom filtering rules; exception handling instructions; annotation instructions; data delivery feedback mechanism instructions; delivery endpoint; delivery intermediaries; metadata handling instructions; logging instructions; routing instructions; data merging instructions; and data splitting instructions.

In a preferred embodiment, the apparatus further comprises means for receiving information assembled in an on demand dataset from a multi-source multi-tenant data repository.

The apparatus can further comprise means for receiving the on demand dataset request from at least one requester taken from a group of requesters comprising: a tenant of a multi-source multi-tenant repository; an agent acting on behalf of the tenant; an agent acting on behalf of the repository; a program acting on behalf of the repository; and a program acting on behalf of the tenant.

The apparatus can further comprise a delivery component, wherein the delivery component includes at least one delivery modality from a group of delivery modalities comprising: quasi real time delivery; scheduled batch delivery; datamart delivery; one time query delivery; e-mail delivery; fax delivery; online delivery; printed hard copy delivery; automated voice delivery; magnetic tape delivery; optical disc delivery; digital media delivery; video delivery; and condition triggered delivery. =p The apparatus may further comprise at least one activity building block for building separable steps of the at least one on demand dataset production process so as to configure the at least one on demand dataset production process. The at least one activity building block can be taken from a collection of activity building blocks wherein each block enables at least one function taken from a group of functions comprising: information element selection; sourcing selection; entitlement enforcement; data assembly; delivery scheduling; transfer protocol handling; standard format transformation; database load; custom data transformation; logging; function execution; filtering; annotating; routing; data splitting; data merging; and data transmission.

The program configuration means can comprise: means for employing the at least one parsed on demand dataset request specification; means for selecting at least one activity building block for inclusion in the on demand dataset production process, wherein the at least one activity building block satisfies at least one characteristic of the at least one parsed on demand dataset request specification; means for parameterizing a selected activity building block with execution parameters; and means for assembling selected parameterized activity blocks into the at least one on demand dataset production process.

The computer code for executing the on demand dataset production process can include at least one computer code component taken from a group of computer code components, comprising: computer code for executing logic of an assembly flow included within the on demand dataset production process; computer code for executing each parameterized activity building block of the on demand dataset production process as many times as indicated by the logic; computer code for transmitting the at least one on demand dataset to the at least one requester; computer code for recording aspects of actions taken in response to the at least one request to enable repetition of the step of executing at a later time; and computer code for logging at least one aspect of delivery taken from a group of aspects. The aspects can include: time of delivery; date of delivery; contents of delivery; requester of the delivery; mode of the delivery; size of the delivery; execution time of the delivery process; identifier of the delivery; any error of the delivery process; any warning of the delivery process; success of the delivery process; feedback of the delivery process; non-repudiation information associated with the delivery process; security features of the delivery; and the at least one on demand dataset request.

The apparatus can further comprise means for initiating the on demand dataset request in response to an action taken from a group of actions comprising: a manually initiated request; an automatically initiated request; a one-time request; a data arrival event; a data availability event; a data deletion event; a data change event; a data temporal event; a scheduled request; a request received through an intermediary; and an on-line initiated request.

The invention is also directed to an apparatus for returning reference data from a multi-source multi-tenant data repository in response to requests from requesters, comprising: means for receiving at least one request from a requester; means for parsing the at least one request to extract the request specification; means for configuring at least one workflow to deliver the requested reference data based on entitlements of the requester, as well as the selection criteria, sourcing preferences and other preferences contained in requester's request; means for executing the workflow and delivering the requested reference data to the requester; and means for limiting the on-demand dataset to data derived from sources and data enhancements to which the requester is entitled.

The apparatus also can comprise means responsive to the request specification including at least one preference taken from a group of preferences comprising: selection criteria; sourcing preferences; data format preferences; delivery transport preferences; and preferences particular to the requester.

The means for configuring includes at least one means taken from a group of means comprising: means for retrieving the requested reference data; means for filtering the requested reference data; and means for formatting the requested reference data. The invention is also directed to an apparatus for returning reference data from a multi-source multi-tenant data repository in response to requests from requesters, comprising: means for receiving at least one request from a requester; means for parsing the at least one request to extract the request specification; means for configuring at least one workflow to deliver the requested reference data based on entitlements of the requester, as well as the selection criteria, sourcing preferences and other preferences contained in requester's request; and means for executing the workflow and delivering the requested reference data to the requester.

The invention may be used with a multi-source multi-tenant reference data utility delivering high quality reference data in response to requests from clients, implemented using a shared infrastructure, and also providing added value services using the client's reference data. Data cleansing and quality assurance of the received data with full tracking of the sourcing of each value, storage of resulting entity values in a repository which allows retrievals and enforces source based entitlements, and delivery of retrieved data in the form of on demand datasets supporting a wide range of client application needs, may be utilized. An advantageous implementation has additional services for reporting on data quality and usage, a selection of value adding data driven computations and business document storage. By using a shared infrastructure and amortizing the costs of data quality assurance across a plurality of clients, while ensuring that clients only receive values from data sources to which they are licensed, better quality data is delivered at lower cost than other methods currently available.

### BRIEF DESCRIPTION OF THE DRAWINGS

These, and further, aspects, advantages, and features of the invention will be more apparent from the following detailed description of an advantageous embodiment and the appended drawings wherein:

FIG. 1A shows an example component structure of the utility.

FIG. 1B shows example contents of a reference data utility repository.

FIG. 2 shows an example of a top level flow of request processing by the utility.

FIG. 3A shows an example flowchart of processing an arriving source dataset.

FIG. 3B shows an example flowchart of processing client delivery requests.

FIG. 3C shows an example flowchart of processing source, client and entitlement metadata.

FIG. 3D shows an example flowchart of processing value added service requests.

FIG. 3E shows an example flowchart of processing reporting and central service requests.

FIG. 4A shows an example flowchart of processing a data based computation service request.

FIG. 4B shows an example flowchart of processing a business document store or access request.

FIG. 4C shows an example flowchart of processing a business document validation request.

FIG. 4D shows an example flowchart of processing a reference data choreography request.

FIG. 5A shows example types of report from the utility.

FIG. 5B shows example types of utility management service.

FIG. 6 shows scalability, availability and geographic dispersion properties of the utility.

FIG. 7A is an example of a flowchart for managing information and associated source based entitlements in a multi-source multi-tenant data repository.

FIG. 7B is an example of a flow chart for interleaved handling of arriving information, source based entitlements and retrieval requests at the multi-source multi-tenant data repository.

FIG. 8A is an example of an organization of a repository.

FIG. 8B is an example of an organization of an entity in the repository.

FIG. 8C is an example of an organization of item instance within an entity.

FIG. 8D is an example of an organization of a versioned attribute in an item instance.

FIG. 9 is an example of a flowchart for inserting information elements with sourcing annotations into the repository.

FIG. 10 is an example of a flowchart for maintaining source-based entitlement information.

FIG. 11A is an example of a flowchart for responding to requests to return information elements from the repository based on requester preferences.

FIG. 11B is an example of a flowchart interpreting a retrieval request.

FIG. 11C is an example of a flowchart for getting the item and item information selection predicates.

FIG. 11D is an example of a flowchart for locating requested information elements.

FIG. 11E is an example flowchart for enforcing entitlements by filtering retrieved values

FIG. 12A shows an overview of the data acquisition and quality enhancement component.

FIG. 12B shows an overview of cross-source cleansing.

FIG. 13 shows a flowchart of validation, normalization, single-source cleansing and cross-source processing.

FIG. 14 shows a flowchart of validation of a single-source dataset.

FIG. 15 shows a flowchart of normalization of a source input stream.

FIG. 16 shows a flowchart of cleansing of a source input stream.

FIG. 17 shows a flowchart of correcting validation errors.

FIG. 18A shows a flowchart of correcting normalization errors.

FIG. 18B shows a flowchart of correcting cleansing errors.

FIG. 19 shows a flowchart of cross-source processing.

FIG. 20A is a flowchart illustrating producing an on demand dataset in response to an on demand dataset request.

FIG. 20B is a flowchart illustrating steps in the parsing and analysis of an on demand dataset request specification.

FIG. 21A is a flowchart illustrating steps in setup of a customized on demand dataset production process.

FIG. 21B is a flowchart illustrating contents of the library of basic activity building blocks.

FIG. 22A is a flowchart illustrating structure of an on demand dataset request specification.

FIG. 22B is a flowchart illustrating an on demand mode case tree.

FIG. 23A is a flowchart illustrating processing steps in an on demand dataset production process.

FIG. 23B is a flowchart for retrieve values and insert into delivery dataset step.

FIG. 23C is a flowchart for an execute delivery instance step.

### DEFINITIONS

Attribute—An attribute consists of an attribute name and an attribute value. Example: attribute name=“Exchange where traded”; and attribute value=“NYSE”. Each attribute value in an attribute has a single evolutionary history leading to its creation and has at least one source. Within the repository, multiple versions of the same attribute form versioned attributes. In an advantageous embodiment, sourcing and event information about each attribute is stored in the ETSDT of the versioned attribute.

Attribute selection—A list of attributes or a predicate on attribute values, identifying the particular attribute values of the selected repository entity to be returned as the output of the request.

Business document storage service—A service to store business documents in the reference data utility and provide access to them to the owning or to other entitled clients. Each business document may have associated with it validation and data choreography functions which provide added value to clients using the stored business document in their business operations. These added value capabilities can make use of the requesting client's entitled reference data.

Client—A customer of the reference data utility. Each client is associated with tenant of the multi-source multi tenant repository in which data is stored on behalf of multiple clients. A tenant may have one or more clients, each client has a subset of the entitlements of the tenant. Administration of client entitlements it typically left to the tenant, but may be offered as a service by the utility. At any point in time there can be multiple agents or programs acting on behalf of a client and making requests on the reference data utility. Each of these agents is then perceived by the reference utility or by components of the reference data utility as a requester. Requests on behalf of a client are for either the delivery of data, or for the execution of added value services, or for the provision of centralized services such as reporting or customer service. Each client is made visible to the reference data utility via a meta data request defining its properties, authorizations, contract protocols, service level and contract agreements, and data and service entitlements. This information is summarized in the client profile.

Client profile—A set of information characterizing the allowed behaviors and preferences of a reference data utility client. This will typically include information characterizing the identity, authentication procedures, contact protocols, authorizations and authorization update procedure, Service level agreements, billing arrangements, reporting processes, and entitlement update procedures for that client. The set of client profiles is used by the reference data utility to administer and configure data and associated service deliveries for its collection of clients.

Data cleansing—The process of determining for each source dataset whether the arriving items conform to that source dataset's source specification and validating the completeness and correctness of attributes received in each item. Data cleansing comprises: acquisition, item validation, item normalization, source dataset specific item cleansing, and multi-source item instance comparison and value selection.

Data driven computational service—A function or business computation stored in the reference data utility which can be invoked on request from a client of the utility. It is an example of a value-add service which can be provided with a reference data utility. Each data driven computational service has a unique provider who made this service available in the reference data utility. The provider grants entitlements to use the service to some set of clients of the utility. Data driven computational service definitions include data input and output definitions characterizing the reference data they need as input and return as results from each service instance. Instances (invocations) of the data driven computational service execute the service by applying a computation to a particular set of input data provided by the requester and returning a set of output data which becomes the property of the requester and is either delivered to them or stored for them in the repository. On demand data sets are used to insulate the function provider from the specific input and output data transfer and format requirements of each requester. Example: computing a valuation function on a portfolio of complex instruments.

Data driven computational service registry—A directory with descriptions, and access information for all of the data driven computational services which have been made available at this Reference Data Utility by providers. This registry of value-add services has associated entitlement management enforced by the standard entitlement management facilities of the reference data utility so that the provider of a data driven computational service can grant entitlement to execute it to specific clients of the reference data utility. Appropriate SLA, billing and reporting arrangements will be put in place when this is done.

Data driven computational service provider—Any party which has made available at least one data driven computational service in a reference data utility for use by clients of the utility. The provider could itself be a client of the utility making this computational service available to others; it could be an agent of the utility making it available as an added value service to some client or it could be an entirely independent third party. The provider of an added value computational service controls entitlement to it.

Data evolution event—Any event resulting in a change to an information element or source element, including deletion and creation of information elements or source elements. Each event includes, at a minimum, an identifier, a timestamp, at least one source of the event, as well as any agents of the event and sufficient information to correlate the event with the information element or source element to which it pertains. Extended attributes of the data evolution event include various additional identifiers, textual descriptions, classifications, etc. The shorter “event” is also used for the same concept.

Delivery dataset—A block of data delivered at one time to the requester as part of delivery of an on-demand data set. A delivery dataset may be a large or small amount of data.

Delivery instance—The act of transferring a delivery dataset at a point in time to a requester as part of delivering an on-demand dataset.

Entitlement—A requester's right to access and receive information provided by sources and item instance processes. If a particular attribute value was provided by Source X, but appears in an item instance maintained by item instance process P, then a requester is entitled to this item instance attribute value only if entitled both to source X and item instance process P.

Entitlement repository—An information repository which maintains a listing of: all identified requesters, all sources, all item instance processes, and the entitlement of each identified requester to each source and item instance process.

Entity selection—A list of repository entities or a predicate on attributes of repository entities, determining the set of entities for which the request is to return information.

Evolutionarily tracked source data tag (ETSDT)—A collection of information reflecting all events in the history of an entity, item instance or versioned attribute. The ETSDT records version as well as all sources and agents of such events. In an advantageous embodiment, ETSDT's are attached to: each repository entity, each item instance, and each versioned attribute of each item instance. In alternate embodiments, ETSDTs may be grouped, split or attached to alternative information elements.

Information element—One of: a repository entity, an item instance, a versioned attribute, an attribute or a property.

Item instance—Information on all attributes of a repository entity provided from a single source or item instance process. An item instance comprises a collection of versioned attributes. Item instances carry source information identifying the source or item instance process used to create them. Example: description of IBM stock generated by a comparison and selection process based on information from Vendor A, Vendor B, Vendor C. Some item instances are single source, e.g. data from Vendor A on a particular IBM bond. Other item instances are multi-source and created by an item instance process, e.g. data on a particular IBM bond generated by running a comparison process on a set of sources. Entitlements need to be able to grant access both to individual sources and to item instance processes and their generated item instances. Attributes arriving from the same source at different times may lead to: those being considered separate source datasets leading to creation of separate item instances for each such source dataset, and those being considered timed arrivals within the same source dataset hence included as versioned values within a single item instance.

Item instance process—A process used to review, validate, cleanse, filter or select from a dataset, or multiple datasets, yielding item instances; also any processes used to review, validate, cleanse, filter or otherwise affect existing item instances. Item instance processes can reflect a single source process (also referred to as “source-specific” elsewhere in this document), as well as processes that utilize data from multiple sources. Composite item instance processes are also possible; “normalized” and “normalized, single source cleansed” are examples of a simple and composite item instance processes, respectively.

Metadata—Descriptive information about an information element. Examples: Internal identifiers, timestamps, classification information, textual descriptions.

Multi-source multi-tenant data repository—A repository with a plurality of entitlement-granting sources and a plurality of tenants that independently arrange receipt of said entitlements with both sources and the repository owner.

Normalization—For each source item in a source dataset, determining the referred entity about which that item contains information and converting the attributes in the item to be compatible with the target description for the repository entity corresponding to that referred entity. This may include changing the attribute value to a target form.

On-demand dataset—A logical stream of data created and delivered dynamically via a generated customized run-time process in response to an on-demand dataset request. The data in the on-demand dataset comes from information retrieved from a multi-source multi-tenant data repository. The on-demand dataset is delivered as either a single delivery instance or as a sequence of delivery instances.

On demand dataset request—A request to create and deliver an on-demand dataset. The description of the requested data is passed as part of the request.

On demand dataset request specification—The part of an on-demand dataset request that describes the requested data. It describes the contents, sourcing policy, format and delivery specifics of the on-demand dataset.

On demand source—A source of data from which data can be pulled into the reference data utility, usually with input processing, cleansing and quality assurance as it is received, in response to a request for that data from a client of the utility. Once imported into the utility and stored in the utility's multi-source multi tenant repository, the data can be delivered to other entitled clients.

Property—Information that does not require versioning because it is public or otherwise generally available for distribution to all tenants of the repository (such as metadata). Information contained within properties can typically be used to make generic requests against the repository at a level which does not require checking entitlements. A property can apply to a repository entity or an item instance. Example: In response to the inquiry; “How many stocks exist in the repository,” stock is a piece of classification information required. Because it is inherently publicly available data, it can be exposed as a property, rather than a versioned attribute.

Reference Data Utility—A common shared infrastructure used to provide cleansed and enhanced reference information from multiple sources as a service to a collection of clients. It may also provide value-add services and general utility support services along with delivery of reference data. The common shared infrastructure includes a multi-source, multi-tenant repository in which raw and enhanced data is stored; it includes shared input processing data cleansing and enhancement in which the source of all information is tracked; it includes on demand dataset delivery allowing entitled data to be selected, retrieved and delivered to all clients matching their delivery specifications; it includes the provision of value added and centralized services. Clients of the reference data repository are tenants of the multi-source, multi-tenant repository component used to store data for the reference data utility. The term reference data utility is often shortened to utility.

Referred entity—A real world entity described by information stored in the repository. Example: an actual bond issued by IBM, a corporation, a counter party or stock trade.

Repository—A collection of information consisting of: repository entities, value add services and business documents, in which knowledge of the contributing source and evolutionary history of each piece of information in the collection is maintained.

Repository entity—A collection of information stored in the repository describing a single referred entity. A repository entity consists of a set of attributes defining the entity (its metadata, e.g. name, properties) and a collection of item instances each containing additional information on the repository entity added into the repository from an identified source or item instance process. Example: information in the repository characterizing a particular bond issued by IBM, corporation, counter party or stock trade.

Repository owner—An organization or corporate entity that owns a repository and makes the repository data services available to tenants subject to their entitlement agreements with sources and additional entitlements to item instance processes of the repository.

Repository access request—A request for access to information stored in the repository from an identified requester. Information required in processing a repository access request includes requester identification, sourcing preference and selection predicate. May also include entity and attribute selections.

Request specification—Information required in processing a request for information from a multi-source multi-tenant repository. At a minimum, includes requester identification, sourcing preference and selection predicate. May also include entity and attribute selections.

Requester—An agent making a repository access or other request. This agent may be acting on behalf of a client of the repository or may be acting for the repository, or a computer program acting on behalf of one of these parties. The requester responsible for a request needs to be identified so that entitlements can be enforced in responding to the request. Requesters are uniquely identified by a requester identifier.

Selection predicate—Specification of those information elements a requester is interested in receiving in response to a request for information from a multi-source multi-tenant repository. A component of the request specification, it most often refers to repository entities, item instances and versioned attributes.

Source—An identifiable supplier of one or more source datasets each containing information on referred entities. A source may be uniquely identified by its source identifier. Example: Vendor A and Vendor C.

Source accuracy—The frequency with which a source-supplied attribute value coincides with the selected value (recommended value) resulting from some multi-source item instance process. This provides an objective measure of the relative quality of different sources of information to the repository.

Source attribute—Source attributes make up source items in source datasets. See source item definition below. For example, if a source item represents common stock of company X as received from some source, the exchange on which the stock of company X trades is a source attribute. Source attributes are normally represented as name-value pairs.

Source dataset—A collection of source items from a specific identified source; source datasets may become available at a specific point in time, may become available continuously or may be fetched on-demand by a sequence for requests. Example: Vendor A Public Bond Information Service. Source datasets are uniquely identified by a source dataset identifier. The source identifier for the providing source may or may not be part of the source dataset identifier.

Source dataset description—Information describing the structure, content of the source dataset and any constraints on values of attributes appearing in items of the source dataset. The source description is provided by the source responsible for the source dataset.

Source dataset identifier—See the definition of source dataset above.

Source element—a source item or a source attribute.

Source identifier—See the definition of source above.

Source item—Information contained in a single source dataset that describes a particular referred entity. A source item is a collection of source attributes that may include any or all of the attributes of the referred entity.

Source usage—The source usage by a client of a particular source is the number of times that a request from that client results in delivery of information provided by that source. This may be provided as the total usage from each source within some fixed period of time. Note that usage of a source may be explicit or implicit; explicit usage is when this source was selected through a specific requester policy identifying the source; implicit usage is when the preference is for some multi-source item instance and the source was a supplier of the selected value for that item instance.

Source profile—A source profile contains information characterizing the behavior of a data source used by a reference data utility. This will typically include information on the identity, authentication procedures, contact information, authorizations, input formats, source data delivery protocols, data correction protocols, entitlement updates and reporting arrangements for that data source. The reference data utility uses its collection of source profiles to administer and configure input processing and cleansing of data received from all data sources.

Sourcing, sourcing information—A source of data; can be an item instance process (e.g. cross-source comparison and selection process) or a specific data provider (e.g. Vendor A).

Sourcing preference—An ordered list of sources and item instance processes; the requester would prefer that attributes and attributes returned as output from the request come from item instances early in this order. Since the processing of requests by the repository enforces entitlement, a requester will not always receive attributes and values from the first choice source in this list but has partial control of the values selected for return.

Target dataset—Information describing the structure, contents and constraints on repository entity information, including item instances, versioned attributes and attributes as stored in the repository. Note that this is a target description from the perspective of input cleansing only. The clients of the repository may regard the target description as the schema for the repository entities which from their perspective is the provider of their reference information.

Tenant—An organization, individual or corporate entity which arranges to be a user of a reference data utility or more specifically of a repository and may arrange with the utility or repository owner and sources to be entitled to information and services. Tenants may pass on entitlements to identified clients acting on their behalf.

Topic—A repository entity property used for hierarchical organization within the repository. For further granularity, topics may be divided into subtopics. In principle, every repository entity in the data repository is uniquely located in this hierarchical topic space. Example: Financial instrument definitions or corporate ownership hierarchies are examples of topics in a financial reference data repository. The financial instrument definition topic may be decomposed into subtopics such as common stock definitions and bond definitions; within bond definitions further divided into corporate bonds and government backed bonds, and so on.

Value added service—In the context of a reference data utility, an optional service providing added value to clients of the reference data utility which is indirectly related to reference data and takes advantage of capabilities of the base reference data utility. Data driven computational services and business document services are examples of value added services optionally provided with a reference data utility. Clients obtain a value added service by issuing a value added service request to the reference data utility. Examples of value added services usefully provided with a reference data utility include data driven computational services and business document storage services.

Value added service request—A request to the reference data utility from a client to obtain a value added service.

Versioned attribute—A collection of one or more versions of the same attribute, wherein each version was produced by a different source or sources. In an advantageous embodiment, an attribute name and a collection of one or more attribute values. An advantageous embodiment for organizing and storing a versioned attribute in the repository is as a collection of attributes (as defined above) where all attributes in the collection have the same attribute name. This organization allows a versioned attribute to be constructed in the repository by moving or copying attributes from a source dataset into a versioned attribute in an item instance, as well as by adding additional attributes as modified attribute values are created by some value enhancement process. A versioned attribute has an ETSDT in which all events and sources pertaining to attribute values in the versioned attribute are recorded. Hence, multiple “values” (multiple contained attributes in an advantageous embodiment) can exist within a single versioned attribute in an item instance, pertaining either to a value from the same original source that was modified by some item instance process(es), or to a value that was composed or selected from multiple original sources.

### DETAILED DESCRIPTION OF THE INVENTION

General Organization

The invention will be described in four sections each addressing a separate aspect. The first section describes the method and operation of a reference data utility with properties that it is outsourceable, shareable, able to support multiple tenants and multiple sources of data and to enforce entitlement and privacy rights to its contained information. Each source may grant entitlements to information derived from its data to any combination of tenants. The information entitled to each tenant depends on the sources used to derive it and the enhancement processes applied to the source data. The section also describes optional additional document choreography and computational services which can be provided by the reference data utility to increase its value to tenants. In an advantageous embodiment a reference data utility includes such value add services.

The second section describes the structure and methods for forming and operating a repository in which information is stored, access to the stored information is granted to requesters and entitlement rights relating to the source and enhancement processing of the data are enforced by tagging individual data elements with a summary of the history by which they were generated.

In an advantageous embodiment, a reference data utility uses such a repository as an information storage and access method for its reference data.

The third section describes a method and organization for performing scalable data cleansing and enhancement of arriving reference information in which both single data source enhancement processing and multiple data source comparison and enhancement processing are supported while the method still maintains full knowledge of all sources used in deriving reference data elements. In an advantageous embodiment, a reference data utility applies this data cleansing and enhancement processing to arriving information from sources as its input method.

The fourth and final section describes a method and organization for scalable on demand delivery of reference data from a repository to requesting clients in which a wide variety of client needs for different delivery content, format and mode of data delivery are accommodated. In an advantageous embodiment, a reference data utility uses this method to deliver data from the utility to clients associated with tenants of the utility in a scalable manner as its output method.

A. General Structure and Method of Operation of the Reference Data Utility

The invention, in a first major aspect, is a method and novel system organization for forming and maintaining a multi-source multi-tenant reference data utility delivering high quality reference data in response to requests from clients, implemented using a shared infrastructure, and also providing added value services using the client's reference data. An advantageous implementation offers additional services for reporting data quality and usage, a selection of value added data driven computations and business document storage.

The method is effectively an “assembly line approach” to data gathering, quality assurance, storage and delivery of reference data. The ability to support a wide range of client requirements for different topics, sources, qualities, modes and formats, organized as an automated extensible system, provides a valuable service by enabling the expensive but critical human expertise and review functions to be centralized and highly leveraged. The design of the utility allows for the efficient global sourcing of data, affording significant economies of scale. The component structure allows for the efficient global distribution of different functions of the utility, this also enables the ability to substitute components and respond to change as business develops. Clients of the utility receive their reference data from one or more soureces indirectly through the utility which gives them the flexibility to reconfiguring their applications to receive reference data from different sources. Gathering and providing uniform quality assurance of reference data on a broad range of topics in a single utility service increases the likelihood that individual client applications of clients will discover and use the best available reference data values. The maintenance and enforcement of source based entitlements in a multi-source multi-tenant shared repository allows a single shared infrastructure to accommodate multiple tenant organizations, with independent departments and applications both across and within tenant organizations to make their own arrangements to license data from supported sources. The reference data utility assures the data sources, through audit log support, that each client of the utility is receiving values derived only from sources to which they are licensed. This auditable assurance is based on the method providing full transparency of the data for each repository entity value. Full sourcing documentation is available; each delivery of a value to a client is logged, identifying the available value and the user access. Regulatory compliance in handling reference data is an expensive proposition for each individual financial services business; using the reference data utility repository to provide this via a uniform mechanism whose cost is amortized across all client organizations offers cost advantages. A standard reference data source promotes coherence and consistency within the industry.

Delivering reference data through a shared repository, with tracked data sources and access, creates a marketplace in which higher level financial service providers can offer their models to many clients and be assured of receiving reliable usage information for contract enforcement or billing. Clients use these higher level services on data in the repository to which they are entitled, with the assurance that data access rules will be enforced and monitored to assure compliance with data access and transfer regulations.

The reference data utility provides monitoring, reporting and customer service as expected in a utility solution. A valuable point of novelty is that the utility provides an objective measure of the accuracy and quality of different available data sources based on its processes for comparing values for the same attribute from different sources.

The above capabilities are provided in an environment in which the security and privacy of client actions is maintained. No client or data vendor is able to discover information about another's data, queries or other actions taken by the repository to support them.

The reference data utility provides benefit through a centralized governance scheme for access to operations and data within the utility, allowing clients and data vendors appropriate access to update and self manage resources in the utility which are either invisible or appropriately reflected to other actors.

The method is described herein as it applies to reference data used by Financial Services businesses. This method for provisioning a multi-source multi-tenant data repository providing shared access to data used for reference by an organization has many other possible areas of application. Access to consumer credit information, government regulation and registration information, and telecommunications usage information are three additional examples where the method would be useful. Characteristics of contexts where the method will be useful and of reference data are: (1) the information comes from many sources (2) there are multiple users potentially in independent organizations needing access to the same information but potentially with different source entitlement rights (3) the referenced information is accessed by users largely in read-only mode except when they participate in correcting invalid values (4) high quality timely information is both valuable and complex to gather hence the efficiencies from a utility approach, shared infrastructure and shared data quality enhancement provide significant benefit (5) entitlement enforcement and privacy management is provided by the repository. Although the invention is described herein in the context of financial services reference data which is one important area of application, the approach disclosed herein, enabling an effective repository to provide data access meeting the requirements above, will have value in any context with these requirements.

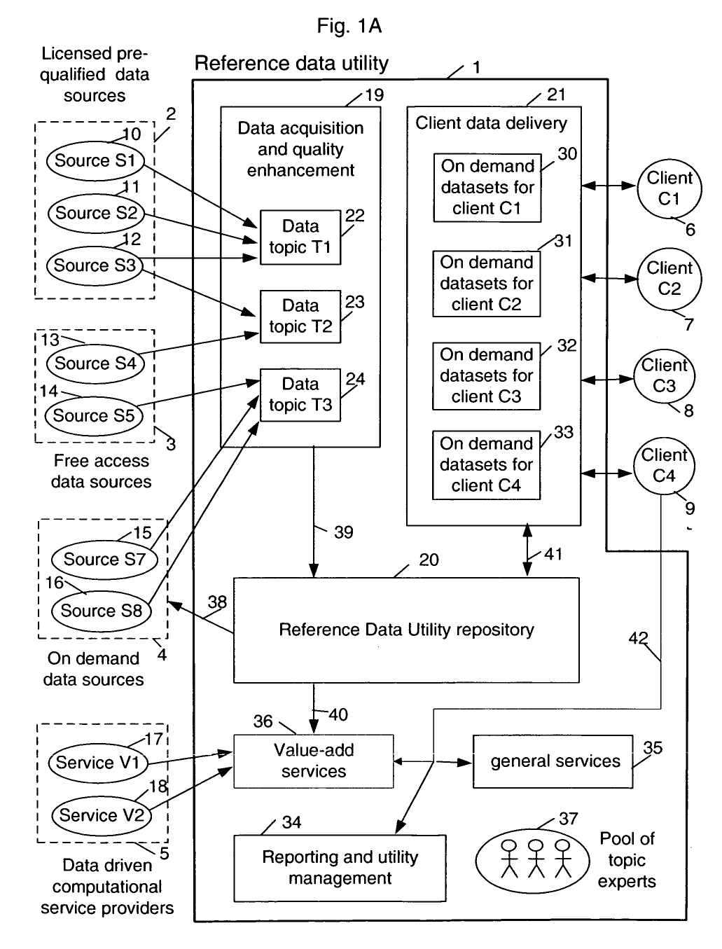

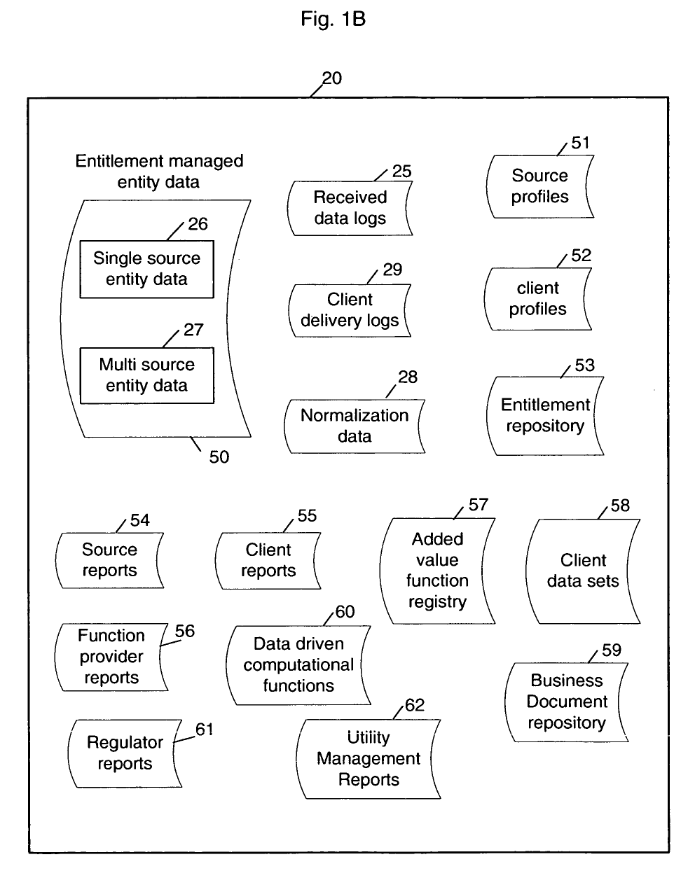

FIG. 1A provides an overview of the major functional units and component structure of the reference data utility and its associated operational environment. In FIG. 1A, polygon 1, delineates the boundaries of the reference data utility. Circles representing clients 6, 7, 8 and 9, of the utility 1, appear on the right. Dashed boxes 2, 3, 4, and 5, representing different types of data and service sources, appear on the left. Reference data utility I can have multiple sources supplying data and other inputs. For illustration purposes FIG. 1A uses seven data sources S1, S2, S3, S4, S5, S7 and S8. These data sources are classified into three types as described below. The number of sources of each type is not limited.

Source S1, source S2 and source S3, shown as ellipses 10, 11, 12 respectively, in box2 of FIG. 1A. represent licensed pre-qualified data sources. The data received from these sources is proprietary. Each source may independently license delivery of its data to clients of the reference data utility 1. As the reference data utility 1 enhances, stores and delivers data derived from these sources, it maintains knowledge of the source of each received data item and of any values derived from it. Furthermore the reference data utility 1 enforces entitlements ensuring that each client receives data only from sources to which it is entitled.

Source S4 and source S5, represented by ellipses 13 and 14, in box 3, are in the unlicensed and public category of raw source data that is continually used and monitored by the reference data utility 1. Because this data is public and unlicensed, no incremental payment for distribution of the values is expected. This information is typically incorporated into the repository 20 ( discussed below) of reference data utility 1, as properties of repository entities rather than entity attributes which are explicitly versioned and tracked. Data in this category can be used freely by the reference data utility 1 to validate or augment other streams of data and values. Source information in this category includes news reports of corporate actions and published registries of financial instrument names and properties. While data in this category does not require tracking in order to enforce entitlements, operators of the utility 1 may also choose to track this type of data for various reasons such as providing auditable sourcing information so that the quality of public sources can be analyzed over time to eliminate public sources of poor quality data.

Source S7 and source S8, represented by ellipses 15 and 16, in box 4, are in the category of on demand data sources providing data that is only fetched on demand as a result of a request from a utility client. Thus, it is distinguished from pushed streams of data received from regular licensed data vendors and from the continuously monitored public data which affects the interpretation of intensively used data in box 3. The definition and pricing information on infrequently traded instruments, such as a bond issued by a local authority or public service organization, is an example of information in the category represented by box 4. When a specific reference data utility client (most often as part of a retail banking operation) requires this information, an action by the repository will request values for that reference item from appropriate sources and perform standard data validation, storage and delivery processing.

Service V1 and service V2, represented by ellipses 17 and 18, in box 5, are a different category of non-data sources providing input to the utility 1. Data driven computational services are made available to the utility 1 by third party providers and are used to add value to clients' data. The reference data utility 1 provides a marketplace to help clients find relevant value added services and manages the execution of data driven computational services on clients' data. A client of the utility can only use entitled services, and a service, while acting on behalf of a client, can only access data to which the client is entitled. As part of this processing, each client use of a service is monitored and recorded by the utility 1. Using this information, the reference data utility 1 can efficiently charge and collect from clients for their data driven computational service usage on behalf of and in conjunction with the service provider. In an alternative embodiment, the utility meters the use of computation services by clients and invoicing and payment are handled by the provider of the service. The utility can mix these two implementations, billing for some computational services and not for others. Higher level value added services are optional. The utility 1 enables their existence. The functions they add to the utility 1 provide significant incremental value for the utility's clients.

Each client 6, 7, 8 and 9 may be an independent enterprise or a department within an enterprise. Each client receives high quality data values from the utility 1 in the form of delivered on demand datasets. Each on demand dataset is either a response to standing subscriptions (representing a sustained interest in regular or quasi real time updates on particular reference item values) or a response to a one-time ad hoc query. Each client will also control how, when, and in what form data values are delivered. In order for the utility to be widely attractive, it is important that wide ranging and flexible data delivery services be defined so that each customer can have data values delivered to them in a convenient format without customized engineering work inside the utility 1. Flexible delivery with customized support embedded into the system structure of utility 1 enables amortization of data costs across many tenants, hence realizing the multi-source multi-tenant data utility 1 as an advantageous system and method.

Boxes 19, 20 and 21 represent the three primary components involved in the flow of data values through the system; from raw data sources through delivery to customers of utility 1. Box 19 represents the data acquisition and quality assurance component responsible for gathering data values into the repository system and assuring the high quality of the data. Box 20 represents the reference data utility repository component responsible for storage and access management of all persistent information needed in the repository. Box 21 represents the delivery component responsible for capturing the on demand dataset request specifications of each requester and constructing the automated delivery procedure to deliver that information.

Inside box 19, the data acquisition and quality enhancement components or boxes 22, 23 and 24, represent the independent input and quality processing for separate data topics T1, T2 and T3, respectively. Each topic can have an arbitrary number of sources providing data for it; a single topic can combine data from any combination of licensed pre-qualified data sources, free access data sources and qualified on demand sources. For example, box 24 indicates that free source S5, ellipse 14, and on demand sources S7, ellipse 15, and S8, ellipse 16, are all supplying data on topic T3. Box 23 is receiving data from pre qualified source S3, ellipse 12, and free source S4, ellipse 13. Box 22 receives data on topic T1 from pre-qualified sources S1, ellipse 10, source S2, ellipse 11 and source S3, ellipse 12. Arrow 39 shows the data received or generated during data acquisition and quality assurance being stored in the repository 20. In order for the reference data utility to enforce source based entitlements to data for its multiple clients, knowledge of all sources contributing to each data value must be maintained through the processing of box 19. The data acquisition and quality enhancement processing of box 19 also supports both single source values, based on analysis of one licensed data source's data describing a referred entity, and multi-source values, obtained by comparing values from multiple sources describing a single referred entity attribute, and selecting a preferred or recommended value from the set.

A method for enabling scalable cleansing and value enhancement of reference data by employing evolutionarily tracked source data tags meeting the above needs is described below.

Generated data to which data acquisition and enhancement processing is applied in box 19 can also arrive as the output of a data driven computational service or as data retrieved from an on demand data source in response to some client request. The types of data that can be stored in the repository are described in FIG. 1B.

Box 21 is the client delivery component; boxes 30, 31, 32 and 33 represent the on demand dataset processing for each client. Specifically, box 30 is the delivery processing for client C1, circle 6, box 31 is the delivery processing for client C2, circle 7, box 32 is the delivery processing for client C3, circle 8, and box 33 is the delivery processing for client C4, circle 9. The reference data utility 1 can have an arbitrary number of clients, concurrently or serially. For illustration purposes four clients C1, C2, C3, C4 are used. For each client, independent processing in response to requests from that client selects values of entities of interest and delivers them via appropriate delivery protocols and transforms. Arrow 41 represents retrieval requests generated as part of on demand dataset processing being presented to the repository 20 of reference data utility 1 and the resulting return of information from where it is stored in the repository 20 of reference data utility 1 for delivery to a client. Thus, arrow 41 shows that repository 20 provides requested reference data values as needed by the client data delivery component (box 21).

Other types of functions are included within the context of the utility. Box 34 represents utility management and report generation services. The report generation service creates one time or periodic reports for clients and data sources. These reports provide information on utilization, delivery summaries, accuracy and similar aspects of service level reporting. Box 35 represents the general client service function which assists clients with operational requests, problem diagnosis, customer questions, concerns or proposed corrections for specific reference values, etc.

Box 36 represents additional value added services offered by the utility 1. This includes data mart hosting and data transform services, data driven computational services applied on request to the clients' data by the utility 1, and business document storage services.

Ellipse 37 represents the pool of human topic experts who provide key decision making for manual processes within the utility 1. The expertise of these people is also likely to be needed to participate in client service functions.

Arrow 39 shows data from the data acquisition and quality enhancement component (box 19) flowing into the repository 20.

Arrow 40 shows that the instances of value add services use reference data entitled to the invoking client while they are running. Arrow 38 shows that the repository 20 will canvas on demand data sources to gather additional information. Arrow 42 shows an example of client invoking the value added services (box 36), reporting and utility management (box34), and general services (box 35) of the reference data utility 1.

FIG. 1B shows an example of information stored in a reference data utility repository. This information includes entitlement managed entity data in box 50. Entitlement managed entity data includes entity data derived from a single source, box 26, and entity values derived from comparisons of multiple sources providing alternate values from which a preferred or recommended value has been selected, box 27. A method for provisioning and maintaining a multi-source multi-tenant data repository with entitlement management based on source tracking of reference data is described below.

Other data elements in FIG. 1B show information maintained in the repository 20 of the reference data utility 1 that is not organized as entitlement managed entity data. Entitlements are maintained and enforced on all of this data as appropriate using access control stored in an entitlement repository shown as data element 53. As noted above, entitlement management of entity data is source based and requires maintaining information on all data sources which have contributed to the derivation of each particular value. For other data in the repository, entitlement management consists of simple access control, using techniques known to the art to record for each object, which clients have access to it and which operations are available to them. The preferred embodiment as shown includes an entitlement repository integrated into the repository 20 of reference data utility 1; an alternate embodiment maintains equivalent information in an independent entitlement repository.

The non-entity data structures stored in the reference data repository with access control provided through the entitlement repository are listed next. Data element 25 represents logs of data as received from the data sources. These logs are maintained for non-repudiation and information source tracing. Data element 29 represents logs of data delivered to clients of the utility 1, recording exactly what values were delivered at what times to each client. The client delivery logs are maintained for audit, transparency, regulation compliance and billing purposes. Data element 28 represents the normalization tables and metadata used to combine input from independent sources and to determine when information from multiple sources is describing a single referred entity. Rules associated with cleansing, normalization, and validation used in the processing of FIG. 1A, box 19, can also be stored in the repository 20 of reference data utility 1. Data element 51 represents source profiles. Each source profile contains information about the interaction protocols, source formatting and encoding used by a data or other input source. Data element 52 represents client profiles. Each client profile contains tenant information, contact information, billing and reporting requirements, operational authorizations, sourcing, format and delivery policy preferences for a client of the reference data utility. Tennant profiles are a special form of client profile which characterize the overall entitlements that each client of the tenant has. Source and client profiles are used in the configuration operations of the reference data utility 1 to ensure flexible, independent adaptation to changes in source and client characteristics and to the introduction of new sources and clients.

Data elements 54, 55, 56, 57, 58, 59, 60, 61, and 62 are optional elements used to support reporting and added value services associated with clients' reference data. Data elements 54, 55, 56 and 61 are reports accumulated and saved in the repository 20 of reference data utility 1 for data sources, clients' function providers and regulators, respectively. Data element 57 is a registry of added value data driven computational services. Data element 60 represents the data driven computational functions in executable form. Data element 58 represents client data sets produced as on demand datasets or as the output of a data driven computational services. Data element 59 represents the business document repository. Data element 62 management reports generated for the operation of the reference data utility.

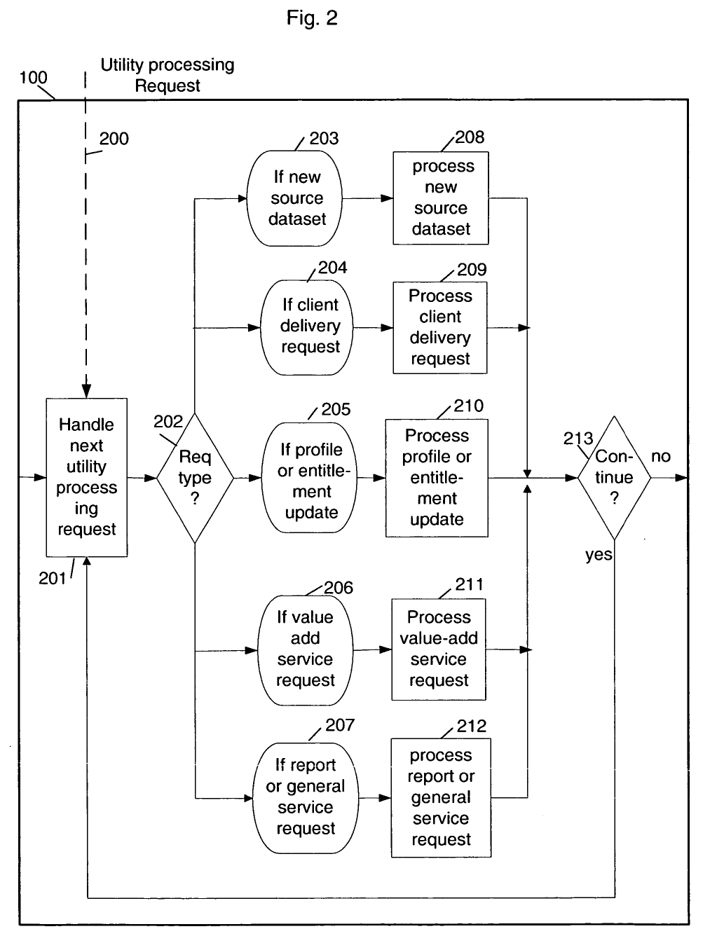

FIG. 2 provides a top level view of the processing of requests by the utility in the form of a flow chart. In this and following flowchart diagrams, solid lines represent control flows and dashed lines represent data movement. Box 100, bounding this diagram, corresponds to the control flow of the overall method of the invention and reference data utility 1 introduced in FIG. 1A and FIG. 1B. Dashed arrow 200 represents all the different requests for reference data utility processing which are handled by this control flow.

Control flows into box 100 from the left into element 201, representing the arrival of a request for processing at the utility 1. A request for processing may originate with data sources, clients of the utility, data driven computational service providers, or staff of the utility itself. Element 201 also includes authentication processing to uniquely identify the person or agent making the processing request, authorization checking to determine that the requester is authorized to make the request and logging the request to ensure that there is an auditable record of all processing done by the utility.

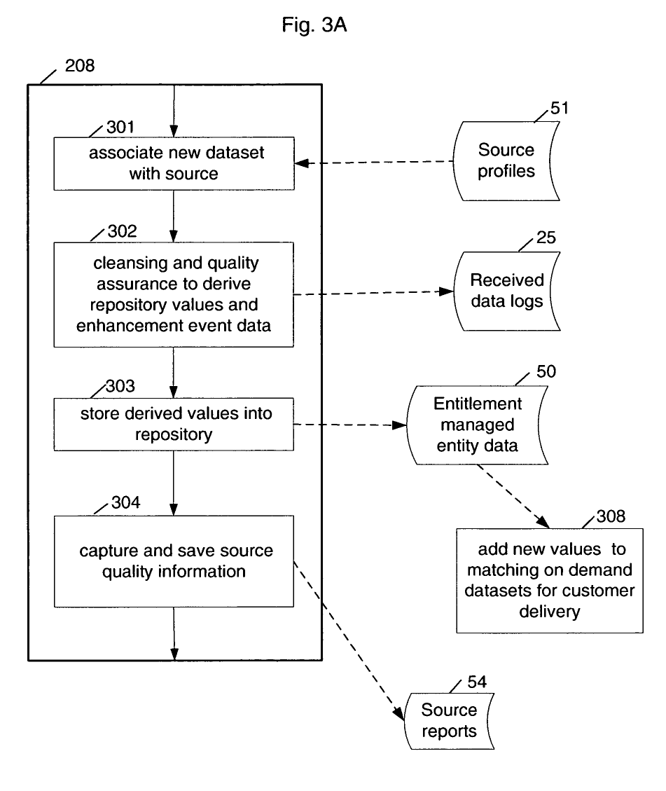

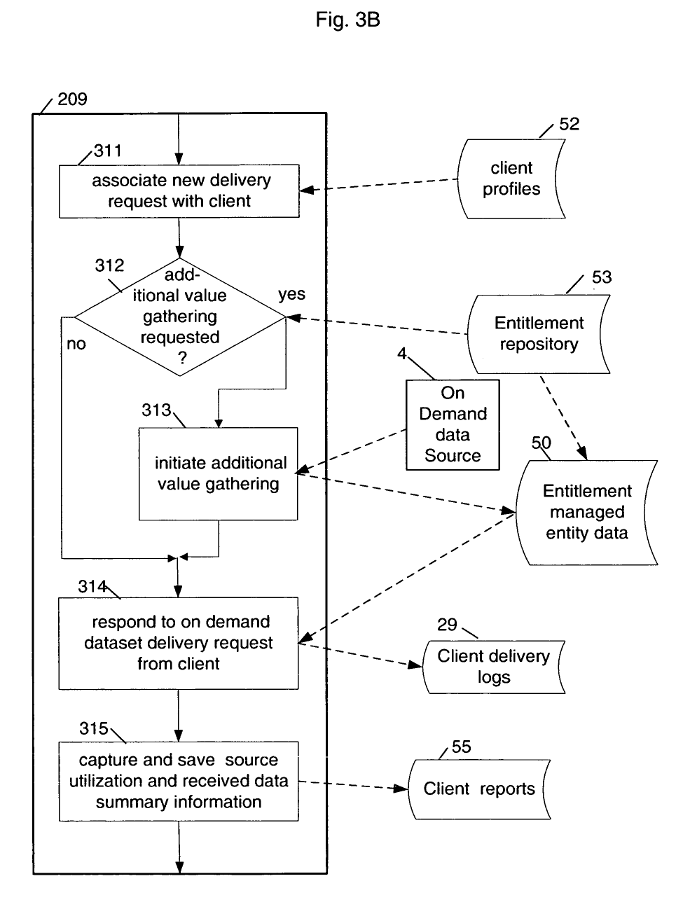

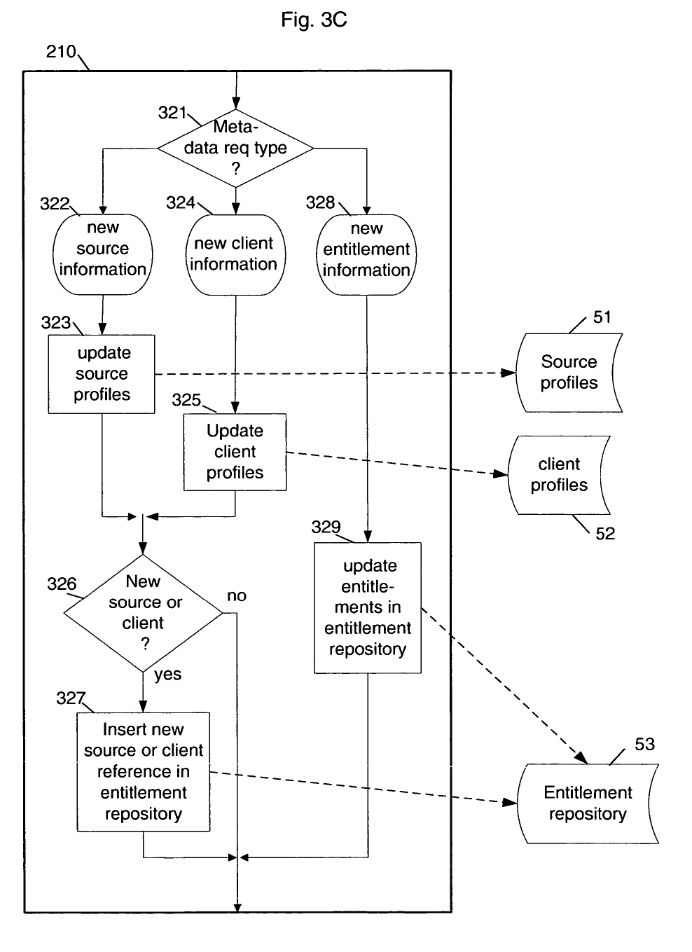

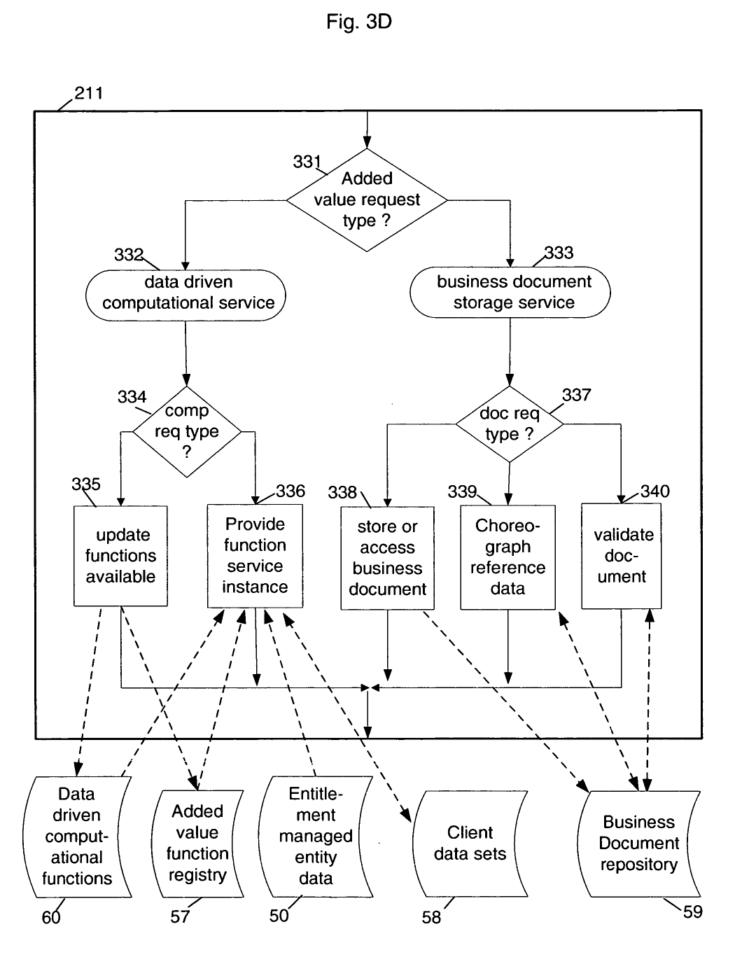

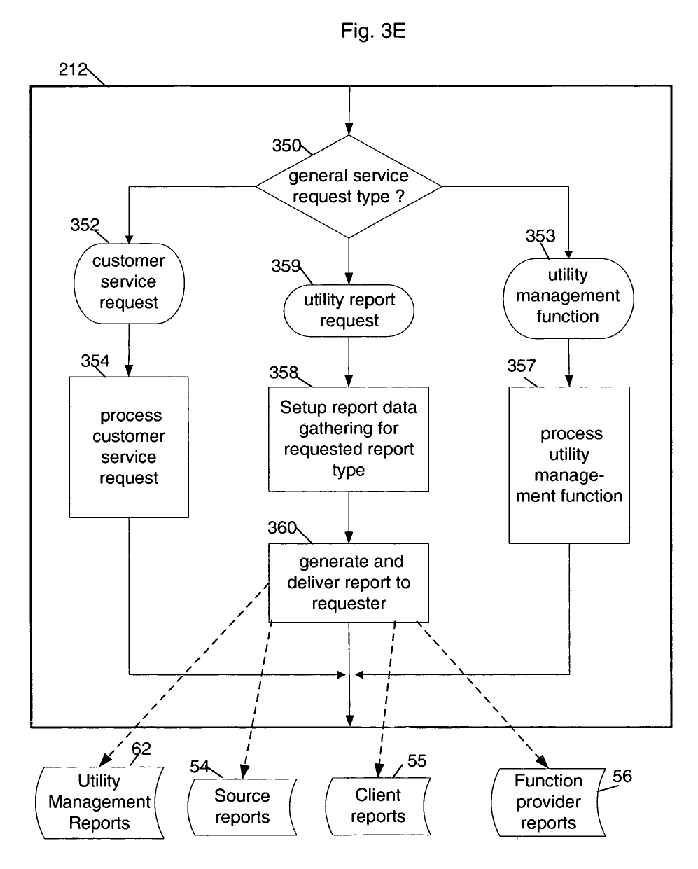

Decision element 202 differentiates the processing of requests by request type, showing a different processing path for each type of request arriving at the utility. The path through outcome element 203 handles new source datasets arriving at the utility. An arriving source dataset is processed in element 208; the description of this processing is elaborated upon with FIG. 3A. The combination of the processing of 203 and 208 is the function performed in block 19 of FIG. 1A. The path through outcome element 204 handles a request from a client for delivery of reference data from the utility. Processing of client delivery requests is handled in element 209; the description of this processing is elaborated upon in FIG. 3B. The combination of block 204 and 209 corresponds to the processing of block 21 in FIG. 1A. The path through outcome element 205 handles profile updates and entitlement updates. These requests identify new clients, new sources, new entitlements to data or value-add functions, or changes to previously registered information of these types. Processing of these requests is handled in element 210; the description of this processing is elaborated upon in FIG. 3C. The processing of blocks 205 and 210 is part of handling data within block 20 of FIG. 1A. The path through outcome element 206 handles requests for processing associated with value added services using information in the utility to provided clients with optional additional capabilities. The processing of these requests is handled in box 211 and elaborated upon in FIG. 3D. The processing of blocks 206 and 211 corresponds to the processing of block 36 in FIG. 1A. The path through outcome element 207 handles requests for general services including the generation of reports by the utility; processing of these requests is handled in box 212 and elaborated upon in FIG. 3E. The processing of blocks 207 and 212 is split between block 35 of FIG. 1A for general services and block 34 of FIG. 1A for reports and utility management requests. Alternate embodiments will contain the same functions but may organize them into different blocks.

After separate request processing by the utility for each of the different types of processing requests, the control flows converge on decision element 213. This decision element determines whether processing continues with the next request or terminates. In the case of continued processing, control flows back to element 201, providing a loop structure. Each iteration of the loop from element 201 to element 213 handles one request. In the case of terminated request processing, control flows out of box 100 ending the flow of the method.

For expository convenience the control flow of FIG. 2 shows the processing of requests sequentially by the reference data utility. Using transaction processing, database and workflow, or other techniques well known in the art, an alternative embodiment of the utility processes requests from many clients, sources, function providers, and utility staff concurrently.

Exit from the processing of box 100 may occur to shut down the utility. Return to additional request handling in element 201 provides clients of the reference data utility 1 continuously available access to their reference data and associated utility services. FIG. 3A provides a high level flowchart showing the steps in processing a dataset arriving from a source. It is an elaboration of the processing element 208 first introduced in FIG. 2. Arriving data is cleansed and used to generate new values for insertion into the multi-source multi tenant data repository 20 (herein referred to as “repository”). New values may trigger additional deliveries of data to clients. Events in cleansing the data and generating values stored in the repository 20 may be documented and used to update utility reports on the data sourcing process.

Element 208, bounding the flow in FIG. 3A, shows this flow is an elaboration of the processing of a new source dataset. Control enters element 208 from the top and flows to element 301 where the arriving source dataset is associated with its source. The repository 20 will maintain descriptive and processing control information for each data source which it is using. The information about each data source is saved in a source profile in element 51, the set of source profiles. Information in a source profile includes authentication tokens, which the utility can use to verify that the dataset originated with the expected source, definitions of the exact source data formats, other conventions and protocols used by this data source and contact arrangements for handling error correction process with the source, and requests for additional data from this source.

Data element 51 is a set of source profiles for sources used by utility 1. The dashed arrow from element 51 to element 301 represents the action of element 301 to select the appropriate source profile for the source providing the new dataset and use information from that source profile to refine subsequent processing of the dataset. In an advantageous embodiment, source profiles are stored in the repository 20 on reference data utility 1 as described in FIG. 1B.

The next step in the flow, element 302, provides cleansing and quality assurance of the information in the new source dataset, and generates enhanced values for repository entities and their properties and documents events in the quality assurance and data enhancement processing. This step requires a method for scalable cleansing and value enhancement of reference data with tracking of enhancement events such as that described below.

One of the actions of the cleansing and data assurance processing is to generate logs of data received from data sources for non repudiation, source tracing and audit purposes. This action is represented by the dashed arrow connecting element 302 to the received data logs, data element 25. In an advantageous embodiment, received data logs are stored in the repository 20 of reference data utility 1 as described in FIG. 1B.

The next step in the control flow, element 303, stores derived values from element 302 as entitlement managed entity data shown as data element 50. This entity data is annotated with origination information for every stored information element so that source based entitlements can be enforced when the utility delivers information to clients. In an advantageous embodiment, as noted in FIG. 1B the entitlement managed entity data is stored in the repository 20 of reference data utility 1. A method for maintaining a multi-source multi-tenant data repository and processing steps to insert new values into it are described in detail below.

A dashed arrow connecting element 303 with data element 50, the entitlement managed entity data, shows that the derived values are added to this data element. A second dashed arrow from data element 50 to (processing) element 308 shows updates and insertions to the entitlement managed entity data triggering delivery processing to add the new values into an on demand dataset for subsequent delivery to a client. That trigger is described in the delivery processing flow discussed in FIG. 3B.

During the processing of step 302, events occur in the evolutionary history of entity values. Examples include: the correction of an incorrect value from a source, subsequent confirmation of a correction from a source, and selection of recommended values based on comparison of corresponding values from multiple sources. These cleansing events are captured and carry important information about the quality of data arriving from each source. The following step, element 304, is the processing to analyze captured source data quality information and include it in reports generated by the utility for each source on the quality of datasets they provide. A dashed arrow from element 304 shows this information being passed to data element 54, representing source reports. Ongoing processing in the utility 1 maintains reporting on source data quality. Each source can be given access to the utility reports on its provided datasets.

FIG. 3B provides a high level flowchart showing the steps of processing client delivery requests.

Box 209 is elaborated upon below, to show how, within the full utility context, value added data delivery is provided in response to on demand delivery requests from clients of the utility.

An on demand dataset request (herein referred to as “request”) enters the utility in box 311. The first step is to associate the on demand dataset request with a client of the utility and authenticate it. This is done in a standard manner known to practitioners of the art, using one of a number of known methods to verify credentials contained in the delivery request against client profile information stored in the utility's repository and represented as data element 52. Information contained in the client profile of the requester is retrieved as illustrated by the arrow representing data flow from data element 52 to box 311.

Once the request has been authenticated and a matching client profile found, the step represented by decision box 312 determines whether additional values are gathered before the process of responding to a request, as described below. Independent parsing of the request is done in this step, which, in alternate embodiments, can be combined with parsing done as part of responding to the request. Additional value gathering includes requesting additional input data from on demand sources and dynamically performing a data driven computational service against existing repository data. In an advantageous embodiment, the resulting new data is passed through a data acquisition and quality enhancement process as described in box 19, introduced in FIG. 1A, and then stored in the repository 20 of reference data utility 1. As such, additional value gathering constitutes a separate service offered by the utility that has its own associated entitlements. Therefore, step 312 examines information from the entitlement repository, element 53, to ensure that the requester is entitled to the additional value gathering service. Queries against the currently available entity data in the repository 20 can be made to access its state relative to the request. Other constraints, such as whether a client's requested delivery timeframe accommodates the additional value gathering can be considered. If additional value gathering is required, the appropriate value gathering process is initiated, at box 313. This may include requesting data from an on demand data source 4. The resulting new entity values are added to the entitlement managed entity data shown by the dashed arrow from box 313 to data element 50. Once additional value gathering is complete, or if no additional value gathering is necessary, the process of responding to the request is initiated as described below (box 314). The process includes retrieving entitled data values from the multi-source multi-tenant data repository 20, the repository of the reference data utility, box 50. As the delivery process culminates with the formation and delivery of the on demand dataset to a requester, updates to the client delivery log, element 29, are generated. Box 314 shows updates being generated and added to the client delivery logs in data element 29. Box 315, which follows in the flow, creates and stores client reports on data source utilizations and received data summaries. The dashed arrow connecting box 315 with data element 55 represents this reporting activity. In an advantageous embodiment client delivery logs and client reports are retained in the reference data utility repository as described in FIG. 1B.

FIG. 3C provides a flowchart showing the steps in processing arriving metadata that characterizes sources of data, tenants, clients of the utility and entitlements of particular clients including, entitlements to data from particular sources and entitlements to value-add services. The utility 1 maintains current metadata on sources, clients and entitlements in order to adapt its configuration, and to control its processing of all other requests. FIG. 3C is an elaboration of box 210 first introduced in FIG. 2, also shown as box 210 bounding the control flow in FIG. 3C.

Control enters box 210 from the top and flows into decision element 321 which determines the type of the metadata request. Each metadata request is either new information on a source, represented by outcome element 322, new information on a client, represented by outcome element 324, or new information on an entitlement, represented by outcome element 328.

New metadata information characterizing a source is handled in element 323, by creating or updating a source profile. The utility maintains a source profile, data element 51, for each source providing source datasets. These could be base sources providing raw data or processes, (e. g. item instance processes), which creates additional or enhanced data values from other data. If the arriving metadata describes a new source of data, a source profile is created in step 323. If the arriving metadata is an update for a source previously known to the utility, the profile for that source is updated In step 323. The metadata request can also trigger the deletion in this step of a profile for a source which will no longer be used. The source profile contains control information needed to cleanse, quality enhance and transform data from that source into repository entity fields. This includes authentication tokens to validate a source as the origin of arriving data, formats, encodings and protocols for receiving datasets from the source, contact arrangements for correction interactions, reporting arrangements, data access and updated authorizations granted to agents acting for the source. Metadata characterizing item instance processes used to derive enhanced values is similar to raw source data and is handled in the same step.

New metadata information characterizing a client or tenant of the utility is handled in element 325 by creating or updating that client's or tenant's profile. The utility maintains a client profile, data element 52, for each of its clients. If the arriving metadata describes a new client, a client profile is created in step 325. If the arriving metadata is an update for a client previously known to the utility, the profile for that client is updated in step 325. The metadata request can also trigger the deletion in this step of a profile for a client who will no longer be active. The client profile contains information necessary to handle and control processing of requests from that client for data delivery, value-add services, customer service and reporting. This includes authentication tokens to determine when requests have originated with that client or its agents, authorization information identifying and specifying operational access rights for each agent of the client, service level agreements applicable to responses provided by the utility, pricing and volume arrangements with the client, reporting services to be provided by the utility, preferred data outputs and contact information for interactions with the client.

After updating a source or client profile, control flows to decision element 326 which tests whether a new source or a new client has been introduced. If this is the case processing flows to step 327 which is an update of the entitlement repository 53 with a reference to the new data source or client. This update will allow source based entitlements granted by the new source or granted to the new client to be added into the entitlement repository 53. If, conversely, the test in decision element 326 shows that the metadata update was to the profile for an existing source or client profile, no change to the entitlement repository 53 is needed at this point.

If the result of the test in decision element 321 was that the new metadata is an entitlement change, control flows via outcome element 328 into the processing block 329 where the entitlement repository 53 is updated to reflect this entitlement metadata. A change in entitlements is either a change in source based entitlements to raw entity data, a change in entitlement to a data enhancement process, or a change in simple entitlements to a value added service or other utility object. A change in source based entitlements takes the form of a new modified or deleted grant, granting access to one or more clients to data from one or more sources or item instance processes. The required processing for this case is to make the appropriate change to the list of entitlement grants in the entitlement repository. Representative flows showing application of updates to an entitlement repository, corresponding to elements 327 and 329, are described in more detail below.

The previously described processing of step 327 ensures that valid references for the granting sources and grantee clients are already in place in the entitlement repository 53. An alternate and logically equivalent embodiment is to provide a one step process incorporating a list of initial grantee clients into the metadata update for a new source or a list of granted sources into the metadata update for a new client.

Step 329 also provides entitlement repository 53 updating for simple entitlements controlling client access to value add services or other resources of the reference data utility. For this sub-case the process is a simple access control list update in the entitlement repository 53 using access control techniques well known in the art. An alternate and equivalent embodiment is to combine this step for simple access into the processing of new client metadata to reduce the number of independent processing steps.

In an advantageous embodiment, data elements 51, source profiles, 52, client profiles, and entitlement repository 53, are stored in the repository 20 reference data utility 1 as described in FIG. 1B. While entitlements have been described as primarily being a grant of entitlement to a particular source for a client or tenant organization, in an alternative embodiment, entitlements can also be associated with value added services indicating that anyone entitled to use the service also derives entitlement to some data or sources associated with the service. Providers of value added service with this property are expected to have obtained redistribution rights to transfer entitlement to data provided to clients on this basis from any sources of the data.

After appropriate updates have been made to the entitlement repository 53, and to client and source profiles, control flows out of box 210. Processing of the metadata update is complete.

FIG. 3D illustrates a high-level processing flow for dealing with requests for value added services; an expansion of box 211 in FIG. 2. Within the context of a reference data utility, a value added service is indirectly related to reference data; for example, it uses reference data as input for various data driven computational services or provides a storage service for reference data related business documents. A relationship between a value added service and reference data exists such that it is advantageous to co-locate them in a single logical system, e.g. the utility. FIG. 3D shows two types of value added services: data driven computational services based on reference data and business document storage services.

Decision element 331 determines whether the received added value request is associated with a data-driven computational service, box 332, or for a business document storage service, box 333. If the request is for a data driven computational service, then control flows to outcome box 332. In this case processing flows to decision element 334 which is a test to distinguish between two types of request associated with data driven computational services. The request may contain the specification and executables of an updated or new data driven computational service from a provider which is to be made available to some set of clients of the reference data utility 1. The processing of this, represented by box 335, is to update the registry of available value-add functions with information describing the newly available data driven computational service as indicated by the dashed line from box 335 to data element 57. The executables of the function are also stored in the library of data driven computational functions, data element 60, in the repository 20 of reference data utility 1 introduced in FIG. 1B as indicated by the dashed line from box 335 to that data element.

In an advantageous embodiment the input and output datasets of data driven computational service are specified so that they can consume and produce on demand datasets as described below. This means that the provider of a data driven computational service can design and develop it to accept a single format and delivery mode of input data; similarly it will yield a single format and delivery mode of output data. Reference data utility clients can then use on demand dataset processing to connect this with any data to which they are entitled and feed the results of the computation to their own applications without developing custom data formatting and delivery logic.

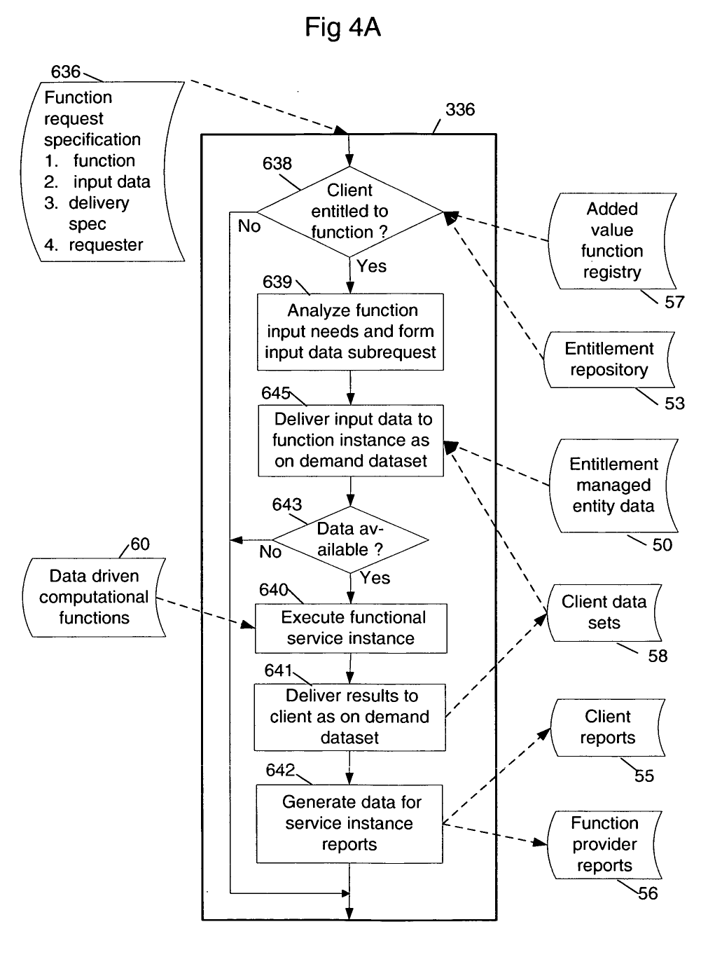

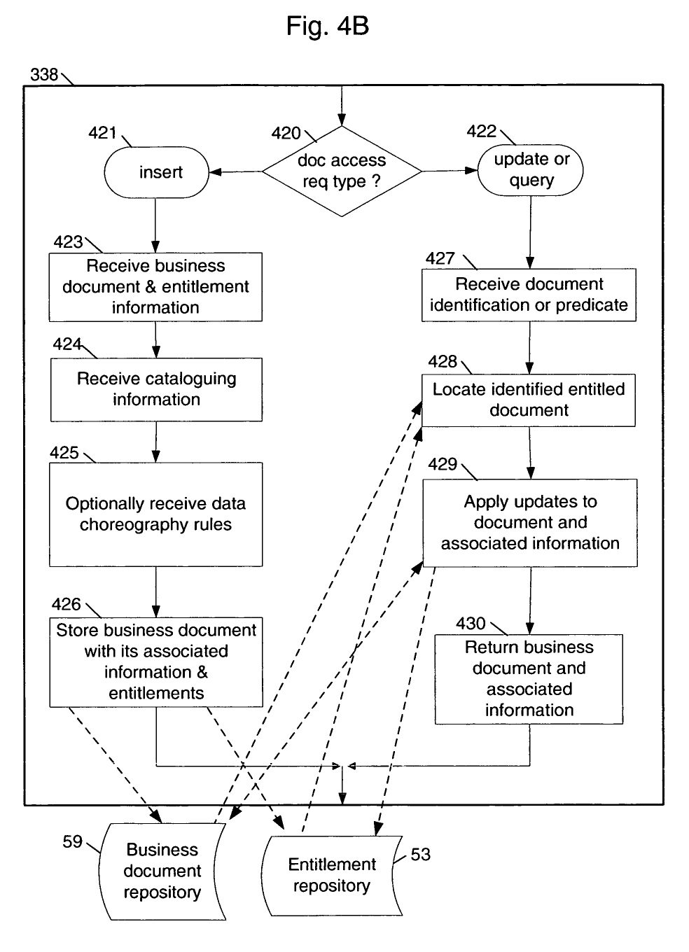

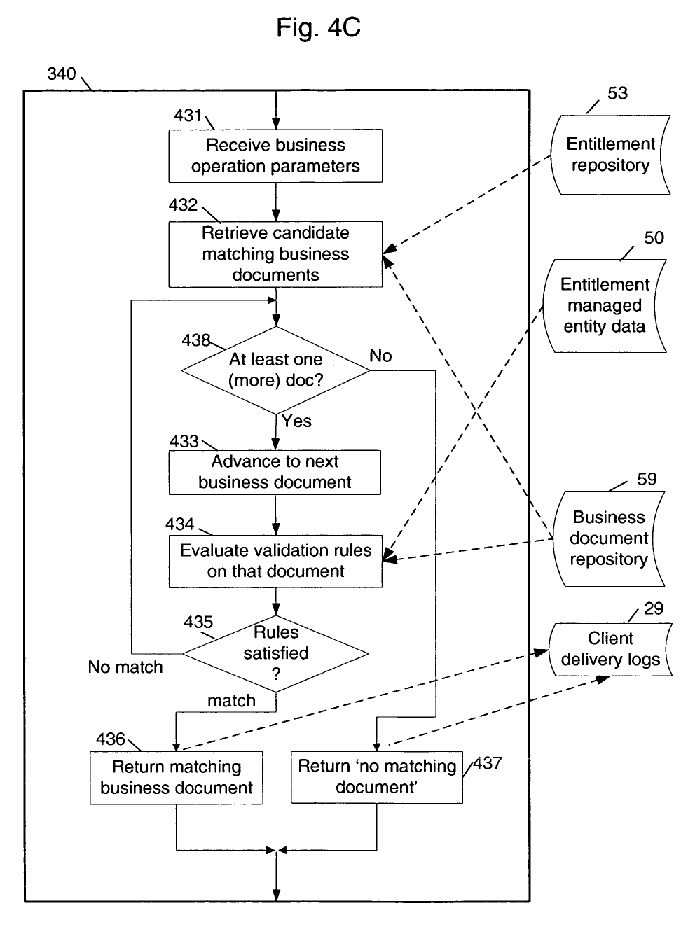

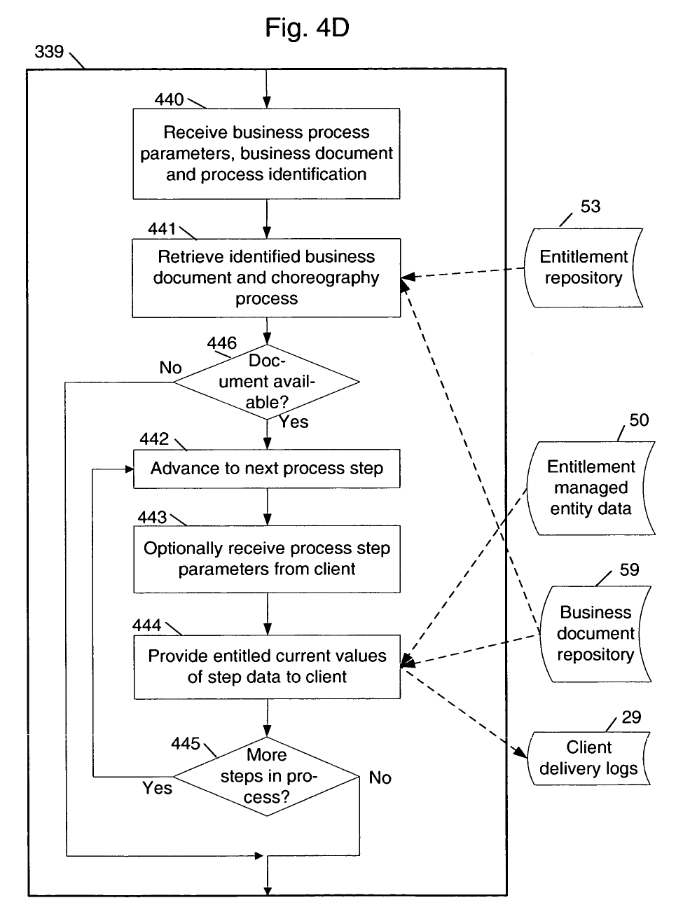

The other type of request associated with a data driven computational service is a request from a client for the reference data utility 1 to provide a service instance by invoking a particular data driven computational function with specified input data and returning the produced results as an on demand dataset. This processing is represented by box 336 which shows that both input and output of the data driven computation may be on demand datasets filled either with entitlement managed entity data represented by element 50, or client datasets in the repository 20 of reference data utility 1 represented by element 58. FIG. 4A provides additional detail on the processing of block 336 in a flowchart that shows the steps of a computational added value service flow for a data driven computational service. The preferred embodiment accepts the on demand datasets as an input to a valued added function, an equivalent alternative embodiment allows value added functions to request the creation of an on demand dataset as part of its computation.

Decision element 337 distinguishes between the processing of three different types of request associated with business document storage services. Boxes 338, 339 and 340 represent the different types of business document storage service requests. Box 338 is a simple request to insert a business document into the business document repository, data element 59, or to update or retrieve a previously stored business document. This processing is further described in FIG. 4B.

Box 340 represents a request to locate a business document suitable for use with (or to govern) a particular business transaction or to validate the suitability of an identified document for a specific business transaction. An example of this type of business oriented document query is: “does a master swap agreement between counterparties X and Y dealing with financial instruments A and B exist?” This processing to handle such requests is further described in FIG. 4C.

Box 339 represents a more complex type of business document storage service request, involving choreography of a client's reference data to support the use of one or more stored business document(s) in a particular business operation. This function is described in more detail in FIG. 4D.

FIG. 3E describes in more detail the processing required to fulfill a general service or report request previously described in box 212 of FIG. 2. Control passes to decision element 350. The request is examined to determine the type of the general service request and routed as a customer service request, box 352, utility report request, box 359, or utility management function, box 353. A customer service request is processed in box 354 after which control proceeds out of box 212. A utility report request gathers data in box 358 after which the requested report is generated in box 360 and then control proceeds out of box 212. A utility management function is executed in box 357, after which control proceeds out of box 212. Dashed arrows connecting box 360 to data elements 54, 55, 56, 62 represent the generation of source, client, function provider and management reports respectively. In an advantageous embodiment these reports are retained in the repository 20 of reference data utility 1 for subsequent access by the owning parties.

FIG. 4A provides an example flowchart that shows steps in providing a function service instance for a data driven computational service. This flow is an elaboration upon box 336 introduced in FIG. 3D, and shows the detailed flow involved in setting up and executing a function service instance for a data-driven computational service. As described with respect to FIG. 3D, requests for data-driven computational services use the same general structure as on demand dataset requests. Box 636 displays the main aspects of a request specification relevant to computational service requests. These aspects are: 1) the identification of the computational service (function) to be invoked; 2) the specification of input data to be used; 3) the specification of the delivery mode, format, etc. in which the results are to be returned; and 4) the identity of the requester. The identity of the requester is used in several ways; one of which is to check that the requester is entitled to the computational service requested and meets any special requirements imposed by the service. Decision element 638 tests this entitlement using the entitlements repository (data element 53) and the added value function registry (data element 57). If the requester is not entitled to the computation service requested, then processing stops and control exits out of the bottom of box 336.

Upon successful completion of the check, the process formulates an on demand dataset request to collect input data for the requested function instance. This is enabled by the computational service request's use of the same structure as an on-demand dataset request described below. As a result, dataset specification aspects such as selection preference and sourcing preference can be included in the computational service request. The computational service can dynamically formulate a one-time on demand dataset request on behalf of the requester, and submit this request to the data delivery component of the utility 1. As part of this request, the computational service can specify its own preferred format and structure of the data to be returned, removing the restriction to understand a pre-defined data model.

The analysis required to map the original function invocation request to a new sub-request to the data delivery subsystem is shown by box 639. The selection predicate and sourcing preference of the original request are copied to the generated request as is, while the format and delivery mode are specified directly by the computation service to fit preferences for receipt and consumption of input data. The identity of the original requester is also passed on. The generated request is formed and submitted to the data delivery subsystem of the utility, and the response is received as an on demand dataset in box 645. The arrow from box 50 to box 645 represents the movement of an on demand dataset from an entitlement enforcing repository. Because the data is extracted from an entitlement enforcing repository represented by data element 50, the enforcement of entitlements to data based on the identity of the original requester is automatically assured. This provides an additional benefit because it removes the need for computational services to perform their own entitlement management of input data. Input data may also come as an on demand dataset from client datasets as shown by the arrow from data element 58.

The next step in processing represented by decision element 643, tests to determine whether input data meeting the requirements of the function and the requesting clients entitlements is available. If insufficient data is returned from the previous step, appropriate logging is done and the remainder of the processing is bypassed and control flows immediately out of block 336. If sufficient data is available, the functional service instance is executed in box 640.

Box 641 shows the step of returning the results, in the form of an on demand dataset, to the original requester (client) or saving them in the repository 20 of reference data utility 1 on behalf of the requester as a client dataset (data element 58). In an advantageous embodiment this uses the capabilities of the utility to support on demand delivery of datasets as described in section D below. Because an on demand dataset request specification allows data-marts and client datasets as possible output formats, it is possible to store the results of the computational service in the repository 20. In this case, results are treated as a client-specific data stream, and can be quality assured as described in section C below. The execution of the data driven computational function uses an executable representation stored in the repository 20 reference data utility 1 as shown by the arrow from data element 60, the set of data driven computational functions.

In an advantageous embodiment, the output of the data driven computational function can optionally be stored in an entitlement managed dataset element 50.

As the last step in the process, any data required for reporting associated with the use of the computational service is generated in box 642. Report types include those delivered to clients (function requesters) and to function providers, represented by data elements 55 and 56, respectively. Other report types exist.

FIG. 4B provides an example flowchart elaborating the steps in handling a request to store or access a business document introduced as box 338 in FIG. 3D. Control flows into this block from the top into decision element 420 which determines whether the business document access request is for inserting a new business document into the store outcome element 421, or for retrieving or updating a previously stored business document, outcome element 422.

For an insert type, the document to be inserted is received in box 423, along with entitlement information associated with the document. Unlike reference data that arrives from data providers, business documents are received directly from clients of the utility. A document submitted by one client may apply to more than one party, and therefore entitlement for multiple parties may be desirable. During the step shown by box 423, determination of entitlements is made based on the requester, as well as the information contained in the request itself.

Cataloguing information accompanying the document is received in box 424. This information identifies, describes and classifies the document in the business document repository (data element 59). This information is used for querying, as well as for business document validation processing as described in FIG. 4C.

An additional set of data choreography rules may optionally be received with the document. Data choreography rules are applicable in scenarios where there is an implied relationship between reference data in the utility and the document being stored. As an example, a document governing allowable mutual fund investments may be linked to financial instruments matching a certain risk profile. Therefore, a rule may be provided for checking whether the risk profile of a financial instrument is within the acceptable bounds described in the business document. Such data correlation rules are optionally received along with the document in box 425. FIG. 4D provides more detail on how data correlation rules are involved in more complex document related processes.

In step 426, the document and the accompanying cataloguing, validation and data choreography rule information (if any) are stored into the business document repository in data element 59 and entitlement information controlling access to the new document is stored into the entitlement repository, data element 53. An advantageous embodiment uses a method for a repository with entitlement management such as that described below in Section B. Entitlements to documents can be specified at insert time. The process of document insertion may be augmented with manual validation processes to ensure that insert-time specified entitlements comply with security standards of the utility. Alternative embodiments use a standard document management repository solution.

The functions to update or query documents are shown in the flow starting with outcome element 422. Box 427 represents receipt of document identification or predicate used to select business documents to access. An advantageous embodiment uses a selection preference within an on-demand dataset request, described below in Section D.

Box 428 is the step of locating the requested document in the document repository and ensuring that the requester is entitled to the document. In an advantageous embodiment, entitlement management is handled with techniques described below in Section B.

If the operation is an update operation, the updates are applied in box 429. The update is applicable to the document cataloguing information, data correlation rules, and the associated business document. The updated document is stored in the business document repository 59. In this processing step there could also be updates to the entitlements to this business document, giving or removing access for a third party and causing an update in the entitlements repository, data element 53.

If the operation is a query function, box 430 is the function of returning the requested document and/or associated information for a query function to the requestor. For an update operation an update confirmation message can be returned to the requester. The response is prepared and formatted in a manner consistent with replying to an on-demand dataset request as described below in section D.

FIG. 4C provides an example flowchart showing the steps in processing a business document validation request. This figure is an elaboration of the processing block 340 first introduced in FIG. 3D which also is shown as a box bounding the control flow in FIG. 4C.

Business document validation locates a business document previously saved in the business document store of the utility, which can be used as the reference document for a particular business transaction. In a financial services context, one example is a pair of businesses that agree that transactions of a particular category between them will be executed according to a particular procedure. They document the procedure with a business document which is stored in the utility's document store following the insert or update flow of FIG. 4A. They also document the validation condition, specifying when this procedure is a valid and appropriate procedure, as a set of validation rules appended to the stored business document by step 424 of FIG. 4B. In practice for a master agreement governing a trade, these validation rules may be sensitive to the issues such as the amount and value of the traded item, the parties on behalf of which the trade is being executed, and the market and context where the trade was transacted. These validation rules typically refer to reference entities for which the reference data utility is providing values to the transacting parties such as corporate hierarchies, financial instrument definitions and properties, and counter parties etc. It is efficient to store and validate business documents in the reference data utility because of the contained references to other financial entities for which values are needed during validation, and because the document is shared between clients executing a trade. Finally, document validation has to be subject to the entitlements. Validation is done on behalf of a requestor. In order for the request to succeed the requestor has to be entitled to the validation request, and all data and documents required for the validation.

Processing of a validation request enters through the top of box 340 in FIG. 4C and flows to element 431 where the parameters characterizing the business operation are received from one or both of the requesting parties. These parameters specify characteristics of the business transaction for which an associated stored business document is needed. In the case of the financial trade example introduced above, they include information identifying the items being traded, the amount, the parties executing, the context of the trade and the parties on whose behalf the operation is being executed as indicated above. Using this information, step 432 retrieves a set of one or more stored business documents, which are potential candidate matches to be used as a governing document for the specified business operation. The entitlement repository, data element 53, provides the entitlement information and the documents themselves come from the business document repository, data element 59.

Decision element 438 heads a loop which repeatedly advances to the next candidate document in the list and processes it to determine whether it is a valid match satisfying all the validation rules for this client request. It is possible that the processing of step 432 yielded no candidate documents for validation to which the requesting client is entitled. In that case, control flows via the “No” branch out of decision element 438 and on to box 437. The dashed line from box 437 to box 29 indicated logging of the results. “No matching document” is reported to the client. The same flow using the “No” exit from decision element 438 may also occur after multiple iterations of the loop if all candidates in the initial list have been evaluated and no valid match has been found.

Step 433 within the loop following the “yes” branch out of decision element 438 advances to the next candidate document. Step 434, also within the loop, evaluates the specified validation rules on that candidate document using context supplied in the request and reference data from the entitlement managed reference data in data element 50. Decision element 435 then tests whether the validation on that candidate document was successful or not. If it was, control flows out of the loop to block 436 which returns the identified current document as the successful match to the requester. The dashed line form box 436 to box 29 indicates logging of the results. If the current candidate document did not satisfy the validation rules, control flows back to the head of the loop where decision element 438 tests whether there are more candidate documents available for validation. If this is not the case, no match has been found and this is the reported result of the processing.

An alternate embodiment always evaluates the validation rules on all candidate documents and returns a list of successfully validated matching documents to the requester instead of returning the first successful match as described above. Although the reference data utility stores, locates, and returns a valid business document used to govern the execution of a specific business operation, the actual execution of the specified business operation remains the responsibility of the clients and their trade execution systems.

FIG. 4D provides a flowchart showing the steps in processing a request to choreograph reference data supplied to a specific business process instance associated with a particular business transaction. This figure is an elaboration of the processing box 339 first introduced in FIG. 3D, also shown as a box bounding the control flow in FIG. 4D.

Reference data choreography supplies current valid reference information supporting a specified business transaction and processing to execute it. The business transaction typically executes on the trade execution systems of the requesting clients, but uses reference values supplied by the reference data utility 1 as reference data choreography. In a financial services context, for example, a trade of common stock may require information about recent dividend payments on the stock and whether they accrue to the buyer or the seller, contact addresses of counter parties to register the transfer with, such as the stock issuer. It may need contact addresses of certificate repositories and other interested parties to complete the transfer, and may need to know the exchange and locality where the stock is traded to understand fee and tax issues associated with the transfer. Much of this information is available to clients of the reference data utility 1 as current values and properties of repository 20 entities. The reference data utility 1 makes entitled information relevant to processing the trade available to one or both parties as part of its reference data choreography processing.

As shown in step 425 of FIG. 4B, business process data choreography specifications can be attached to each business document stored in the business document repository. The reference data choreography rules specify which values to select from the entitlement managed reference data utility 1 to support a particular business process for which this business document is being used as a guide. Choreography value selection is parameterized with the characteristics of the business transaction being supported. Since a business process typically involves multiple steps with different reference data needed for the different steps, the reference data choreography specification for a given business process takes the form of a set of reference data selections associated with steps in the business process.

For example, for a business document which is a master agreement governing trade in common stock, parameters for each particular business transaction include the stock symbol, amount traded, trade date and time, trade price, etc. An appropriate reference data choreography step returns the current entitled definition of the stock, its recent dividend history and announcements, counter parties for registering the trade, etc. This information is supplied to the trade execution systems of the utility's clients executing the trade, increasing the reliability, consistency and accuracy of their operations.

In FIG. 4D, control enters at the top and flows to box 440 where the business process instance parameters, the business document identification and the business process identification are received from the utility client in a request. The business process instance parameters are unique properties characterizing this particular business operation. As described above, examples include the item traded, trade date, trade amount, etc. The client also selects a particular business document to govern the trade execution process. This is done by executing a business process document validation request as elaborated in FIG. 4C or by an explicit selection of a business document by the client or clients. Since there may be multiple business processes associated with a single business document in the store, the specific business process for which reference data choreography is requested is also identified in step 440.

The following step, box 441, retrieves the identified business document from the business document repository and locates the identified business process data choreography request identified by the client. The business document is retrieved from the business document repository, data element 59, after first checking that the requesting client is entitled to access it using information in the request and the entitlement repository, data element 53. Decision element 446 then tests to determine whether a document with matching choreography and to which the requesting client is entitled has been returned in step 441. If not, then no data choreography is possible and control flows out of box 339 reporting this as the outcome of the request. If a business document with matching choreography has been found, control flows on via the yes exit from this test.

Multiple steps may exist in the data choreography for a specific business process, each parameterized with different input data and each returning a different set of reference values for use in the next step of the process. Element 442 heads a loop. Each iteration of the loop provides the reference data choreography for one step of the identified business process instance. The action of element 442 is to advance to the next process step of the transaction. In element 443 step specific parameters may be received from the requesting client. Element 444 uses the step specification provided in the process choreography annotation to the stored business document and following it, retrieves appropriate entitled repository entity values from the entitlement managed repository entity data consistent with the step inputs and the step specification. These values are returned to the requesting client or clients for use in their trade execution system. Appropriate logging and reporting of the delivery is made to a client delivery log as shown by the dashed line from box 444 to data element 29.

Decision element 445 contains processing to determine whether data choreography for the business process instance is complete or whether there are additional steps to be processed. If the data choreography for the business process is complete, control flows out of box 339. If there are additional steps to be processed, control returns to element 442 and the next step of the data choreography is processed.

The reference data utility 1 provides reference values to the requesting client or clients. These clients use their own trade execution systems to effect the trade. An advantageous embodiment is to use techniques such as Service Oriented Architecture and Web Services, well known in the art, to enable the efficient interface of different client trade execution systems to the reference data utility 1. Since the reference data values provided in each business process instance step are read-only, minimal state information about the interaction between the client's trade execution system and the reference data utility 1 is needed.

Dashed lines connecting steps 441 and element 444 with the entitlement repository 53, the entitlement managed repository entity data 50 and the business document repository 59, show where these sources of data are used.

The services for validating and providing reference data choreography are useful, but optional, extensions of the basic capability to store and access business documents in the reference data utility store.

An alternate embodiment of business document function is to provide clients with alerts when there is a change in reference data which affects the meaning or usefulness of their documents in the business document repository. For example a change in corporate ownership hierarchy may affect a set of business documents—specifically master agreements governing transactions may need to be reviewed when there are changes in the hierarchy of corporate entities which could be participants. Using the on demand dataset capability, the reference data utility 1 can monitor changes affecting specific sets of business documents on behalf of clients and deliver affected document identifiers to them when such changes occur.

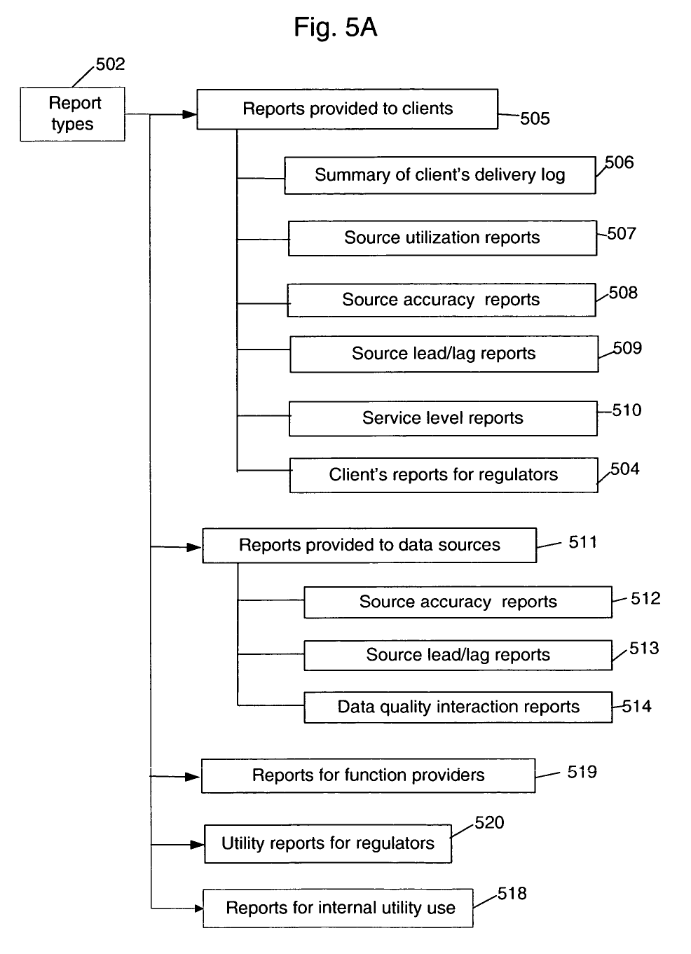

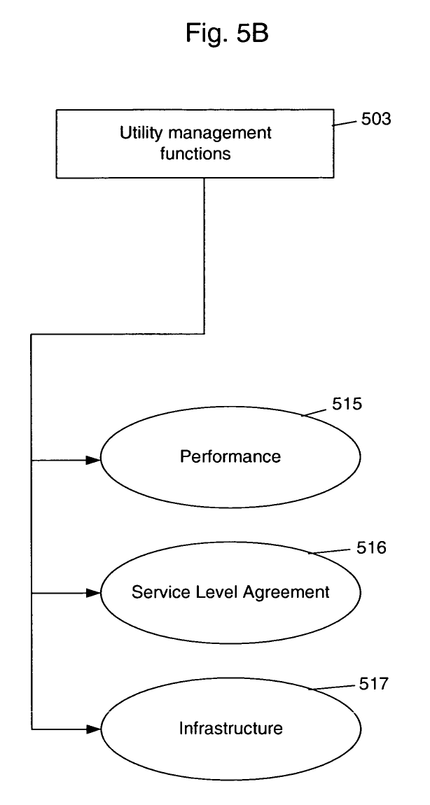

FIG. 5A describes the types of reports that the utility 1 can generate for clients, data sources, providers of value-add functions, regulators and internal management. A simple hierarchy starts at box 502 with report types. The utility 1 can provide multiple types of reports; reports to clients, box 505, reports to data sources, box 511, reports to function providers, box 519, reports for regulators, box 520, and internal reports used to manage the utility, box 518.

Reports for regulators 520 are defined by the relevant regulatory agencies. Internal reports 518 are defined as needed by the utility operator.

Client reports include, but are not limited to, delivery log reports, box 506, source utilization reports, box 507, source accuracy reports, box 508, reports on source timing, box 509, service level reports, box 510, and reports generated for customers which they have to give to regulators, box 504. Clients may be regulated by different agencies than the utility and as such their reporting requirements may be different. These reports are defined by the regulatory agencies and generated as needed.

The utility generates three categories of reports for data sources; accuracy reports, box 512, timing reports, box 513, and quality and usage reports, box 514. These reports are designed to help the source vendor improve and manage their data quality by assisting in identifying the issues that are critical to the source vendor's customers.

Function provider reports in box 519 provide information gathered by the reference data utility 1 on usage of the provided functions to support assistance from the reference data utility 1 in client usage accounting and billing.

FIG. 5B gives an overview of the utility management functions represented by box 503. Utility management functions are divided into three broad categories; performance, ellipse 515, service level agreement, ellipse 516, and infrastructure, ellipse 517. The performance function allows the utility operator to monitor performance based on metrics defined by the operator. Monitoring enables the utility to manage performance manually, automatically or through a combination of both. Service Level Agreement (SLA) functions allow the utility to monitor its performance against its SLA commitments and manually or automatically manage its operations to improve utility performance as evaluated by the SLAs. The infrastructure function supports the efficient management of the processor's storage, software and other information technology used by the reference data utility 1 or its operations.

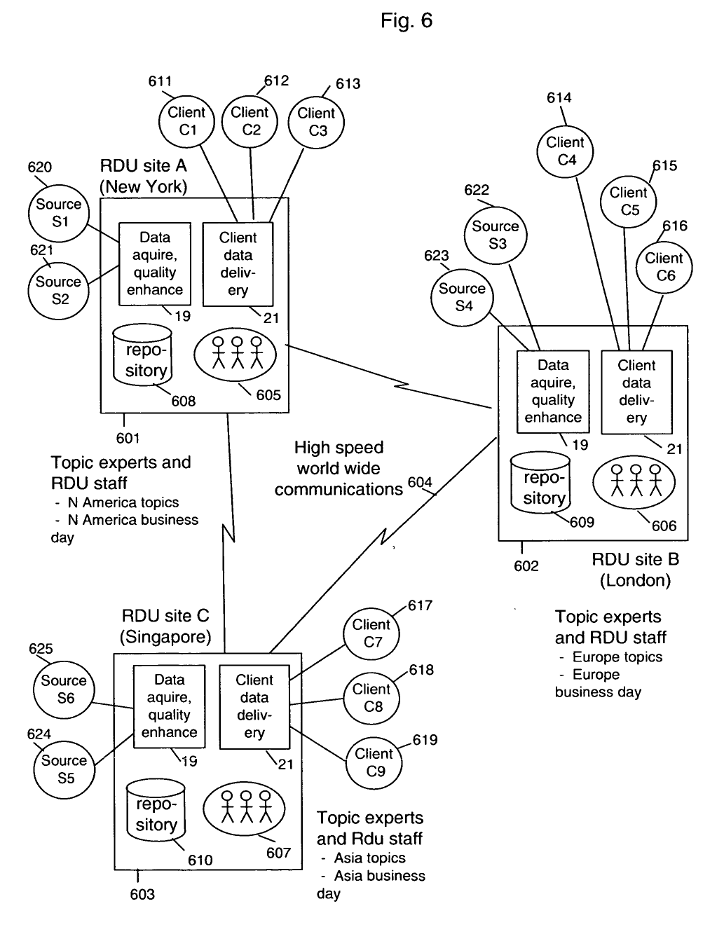

FIG. 6 addresses the geographical dispersion and high availability issues affecting a multi-source multi-tenant reference data utility.

Boxes 601, 602 and 603 each represent a utility site located in different cities around the world; in this example New York, London and Singapore, respectively. The technique can be applied to any number of sites in any set of locations. Each of these sites has processing capabilities of a utility, corresponding approximately to the capabilities represented by reference data utility 1 in FIG. 1A. A data acquisition and quality enhancement component, box 19 as first introduced in FIG. 1A and a client data delivery component, box 21, are shown at each site. The high quality of data values in each repository 608, 609, 610 is maintained by a pool of human experts with deep business knowledge of relevant topics; these experts make judgments about arriving values to ensure that data delivered to customers is of the highest quality. Therefore, the effectiveness of the utility depends on availability of the best experts on each topic to process information on that topic in a timely way at the lowest cost. It is assumed that experts on regional issues will be located in proximity to the region. Ellipses 605, 606 and 607 represent the human pools of experts providing these quality assurance services on arriving data, and associated customer services. The function of each of these pools corresponds to ellipse 37 in FIG. 1A. Similarly elements 608, 609 and 610 are site specific versions of the repository 20 of reference data utility 1 in FIG. 1A. FIG. 6 expands the utility concept as described in FIG. 1A, by including multiple sites. In a multi-site utility, data quality enhancement for a particular subtopic need be performed at only one site; this task can be assigned to the site where it is performed most efficiently. Hence, topics or subtopics are partitioned and each is assigned for primary quality assurance to a site, as represented by boxes 601, 602 or 603.

Links 604 represents a high speed, world-wide communications fabric connecting the geographically dispersed sites. This capability ensures that the multi-site utility is able to operate as a single logical service, making data available to clients regardless of where they or their subscribed vendor sources are connected, and ensuring that backup service is available for utility capabilities from another site should a site be disabled. Although reference data for a topic is cleansed at a selected primary site, in an advantageous embodiment, the cleansed entity data on each topic is then copied to all sites for ease and speed of delivery to clients. Also, updated entitlement repositories are maintained at each site, at least covering entitlements of clients attaching at that site. Hence all sites are involved in cleansing; each item of arriving data is acquired and quality enhanced once and all entity data is available to all entitled clients via local repository access with local entitlement enforcement. Use of a guaranteed messaging system for propagating cleansed data from the primary site to other sites, assures that updates are propagated to remote sites without risk of data loss. In an alternate embodiment, cleansed data and entitlements are stored at a more restricted number of sites; requests to retrieve and deliver reference data must be sent to one of the sites where the data is located. One form of this restriction is to retain and store cleansed data only in its primary cleansing site. There are availability, resiliency and redundancy advantages in storing each item of data at a plurality of sites, prompting intermediate alternate embodiments where each data item is stored at more than one, but not all sites.

In the example of FIG. 6, data sources S1, S2, S3, S4, S5 and S6, represented by circles 620, 621, 622, 623, 624 and 625, respectively, each connect to one of the utility sites. There is an assumption that high speed, world-wide communications (connecting links 604) allows data from each source to be distributed wherever needed for input processing, quality assurance or storage in a repository. Similarly, clients C1, C2 and C3, (represented by circles 611, 612 and 613) are attached at repository site A, clients C4, C5 and C6 (represented by circles 614, 615 and 616) are attached at repository site B, and clients C7, C8, C9 (represented by circles 617, 618 and 619) are attached at repository site C. This set of example client and source attachments illustrates properties of the multi-source multi-tenant reference data utility.

The reference data utility treats each connecting client as an independent logical entity with specific entitlements to which data can be delivered. A single corporate tenant may have associated with it clients which connect at a plurality of reference data utility sites. The higher level corporate ownership may be reflected in entitlement structures, and in client profiles, but does not alter the methods for delivering retrieved data to each connecting client described in this method. For the purposes of delivering on demand data sets and executing value add functions, the utility treats each local client as an independent owner of a client profile and submitter of requests to the utility for retrieval and delivery of data. For the purposes of accounting, entitlement tracking, service level reporting, contract management and authorization management, the utility can maintain awareness of hierarchical relationships associating connecting clients with possibly geographically dispersed corporate entities to which they belong.

Each client C1, C2, . . . C9 attaches at a single site but has access to all reference data in the dispersed reference data utility to which they are entitled regardless of the site used to provide quality assurance on those values, the site of the connection points for data sources to which that customer is entitled, the site of primary storage for that data (when data partitioning is used), or the failover or backup site providing master storage and update of values for that topic or subtopic during a temporary failure of a master site.

Repositories 608, 609 and 610 represent reference data utility repositories (corresponding to the logical capabilities of repository 20 in FIG. 1A) maintained at each utility site. The repository at each site is aware that it is the master (source of) for some reference topics. The results of data gathering and quality assurance on those topics are subsequently propagated to remote sites from that site. For other reference topics, this site will receive and hold values from whichever of the other repository sites is acting as the master. In an alternative embodiment, the data is replicated and enhanced at all sites. In another alternative embodiment the data can be partitioned between sites and each data element stored at a single site only. Replicating the data to all sites provides better availability and ensures that each site is responsive to locally attached customers requesting data. It may be sufficient for arriving raw data logs and customer delivery logs to be stored only at the repository site where data is received and quality assured or where a logical customer is locally attached. In an alternative embodiment, where data is partitioned and held at a small number of sites, the differences in the assignment of storage and data quality assurance responsibilities makes each repository site distinct and enables each repository, though functionally similar, to hold different data.

This concludes the description of the flow diagrams for section A describing the overall reference data utility and associated value add functions. In preferred embodiments workflows are used to implement the process and flows described herein. Alternative embodiments use script, discrete distributed process, or a mixture of all of these. Any suitable mechanism or programming language is used to implement the flows and processes described herein.

B. General Structure and Method of Operation of the Repository

This aspect of the invention is directed to a multi-source multi-tenant data repository (herein referred to as “repository”) with entitlement management based on source tracking of reference data values and to a method for operating it. Such a multi-source multi-tenant data repository with entitlement management is an important component of a multi-source multi-tenant reference data management service or of utility 1, described above. It is also useful in other contexts. The multi-source multi-tenant data repository manages and provides permanent storage for repository information elements, associated metadata, entitlements, value add functions and documents, and may function as repository 20 described above.

Throughout we illustrate aspects of the invention with examples of financial reference data such as descriptions of financial instruments, counterparties, corporate legal entity hierarchies and corporate action events. Reference data in these categories is widely used in financial markets. The methods of the invention are also applicable to provide and support other classes of reference data with similar characteristics. In particular a multi-source, multi-tenant entitlement repository with source based entitlement management is useful wherever there are many sources and many tenants with independent source based entitlements needing to search and retrieve values to which they are entitled but, in general, not needing to update the data directly.

The repository also includes data retrieval, access and query mechanisms available to requesters (for example tenants, or agents acting on their behalf). Advantageous innovations of the repository component that distinguish it from a standard database are:
the repository incorporates the ability to store multiple versions of attributes (versioned attributes), where each version is deemed distinct based on value, metadata, temporal information or sourcing information;
the repository retains full information about the history and sourcing of all information elements. The history includes the following aspects:
   all events pertaining to the information element in question;
   all sources and agents of such events; and
   chronological order of such events.
the repository maintains source based entitlement information on all authorized requesters and on all entitlement grants from particular sources to particular requesters; and
the repository incorporates the ability to service requests for the information it includes based on selection and sourcing preferences of the requester, and source access driven entitlements.

The data in the repository is organized to allow shared access paths. Access paths and indexing are available to all requesters to select reference item values of interest and they provide client-specific entitlement-based access to reference data values.

The repository allows individual requesters to specify their preferred source for retrieved data at the field level. This preference will be used in choosing between available values from different sources entitled to the requester.

All of the above capabilities are provided in an environment in which the security and privacy of customer and vendor actions are maintained. No customer or data vendor is able to discover information about another's data, queries or other actions by the repository to support them.

The method is described herein as it applies to reference data used by Financial Services businesses. This method for forming and organizing a multi-source multi-tenant data repository of reference information with entitlement management based on source tracking of reference data values has many other possible areas of application. Access to consumer credit information, government regulation and registration information, and telecommunications usage information are three additional examples where the method has use. Characteristics of contexts where the method has use and of reference data are: (1) the information comes from many sources; (2) there are multiple users, potentially in independent organizations, that need access to the same information but potentially with different source entitlement rights; (3) the referenced information is accessed by users largely in read-only mode except when they participate in correcting invalid values; (4) high quality timely information is both valuable and complex to gather, hence the efficiencies from a utility approach, shared infrastructure and shared data quality enhancement provide significant benefit; and (5) entitlement enforcement and privacy management must be provided by such a utility. Although the invention is described in the context of financial services reference data, which is one important area of application, the approach revealed herein, enabling an effective utility to provide data access meeting the requirements above, has value in any context with these requirements.

When the repository is being used in the context of a reference data utility it corresponds to element 50 , the entitlement managed entity data, appearing as part of the reference data utility repository 20 in FIG. 1B.

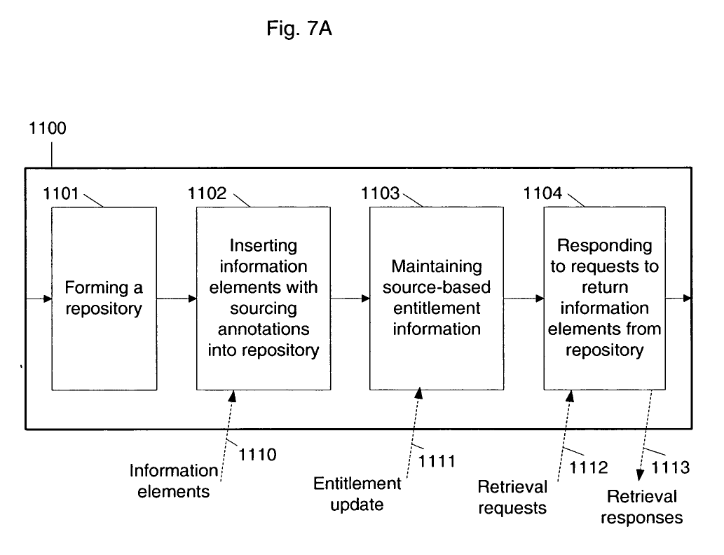

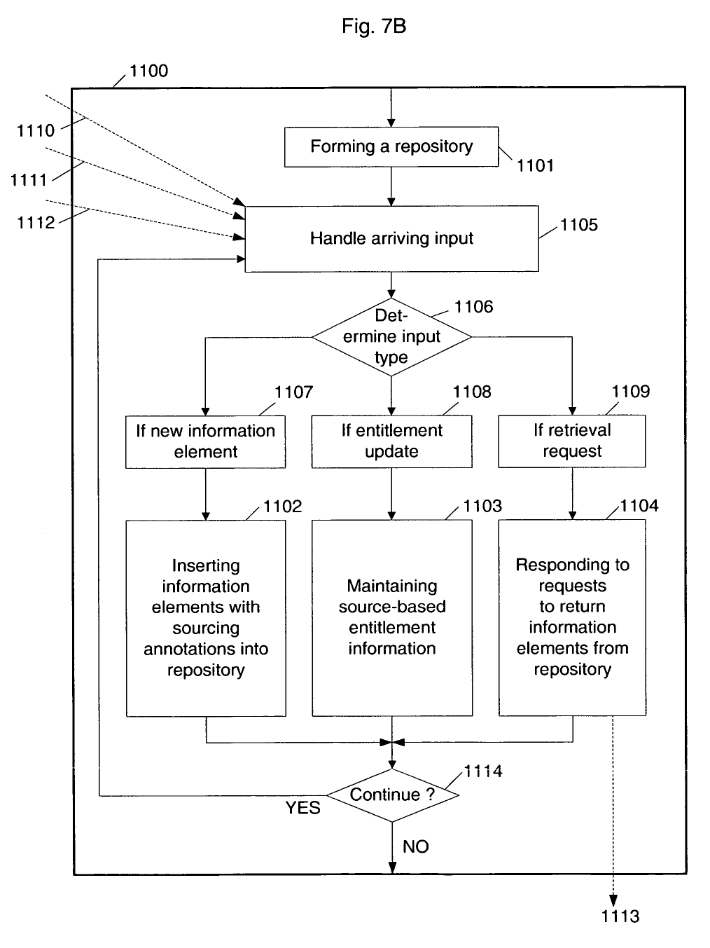

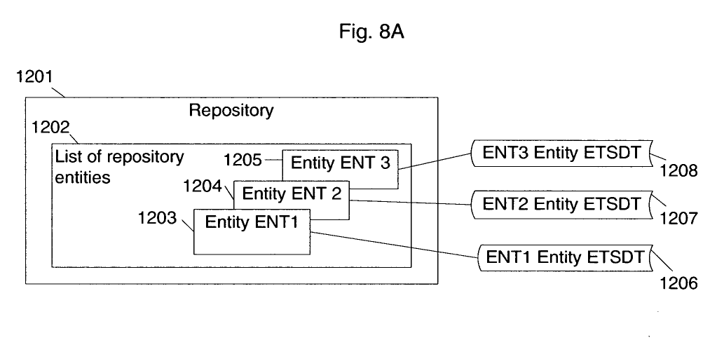

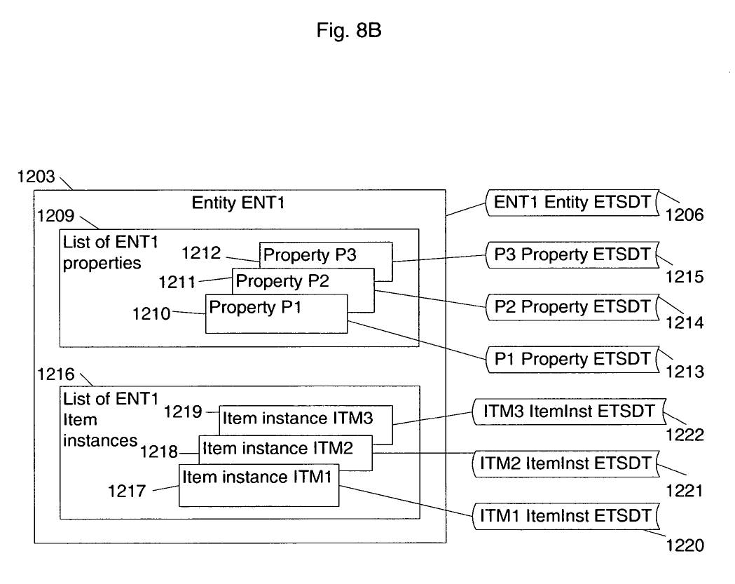

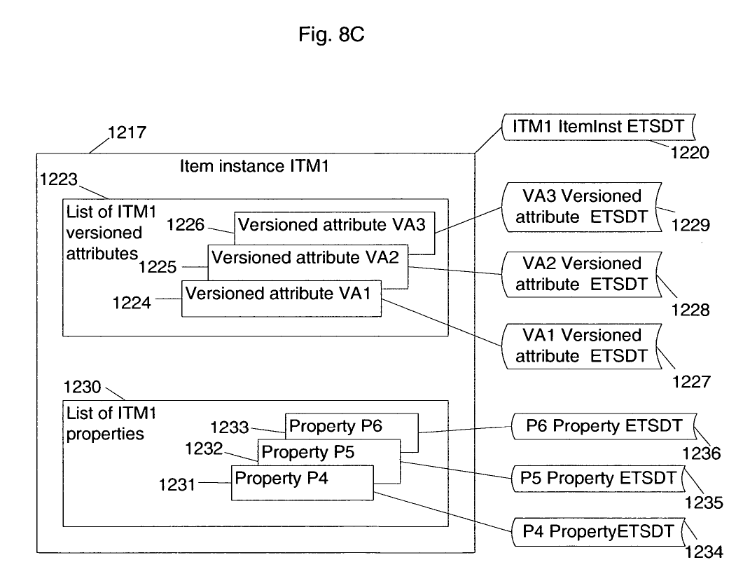

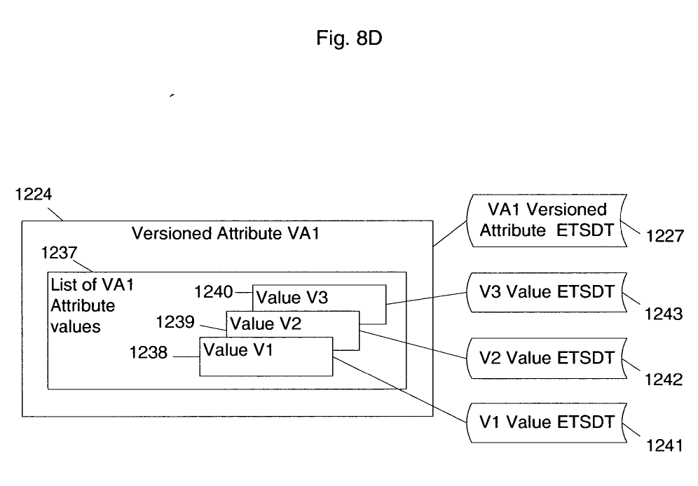

FIG. 7A shows an example of a method for managing information and associated source based entitlements in a multi-source multi-tenant data repository. This figure represents a high level overview of the advantageous processes needed to form, maintain and operate the repository. In FIG. 7A, box 1100 represents the overall method. Within it, box 1101 represents the initial step of forming the repository with the necessary information element structures in place (described in detail in FIGS. 8A, 8B, 8C, 8D). In addition to these, the repository is used to store other items that reside in a data store. These additional items are business (value added functions, business documents, etc.) or functional/operational (rule sets, log records, etc.) in nature as was described in the description of box 20 in FIG. 1B.

Box 1102 is the function of inserting arriving information elements into the store, annotating each element with annotations describing its evolutionary history.. These annotations are known as evolutionarily tracked source data tags (ETSDTs), and can be associated with any information element (or set of elements) in the repository. Each event (the term “annotation” is also used synonymously throughout this document) in an ETSDT effectively corresponds to some action performed upon the information element being described and corresponds to a distinct version of that information element. Each event within an ETSDT carries important information, in particular, the source, or sources,-of the event (a source can be a single-source or a multi-source process, as well as an atomic source such as “original document”), the agent who performed the event, event identifier information, timestamp information and descriptive information about the event. Other attributes are possible. Recording full sourcing information in this way provides full traceability to all sources that contributed to the creation of the information element value. This full traceable history is a advantageous enabler of a multi-source multi-tenant data repository wherein the intellectual property rights of source providers and privacy rights of data consumers can be protected. See FIGS. 8A, 8B, 8C and 8D for examples of information elements and associated ETSDTs. Arrow 1110 represents information elements arriving as input to the insertion step of box 1102.

Box 1103 represents the repository's ability to maintain source based entitlement information about authorized requesters of repository information and data sources to which they are entitled. For example, in a financial reference data repository, a record specifies that repository tenant A is entitled to financial instrument data from source providers A and C only (whereas the repository may include data from providers A,B,C, D, E, F, and G). Arrow 1111 represents updates in entitlement information received as input and handled by the entitlement maintaining process of box 1103. One possible choice for an embodiment of box 1103 is for updated entitlement information to be stored in the multi-source multi-tenant repository; an alternate embodiment is to maintain entitlement information following the processes described herein but storing the updated entitlement information in a separate repository.

Box 1104 represents the ability of the repository to use ETSDTs together with source based entitlements in a process that provides controlled access to the information included in the repository. This process takes into consideration various sourcing and selection preferences of the requester. For instance, in a financial reference data repository, this process is able to respond to a request to return information on all stocks in an interest list A from all available sources. In this example the process would identify the requester, retrieve their entitlements, and then select and return the information set forming the intersection of the request specification and the entitlement restrictions. Arrow 11 12 shows retrieval requests arriving as input to the processing of box 1104; arrow 1113 shows retrieval responses being returned as output for this processing.

Thus, the present invention includes a method for sustaining a multi-source multi-tenant data repository. The step of sustaining including the steps of: forming the multi-source multi-tenant data repository to include information elements from a plurality of sources, describing at least one referred entity; annotating a plurality of elements from the information elements in the multi-source multi-tenant data repository with sourcing information; maintaining information about entitlement of requesters to information elements based on the sourcing information; and responding to at least one request from at least one requester to return a set of information elements based on requester-specified selection predicates and sourcing preferences and subject to the entitlement of the at least one requester.

In a financial market example used herein, the method is for sustaining a financial multi-source multi-tenant data repository. The step of sustaining includes the step of forming the financial multi-source multi-tenant data repository to include information elements from a plurality of sources, describing at least one referred entity. Consider sources feeds from Vendor A, Vendor B, and Vendor C. The method also includes the step of annotating a plurality of elements from the information elements in the multi-source multi-tenant data repository with sourcing information. Examples of sourcing information include that a specific set of values defining the common stock of company A were received from the Vendor B feed in a data record with record identifier R received at time T. It also includes the step of maintaining information about entitlement of requesters to information elements based on the sourcing information. Examples of this include that client C is entitled to receive data from Vendor A and Vendor C feeds but not from the Vendor B feeds. It also includes the step of responding to at least one request from at least one requester to return a set of information elements based on requester-specified selection predicates and sourcing preferences and subject to the entitlement of the at least one requester. Examples of this include returning to client C the current entitled recommended definition of the common stock of company A.

FIG. 7B is an alternate more detailed control flow of an advantageous embodiment for the method showing how each individual arriving input, i.e. information element, update to entitlements or retrieval request, is handled when it arrives at the previously formed repository. This representation shows that the insertion of new annotated information elements, updating of entitlement information and responding to retrieval requests can be interleaved.

In FIG. 7B, box 1100 again represents the overall method. Control enters from the top. The initial step is to form the repository establishing the essential data structures with box 1101 as described above. At this point the repository is ready to receive inputs. The inputs are represented by the arrows 1110, 1111, 1112, representing arrival of new information elements, entitlement information updates and requests for information retrieval, respectively. Box 1105 is the step in the control flow where all of these arriving inputs are first handled. It heads a loop from box 1105 to box 1114; each iteration of this loop will handle one arriving input.

The first control flow step in processing an input is to determine its type. This is done in the decision element 1106. The method handles three primary types of arriving action prompt: a new or updated information element, an entitlement update and a request for information. These outcomes from decision element 106 are handled by the paths headed by boxes 1107, 1108, and 1109 respectively. The processing of a single arriving information element is handled by a control instance of the insertion and annotation process in box 1102. This processing was discussed when box 1102 was first introduced above in FIG. 7A. The processing of a single arriving update to entitlements is handled by a control instance of the “maintaining source based entitlements” process represented by box 1103. This processing was discussed when box 1103 was first introduced above in FIG. 7A. The processing and response to single request for repository information is handled by the “responding to requests to return information elements” process represented by box 1104. This processing was discussed when box 1104 was first introduced in FIG. 7A.

After completing the processing of an arriving information element, entitlement update or request for information, a choice is made in decision element 1114 whether to return to the head of the loop to handle more inputs. Under usual conditions when the repository is not shutting down the Yes branch will be taken and control flows back to the top of the action loop awaiting the next arriving action prompt. Repeated instances of this action loop result in additional information elements being added into the repository with annotations, additional entitlement updates being received and saved, and additional requests for retrieval of information stored in the repository being served.

The above flow is a logical control flow describing the method. Using well understood transaction, database and computer concurrency techniques, an advantageous embodiment of the method is able to handle multiple actions from different sources and requesters concurrently.

FIG. 8A shows an example of a conceptual organization of the repository's top level information elements. Box 1201 represents the overall repository, also represented generally as 20 in the discussion above. At the top level the repository includes a list of repository entities as represented in box 1202. Example repository entities ENT1, ENT2, and ENT3 within this list are represented by boxes 1203, 1204, and 1205, respectively. A repository entity (e.g. box 1203) is a collection of information all of which describes a single referred entity. For example, in a financial reference data repository, a repository entity might correspond to “common stock of company X”.

Each entity has associated with it an evolutionarily tracked source data tag (ETSDT). In the advantageous embodiment, ETSDTs are also attached as annotations to other lower level information elements in the repository. An ETSDT stores event information associated with the information element which it annotates and essentially chronicles the evolutionary history of the information element. This includes information describing: creation of the element, modification of its properties, creation of versions, etc. Each event stored with an ETSDT carries various information (identifiers, event descriptions, user IDs, timestamps etc.), but most importantly each event has a source (or sometimes multiple sources) and, if appropriate, an agent. The resulting availability of a fully sourced history for each information element is an enabler of the multi-source multi-tenant aspects of the repository. Information elements 1206, 1207, and 1208 represent the ETSDTs attached as annotations to example entities ENT1, ENT2, ENT3 respectively. At the entity level, the ETSDT records the information and associated quality enhancement actions, which prompted the creation of this repository entity.

FIG. 8B shows an example organization for the information of an entity in the repository showing the contents of the entity in more detail. Box 1203 is redrawn since it was already introduced as entity ENT1 in FIG. 8A. The previously introduced entity ETSDT for ENT1 is also redrawn in FIG. 8B attached as an annotation to ENT1 represented as data element 1206.

Each repository entity includes a list of entity properties represented as box 1209 and a list of entity item instances represented as box 1216. Entity properties are additional information about the entity that can include metadata information and business information about the referred entity that is not necessarily associated with a paid, or otherwise restricted source. Hence, properties could be internal identifiers, non-vendor owned classification information, etc. Normally, information stored within properties is made available to requesters in an unrestricted fashion and, as such, is used to construct indexes and to locate and select entities through shared access paths available to all tenants of the repository. Examples of properties of a repository entity, which refers to a financial instrument include: the full name of the instrument, identification as a stock or a bond, the industrial sector of the issuing corporation, etc. These properties are either public information or otherwise equally accessible to all tenants due to some business arrangement with tenants and/or data providers. If a property requires restricted access for whatever reason it should be represented as a versioned attribute instead.

Example repository entity ENT1 is shown with three entity properties P1, P2, and P3 represented by boxes 1210, 1211, and 1212 respectively. In this example, each entity property has annotations within the parent entity ETSDT (box 1206) relating to them. An advantageous embodiment places property annotations within the parent entity ETSDT. An alternative implementation could have separate ETSDTs associated with the properties.

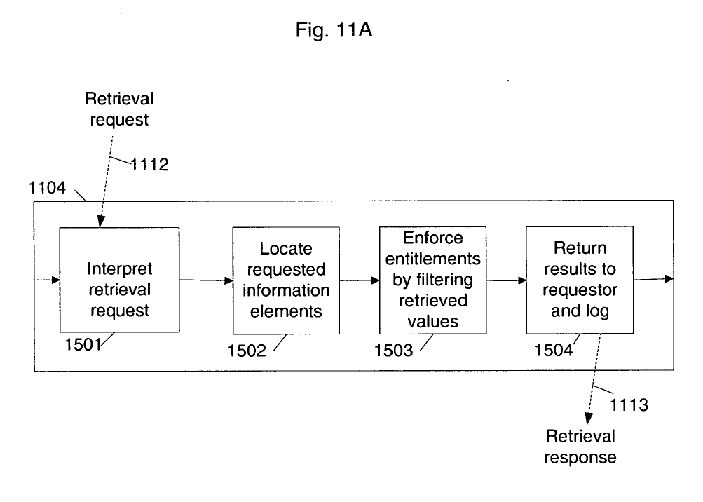

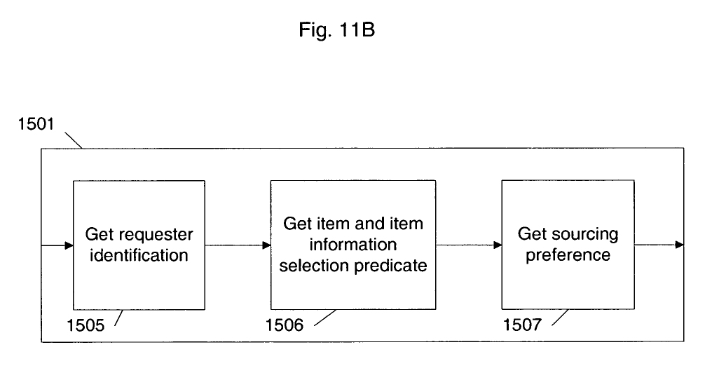

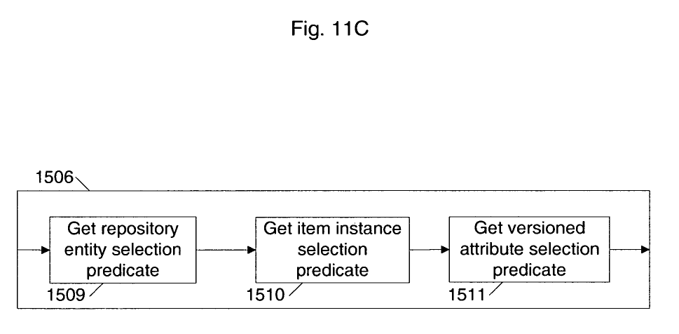

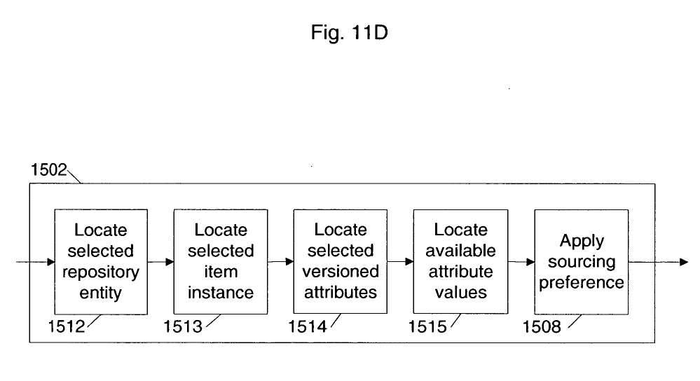

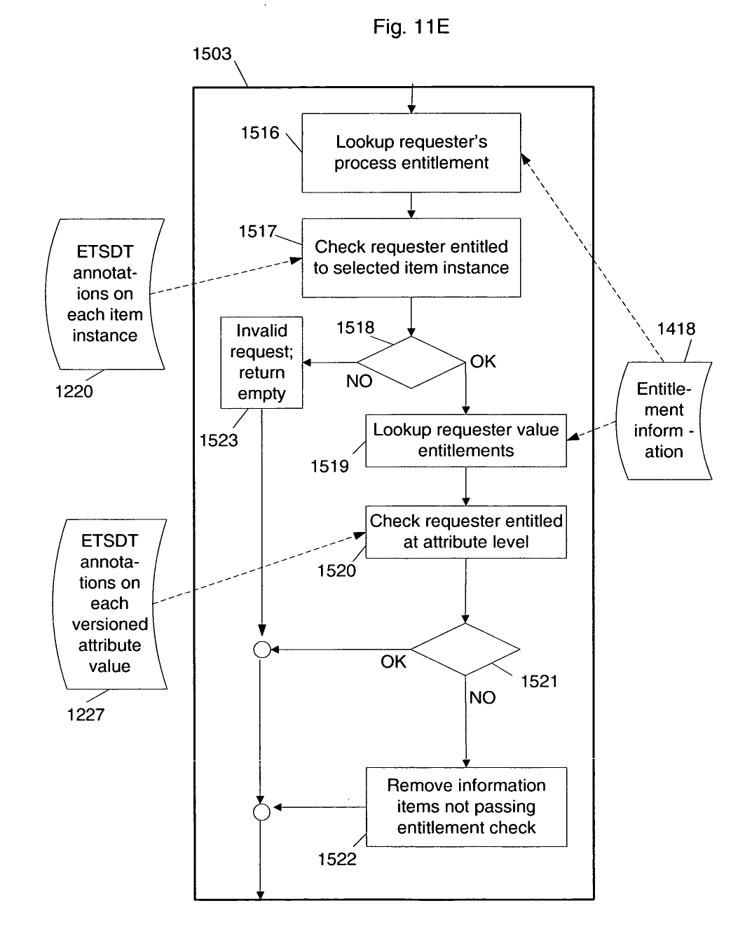

A repository entity includes a list of item instances. Each item instance gathers together and includes a set of all attribute values for the parent entity provided by a single, common sourcing. One common sourcing could be that all data in the item instance originated from a single source dataset provided by one source (e.g. Data Vendor A). Another common sourcing is that the data in the item instance was provided by a single identified item instance process (e.g. Value Comparison Process B). Distinct support for both types of sourcing is important because in the case of multi-source data enhancement processes, both the item instance process and the data sources contributing to that item instance process play a role in determining entitlement. This is further described in the entitlement enforcement processing description of FIG. 11E.

To further elaborate on item instance processes, an item instance process is any process that is used to create, update or review item instances. The concept of an item instance process covers many common methods of creating and working with item instances. Examples of item instance processes include: getting a feed/dataset of items from a source and applying validation, normalization and cleansing to the dataset; employing cross-source processes to compare information from several sources and selection of a preferred value based on this comparison; employing cross-source processes to create composite values that include attributes from multiple sources; and running an algorithmic value enhancement process against values provided by another source. Each such distinct process generates a separate item instance that is stored under the appropriate repository entity. It's possible to have composite item instance processes—as such, both “Normalized” and “Normalized, and Single Source Cleansed” are valid item instance processes where the former is a simple item instance process and the latter is a composite one, comprising of a normalization process and a single source cleansing process. Whether only a single source or multiple sources of information are employed during processing is an advantageous characteristic of an item instance process.

Box 1216 represents the list of item instances included in example repository entity ENT1 in FIG. 2A. Boxes 1217, 1218, and 1219 represent example item instances in this list, ITM1, ITM2, and ITM3 respectively. Each of these has an associated ETSTD attached to it as an annotation represented in the figure as rectangles 1220, 1221, and 1222 respectively.

In the context of a financial instrument reference data repository, possible examples of item instances for the entity representing “common stock of company X” include: (1) data on this instrument provided by Vendor A, (2) data on this instrument provided by Vendor B or (3) data on this instrument obtained from a repository service which compares data from multiple sources and selects a recommended value from these possibilities.

Note that an alternative embodiment may have a different scope for the various ETSDTs described (for instance, it is possible to have an implementation with a single logical ETSDT for entities and item instances, reflecting events in the history of both information elements). However, any such alternative implementation logically corresponds to the structures described herein.

FIG. 8C is an example organization for the information of an Item Instance showing its content in more detail. Box 1217 represents an expanded view of the example item instance ITM1 originally introduced in FIG. 8B. Data element 1220 represents the item instance's ETSDT previously described in FIG. 8B. In FIG. 8C, item instance ITM1 includes a list of versioned attributes represented as box 1223 and a list of properties represented as box 1230. The properties have annotations related to them stored in the ETSDT of their parent item instance (box 1220).

Each versioned attribute in the versioned attribute list includes a set of attribute values characterizing the parent repository entity with values provided by the source or item instance process associated with the parent item instances. For the previously introduced example of a repository entity with information about “common stock of company X”, examples of versioned attributes include (1) current price, (2) exchange where traded, (3) announced dividend accrual date, and (4) announced dividend amount.

In FIG. 8C, for item instance ITM1, versioned attributes VA1, VA2, and VA3 in the versioned attribute list are represented by data elements 1224, 1225 and 1226 respectively. Each of these versioned attributes has an associated ETSTD attached to it as an annotation, represented herein as data elements 1227, 1228, 1229.

Item instances also have associated properties that are available for use by requesters to access information stored in the repository. Item instance properties P4, P5, and P6 in ITM1's property list are represented by boxes 1231, 1232, and 1233, respectively. An important example of an item instance property is the unique item instance process identifier or source dataset identifier characterizing the source of information in the item instance. Item instance properties are also information elements and have annotations within the item instances ETSDT's relating to them.

FIG. 8D snows an example organization for the information of a versioned attribute showing its contents in more detail.

The enlarged box 1224 with its attached versioned attribute ETSDT, represented as data element 1227, includes this expanded view. It shows that a versioned attribute consists of a list of attribute values. Box 1237 represents the list of values for example versioned attribute VA1 as attribute values V1, V2, V3 in boxes 1238, 1239, and 1240, respectively.

Attribute values are the lowest level of information element and represent the atomic pieces of business data from which higher level versioned attributes, item instances and repository entities are composed. Multiple values of attributes exist within an item instance for one of the following reasons: (1) several collection and quality enhancement actions have been applied to the original source data leading to several viable values, (2) multiple values have been supplied by a single source for this attribute, or (3) the given item instance represents data produced by multi-source item instance process, and alternate values for the attribute are available from different sources.

When item instance processes modify an attribute more than once, each modification creates a new value (version) of the versioned attribute. The structure that allows detailed tracking of these changes is the versioned attribute ETSDT, which includes annotations pertinent to each attribute value. Each annotation is directly associated with a specific attribute value. The information stored in the ETSDT allows historical traceability of every attribute modification and, most importantly, includes information about the source(s) and agent(s) of such modifications. This knowledge is later used to decide whether the value can be provided to a specific requester.

To elaborate on the financial instrument example (using common stock of company X), item instance process P is an automatic cross-source comparison and value selection process which creates composite item instances. An employee employed on behalf of a reference data repository is responsible for reviewing and correcting (as necessary) the resulting composite item instances. The first time that process P is executed, a new item instance, 1, would be created under the repository entity representing common stock of company X. A property on that item instance indicates that process P is the item instance process producing this item instance. Since an item instance is composed of attributes, for a given attribute A within 1, process P includes, for example, the comparison and review of five attribute values V1, V2, V3, V4 and V5 provided by different sources (data providers). At the completion of process P, value V3 of attribute A is selected. In this example, value V3 would exist as a separate value (version) within the versioned attribute A, and would have a corresponding annotation in the versioned attribute level ETSDT, stating that V3 matches the value provided by data provider DP1 (source 1) and data provider DP5 (source 2), and was further confirmed based on review by data cleanser DC1 (agent) who, in turn, based the decision on review of a public document of Company X (source 3). As evidenced, this sourcing information can be complex, given the complicated potential item instance processes. An innovation of the repository is the ability to carefully keep track of all such sourcing history and then use it as a basis for responding to request for data within the confines of requester entitlements (described in FIGS. 11A, 11B, 11C, 11D and 11E.

In addition to storing repository entities with associated properties, item instances, versioned attributes and attribute values, the repository is used to store other objects such as value added functions and business documents. Entitlement tracking for these objects is needed as well, and it is possible to handle them entirely using the data structures described above. However, if the level of versioning and multi-sourcing for these objects is significantly simpler than the method was designed to provide, an alternate, and advantageous, embodiment is to store each such object in a separate list in the repository, with associated ETSDTs recording source and creation history, but storing all the object information in a simple entitlement managed value box. Such stored objects still have generally accessible properties at the top level enabling requesters to access them readily.

As in FIG. 8A, it should be noted that an alternative embodiment may elect to have a different scope for the various ETSDTs described (e.g. have separate ETSDTs for item instance properties). However, any such alternative implementation logically corresponds to the structures described herein.

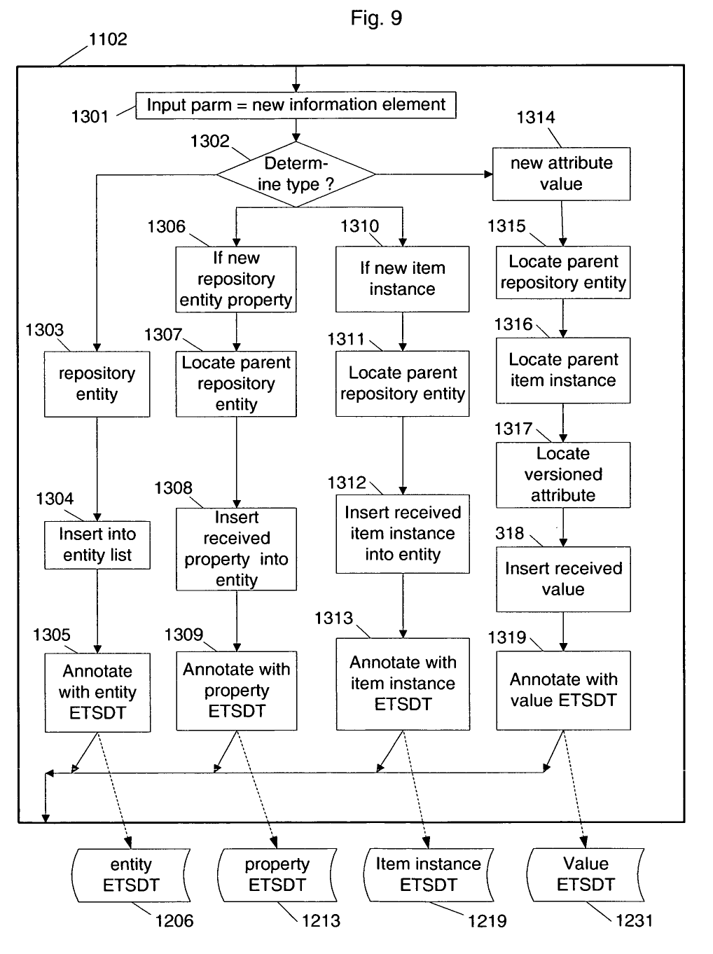

FIG. 9 expands box 1102 from FIG. 7A labeled “inserting information elements with sourcing annotations,” providing more detail about the sample control flow for an advantageous embodiment of this box. Multiple control flows exist based on the kinds of events and kinds of information elements being updated, however, they all follow the same general principle. For purposes of illustration, four processes are chosen: creation or updating of a new entity, creation or updating of a new entity property, creation or updating of a new item instance and creation or updating of a new attribute value.

Control flows into box 1102 in FIG. 9 when a new information element event arrives at the repository. The new information element to be inserted into the repository is available as an input parameter to the flow of FIG. 9. Box 1301 represents acceptance of the input event. Decision element 1302 is a test to determine the type of the new information element presented for annotation and insertion into the repository. Detailed flows are provided corresponding to creation or update of a new entity, creation or update of an entity property, creation or update of an item instance, and a new or updated value for an existing versioned attribute. These flows are represented by the outcome paths from decision element 1302 leading to boxes 1303, 1306, 1310 and 1314 respectively.

The FIG. 9 control path starting with box 1303 shows an example of a detailed flow for the creation of a new repository entity or update of a property of an existing repository entity. In the context of the financial instrument example this occurs when the repository starts keeping information on a new financial instrument or changes a property such as the “industry grouping” in which this instrument is classified.

Box 1303 represents the identification that the arriving information element defines a new entity. Box 1304 is the action of adding the new entity into the repositories entity list. Box 1305 is the action of creating the annotating entity ETSDT for the newly inserted entity. The dashed line joining box 1305 with data element 1206 shows that the updates are applied in an entity ETSDT as introduced in FIG. 8A.

The FIG. 9 control path starting with box 1306, shows an example of a detailed flow for updating or creating a new repository entity property. In the context of the financial instrument example discussed above, this occurs when some classification of the instrument is first known or changed, such that it is associated with the transportation industry.

Box 1306 labels that we are on the new entity property path. Box 1307 is the step of locating the parent entity described by this property. Box 1308 is the step of inserting the received property value into the property list for that entity or updating a previous value. Box 1309 is the step of annotating this new property with an ETSDT recording its source and other events in the path of creating a quality assured version of the received information. The dashed line to data element 1213 shows that this annotation is stored in the repository as an entity property ETSDT as described in FIG. 8B.

The FIG. 9 control path starting with box 1310 shows an example of a detailed flow for creating a new item instance for an existing repository entity. In the context of the financial instrument example discussed previously, creation of a new item instance for a repository entity whose referred entity is a corporate bond or common stock occurs when either a data provider, a source of information or an item instance process, such as a multi-source data quality enhancement process associated with the repository itself, starts providing attribute values for this bond or stock.

Box 1310 represents the identification of a new item instance for an existing repository entity. Box 13 11 represents the identification of the location of the appropriate parent repository entity to which the new item instance pertains. This is done on the basis of the referred entity or, if no repository entities currently exist for the referred entity, a process for creating a new repository entity is triggered. The flow continues after the proper parent repository entity has been located or created. Box 1216 in FIG. 8A shows that the list of item instances is a top level data structure in each repository entity. Box 1312 represents creation of a new item instance in this list using the provided item instance information or, if the arriving element is a property update to an existing item instance, applying this change. Box 1313 is the action of either creating a new item instance ETSDT or annotating the property change in an existing one. A new ETSDT records the creation of the item instance, and serves as the first annotation in the history of this item instance. The dashed line connecting box 1313 with data element 1219 shows the association between this update action and item instance ETSDT introduced in FIG. 8A.

The FIG. 9 control path starting with box 1314 shows an example of a detailed flow for creating or updating an attribute value in an existing item instance of an existing repository entity. In the financial instrument example discussed earlier, examples of processing new attribute values include when a particular source or item instance process provides new values for an attribute of the instrument, e.g., exchange where traded, maturity date or rating of a bond, or the date of accrual and amount of a dividend payment on a common stock.

Box 1314 represents identification of the new attribute value for an existing item instance of an existing repository entity. Box 1315 represents the identification of the location of the parent repository entity to which the new attribute value pertains. This is done on the basis of the referred entity. Box 1316 represents the identification of the location of the parent item instance to which the new attribute value pertains. This is done on the basis of the item instance process which triggered the input event. Box 1317 represents the identification of the location of the specific versioned attribute to which the new attribute value pertains. Box 1223 in FIG. 8B shows a list of versioned attributes to be a top level data structure of an item instance. In the financial instrument example discussed previously, information such as the exchange where traded, coupon payment details, rating, dividend amount and data are distinct versioned attributes of the subject financial instrument. Box 1318 represents addition of the new or updated value to the versioned attribute. Box 1237 in FIG. 8D shows that a list of included values is a top level data structure of a versioned attribute in the context of versioned attribute VA1.

Box 1319 represents the annotation of the new value within the ETSDT of the versioned attribute. The sourcing information included in the annotation exactly identifies the source(s) of the new value. The sourcing information is also a convenient place to store other information related to this event, such as: (1) specific documentation of the reasons for having the new value (e.g. the value was flagged for review by the cleansing engine), (2) specific documentation of research or validation actions taken (e.g. looked up the value in source A), (3) agent of the change (for instance, an employee tasked with reviewing values), etc. The dashed line connecting box 1319 to data element 1231 shows that the data object impacted by this tagging process is a versioned attribute ETSDT as introduced in FIG. 8D in the context of the ETSDT for the versioned attribute VA1 in item instance ITM1 in repository entity ENT1.

Control flow exits box 1102 from boxes 1305, 1309, 1313 and 1319 for the examples, respectively.

It has been noted that the repository could be also be used to store information such as value added functions or customer's business documents. These objects require some or all of the capabilities of repository entities with item instances and versioned attributes. It is possible to support the storage of such objects with repository and ETSDT's exactly as described herein. An alternate embodiment involves the use of a simplified data structure for these objects, encompassing storage of the object, properties to help locate it in repository, and a single ETSDT with sourcing information to manage entitlement to the object. Handling the addition of such an object to the store and annotating it requires some simplification and omission of steps from the control flow of FIG. 9. Such modifications will be obvious to practitioners of the art, after reading the material herein.

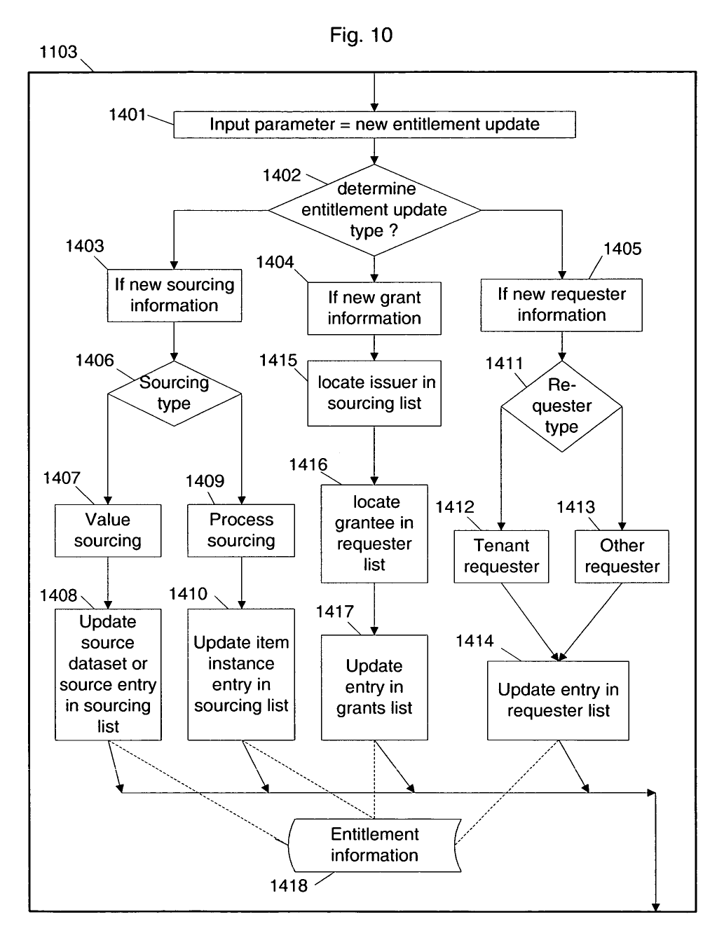

FIG. 10 expands box 1103 introduced in FIGS. 7A and 7B and labeled “maintaining source based entitlement information,” providing a more detailed control flow for an advantageous embodiment of this box.

Control enters box 1103 whenever new source-based entitlement information arrives at the repository as an input. The received entitlement information update is passed in to the flow of this figure as an input parameter. Box 1401 represents receipt of the updated entitlement information. Decision element 1402 is the step of determining the type of supplied entitlement information update. Three types of updated entitlement information are described: updated information is provided on a sourcing, on a requester or on a grant from a source to a requester.

Box 1403 represents entitlement information describing a new source or source process. Each source provides information on repository entities to the repository and grants particular identified requesters entitlement to the provided values. In the context of a repository including information on financial instruments, examples of a source are Vendor A or Vendor B. Each source makes their own contractual arrangements with external entities to provide raw data for a service fee. A repository that enhances and stores this information from multiple sources and delivers it to multiple tenant organizations in response to requests has to be able to demonstrate to each data source provider that no information has been passed to a requester not entitled to receive it.

Decision element 1406 represents the separation of new sourcing information into two types: value sources and process sources. Box 1407 represents processing of value sources; box 1409 represents processing of process sources. The previously provided source examples of Vendor A and Vendor B represent examples of value sources. Value sources deliver particular data services, in the form of source datasets, such as a stream of information on bonds or a stream of information on corporate hierarchy, in a manner that the specific values provided, and any values derived from them through the application of single-source dataset based validation processes, can be accessed only by requesters who have explicitly contracted with the source to receive then. Process sources represent value enhancement processes typically provided as a data quality assurance and enhancement process associated with the repository. Value enhancement processes are a type of an item instance process. Examples include validation and cleansing of a single source dataset in isolation and a comparison process using multiple source datasets providing alternate values for the same referred entity to select the most reliable value. Requesters need to be entitled to an item instance process as well as the attribute values used in the application of the item instance process in order to be entitled to receive values generated by applying that process to those source values. Boxes 1408 and 1410 represent the creation and maintenance of information uniquely identifying both value and process sources, respectively, as part of the entitlement information represented in data element 1418.

In addition to uniquely identifying and characterizing all sources (both process and value) that may grant entitlement, the information represented by data element 1418 also identifies and characterizes all requesters that receive entitlements. In an advantageous implementation of a reference data utility using this repository method, the entitlement information represented by data element 1418 is saved in the entitlement repository, data element 53 in FIG. 1B.

Box 1405 represents entitlement information describing a new requester. Information characterizing requesters is maintained so that all entitlement grants are well formed, resulting in well-defined target requesters that can be authenticated. Decision element 1411 represents the separation of new requestor information into two types of requester: tenant requester (clients) and other requesters. Box 1412 represents processing of tenant requesters, which are customers of the repository. Box 1413 represents processing of other requesters, which include personnel associated with the repository who provide repository maintenance or customer service and, in a financial context, individuals or entities associated with audit functions on behalf of exchanges, data providers, and legal or compliance review. Box 1414 represents maintenance of information on all such requesters (including the authentication procedure used to validate that specific requests are initiated on behalf of repository requesters) and ensures that this information is included in the entitlement information represented by data element 1418. The information maintained on tenant and other requesters and the methods used to authenticate them may differ or may be similar.

Block 1404 represents processing of an entitlement from a specific granter to an identified grantee. Box 1415 represents location of the granting source within the information already stored in the sourcing list represented by data element 1418. The entitlement granter may be a value source, a source dataset or an item instance process. Box 1416 represented identification of the requester requiring entitlement, the grantee, in the list of valid requesters. Box 1417 represents the creation of the new or updated grant of entitlement (an update may supplement or revoke previous entitlements) to this requester from this source for inclusion in the entitlement information represented by data element 1418. As noted previously this entitlement information could be stored in the repository or separately.

The entitlement information represented by data element 1418 enables enforcement of current entitlements during request processing. A stream of source and requester definitions and grants issued occurs, each generating separate flows at a different points in time through the logic described in FIG. 10.

FIG. 11A details the overall process employed by the repository to respond to requests for information based on requester preferences. Box 1104, introduced in FIGS. 7A and 7B, represents the overall high level flow of the process. Box 1501 represents receipt of the request for information, and interpretation of the request to extract the request specification. The request comes from any requester; that is any party or process acting on behalf of a customer or tenant, or an agent of any data management utility or system in the context of which the repository is being used.

Box 1502 represents the actions taken by the repository to locate the requested information elements.

Box 1503 represents the application of entitlements, thereby limiting the set of return values to those to which the requester is entitled. This is done on the basis of sourcing, which is possible because information elements in the repository are annotated with sourcing information as described previously. Because of this feature of the invention, the action represented by box 1503 becomes largely a matter of comparing the sources and processes to which the requester is entitled to the sources and processes which contributed to the requested information (see FIG. 11B for some of the finer details of this process). This can be contrasted with conventional systems in which entitlements typically only deal with the ability of users to execute particular functions, rather than access data from particular sources.

Box 1504 represents the final step of returning the resulting dataset to the requester. As shown by dashed arrow 1113, it is this step which generates the response to the retrieval request initially introduced as an output of the overall method 1100 in FIGS. 7A and 7B and logs as appropriate.

In FIG. 11B, box 1501, which represents receiving the request and extracting the request specification, is further decomposed into boxes 1505, 1506, and 1507. The request specification received by the repository includes an arbitrary number of parameters, but at the minimum, it includes the following:
identification of the requester (represented by box 1505)
a predicate governing selection of the information elements to be returned (represented by box 1506). The selection predicate can use implementation dependent languages (such as SQL) to specify which information elements the requester is interested in, and includes parameters that are typically expressed by means such as interest lists, temporal restrictions, conditional selection, etc.
an ordered list or other prioritization structure specifying the requester's preference of sources if multiple information elements from separate sources are available that satisfy the selection predicate in the previous step. This is referred to as a sourcing preference (represented by box 1507). Sourcing preference is a very important aspect of this invention because it is an advantageous piece of information used to navigate a repository in which data from multiple sources and belonging to multiple clients is located. The sourcing preference of the requester is used in conjunction with entitlements and evolutionarily tracked source data tags of information elements to ensure that requesters get only the information to which they are entitled. (The entitlement enforcement aspect of this process is described in more detail in FIG. 11B; also see the description of box 1503 above). It is also important to realize that some sourcing preferences may have a complex multi-level structure and exist at multiple information levels. For example, when creating a sourcing preference in the context of financial information, it reflects the following complex preference (sample): “for European stocks, the preference is: first, single-source cleansed Vendor A; if not available then single-source cleansed Vendor B; if not available then normalized-only Vendor C. For US bonds, the preference is: first, normalized-only Vendor A; if not available then single-source cleansed Vendor C, except where the bond is classified as corporate bond: in this case, first, single-source cleansed vendor C, then cleansed Vendor B. For all other bonds, the preference is for single-source cleansed values from all three of Vendor A, Vendor B and Vendor C. Finally, for US stocks, the preference is for values generated by a cross-source comparison and selection process X”. In this example, the sourcing preference touches upon multiple information levels (repository entities, item instances, attributes and metadata) and potential sourcing choices, and requires multiple levels of processing to satisfy.

An example of further elaborated flow for getting the information selection predicate is shown in FIG. 11C. The selection predicate part of the request specification can refers to any level of information within the repository and, as such, effectively includes predicates referring to any available information item, namely repository entity (represented by box 1509), item instance (represented by box 1510), and any attribute values (represented by box 1511). Once executed, the selection predicate yields zero or more information elements.

The main task of the process represented by Box 1501 in FIG. 11B is to parse, validate and extract the above items from the request received. The specifics of the process required to parse out this information are well understood by practitioners of the art and are not the subject of this invention.

In FIG. 11D, box 1502 is further decomposed into boxes 1512, 1513, 1514, 1515, and 1508 which show an example flow, in greater detail, of steps taken by the repository to locate the information elements matching the request specification extracted above. This process is aligned with the request specification aspects described in relation to box 1501. As explained, the two advantageous aspects of the request specification, the selection predicate and the sourcing preference, are frequently used to express quite complex concepts. To satisfy the request, the repository first performs information selection at all levels as needed, namely at the repository entity level, item instance level, versioned attribute and attribute value level. It is possible that metadata associated with these information elements is also selected. These activities are represented by boxes 1512, 1513, 1514, and 1515, respectively. This process forms a return dataset, to which the requester's sourcing preference is then applied, usually narrowing the dataset (represented by box 1508). This is done by comparing the sources specified in the sourcing preference to the sourcing information recorded in the repository for each information item. It is possible that some elements of the sourcing preference cannot be satisfied (for example, no information from preferred data sources was found); in this case the repository will need to include a special record reflecting this in the return dataset, or use other means of notifying the requester. In an implementation of the repository in the context, for example, of a multi-tenant reference data repository, multiple optimization options are available to make the process of locating information elements more efficient. These include controlled, data-driven methods of forming allowed requests, limits or minimum requirements on the number of preferred sourcing choices, table views, various repository indexing techniques, etc. However, at its functional core, any such implementation remains consistent with the described steps.

In FIG. 11D, selection of information is represented by box 1502. The selected information elements are then filtered through entitlements box 1503. In an alternate embodiment, entitlements 1503 could occur before or as part of 1502. When this is done all of the actions within box 1502, specifically 1512, 1513, 1514, 1515, and 1508 are subject to entitlements. They each return a response based on the entitlements of the requester.

FIG. 11E provides additional detail about the activities represented by box 1503 from FIG. 11A, namely, enforcing entitlements as part of the process of responding to a request. The multi-source, multi-tenant nature of the repository makes processing entitlement information a more complicated task than a simple filtering scheme that might be employed in single-tenant data management applications. Specifically, it is insufficient to enforce entitlements at a single point (for example, at the lowest data structure level—the attribute) because a multi-source multi-tenant data repository supports storing item instances generated by cross-source processes (a type of item instance process) which may themselves require entitlement. Further, it is possible to be entitled to a process, yet not be entitled to all values that this process generates, which is why a multi-level entitlement check takes place. For instance, continuing with the example of a financial instrument reference data repository, a reference data utility in which the repository exists may offer, as an additional service, a multi-source item instance process P that produces composite records based on multiple sources according to some algorithm. Tenant A of the repository subscribes to this service. However, based on the rules driving the service, the composite records it generates sometimes include information from a data source to which tenant A is not entitled. In these cases, such results are not returned to tenant A, even though tenant A is subscribed to the service. The two-level source check (process level and attribute value level) is required to detect and properly handle such situations. Optimizations include designating separate terms like “simple source” and “complex source” to help differentiate at runtime between item instance processes that require one-level entitlement checking vs. two-level entitlement checking. At its functional core, the entitlement checking process is aware of and accommodates both possibilities.

In FIG. 11E, the entitlement process is represented by box 1503 starting at the repository entity level (i.e. the desired repository entity has already been located). Box 1516 represents the retrieval of the requester's entitlement to item instance processes of the current repository entity using the entitlement information represented by data element 1418 as shown in FIG. 10. This entitlement information, and the steps required to create it, were described in FIG. 10. Box 1517 represents a check based on this entitlement information to determine whether this requester is entitled to access the selected item instances (recall that each item instance is associated with an item instance process). It is at this level that information about the item instance process that generated the given item instance is stored. Additional information stored in the ETSDT for the item instance may also need to be used, as represented by the dashed line connecting box 1517 with data element 1220. Decision box 1518 represents a flow checkpoint; if the check represented by box 1517 fails, the requester is not entitled to access this item instance; if the check succeeds, further checking at the attribute level occurs. In the event of a successful outcome at decision element 1518, box 5119 represents retrieval of the requester's entitlement to specific sources from the entitlement information represented by data element 1418. In an alternative implementation this step is combined with activities represented by box 1516. Box 1520 represents the actual entitlement check at the attribute level. This check utilizes sourcing information from a versioned attribute ETSDT (data element 1227) to ensure that only entitled sources have been used to produce the desired value. If the check passes (at the decision point represented by decision box 1521), the attributes and the enclosing item instance are entitled and are eligible to be returned to the requester. Otherwise, based on the nature of the item instance process, either the specific versioned attributes or the entire item instance is removed from the return set (represented by box 1522). This process proceeds across all selected item instances and selected attributes to produce a filtered dataset that is returned to the requester. This concludes the description of the flow diagrams pertaining to the repository aspect of the invention. If the test in block 1518 fails, then no entitle item instance is available so control flows out of block 1503.

C. Description of Data Cleansing and Value Enhancement

This section describes a method and organization for performing scalable data cleansing and value enhancement of arriving reference information in which both single data source enhancement processing and multiple data source comparison and enhancement processing are supported while the method still maintains full knowledge of all sources used in deriving reference data elements. In the context of a reference data utility, this method can provide the data acquisition and quality enhancement processing shown as box 19 in FIG. 1A.

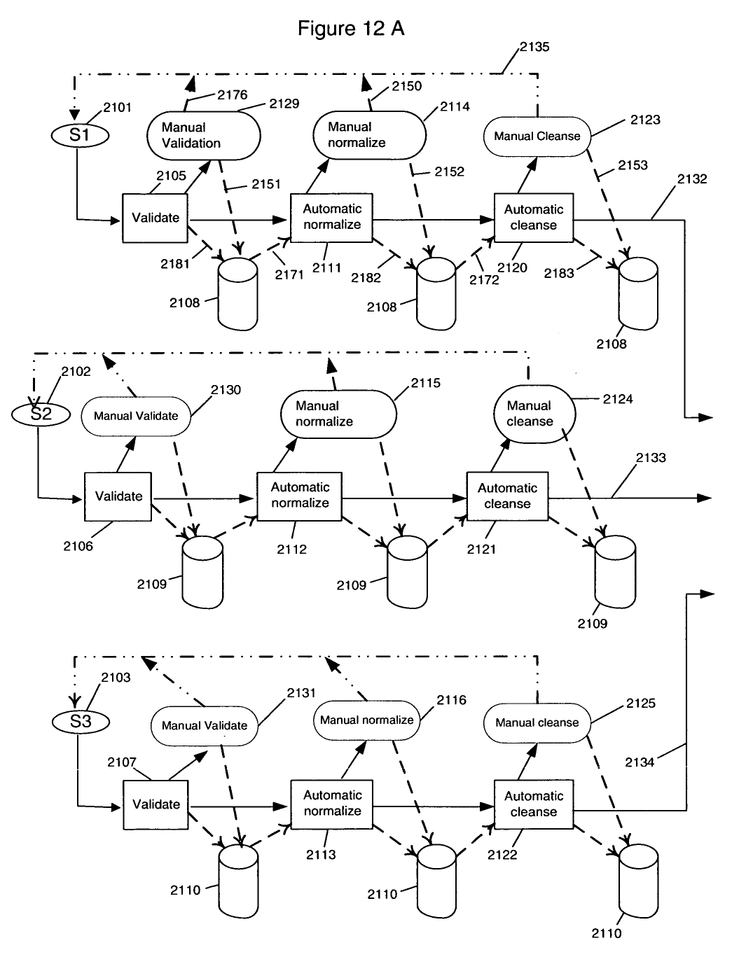

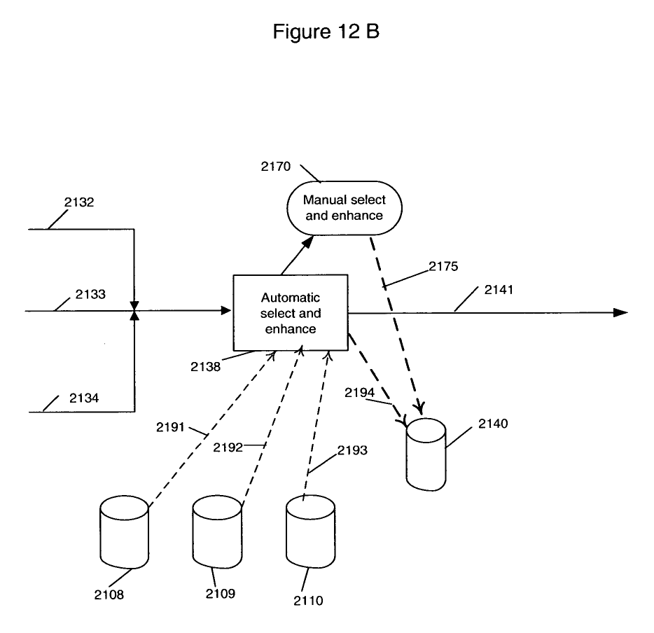

FIGS. 12A and 12B when taken together show a complete high level control flow for the Data Cleansing and Value Enhancement method (DCVE). FIG. 12A shows the single-source data cleansing portion of the DCVE. FIG. 12B shows the multisource data processing.

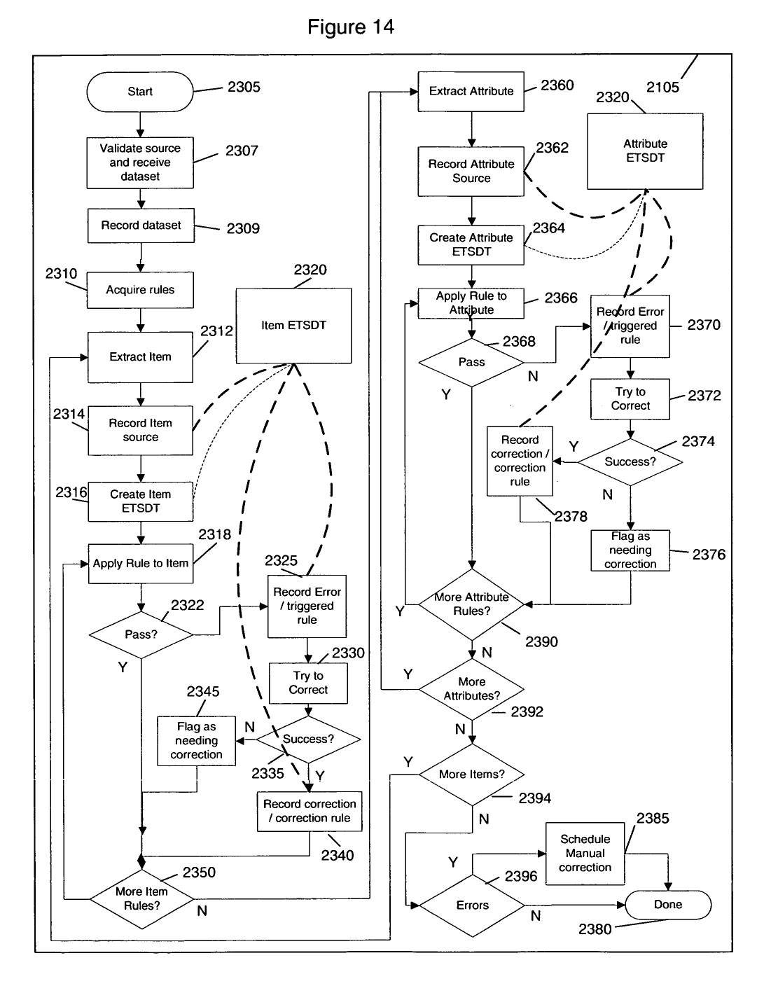

In FIG. 12A the vendor sources of data are represented by ellipses 2101, 2102, 2103. Multiple sources of data are concurrently processed by the DCVE. In FIG. 12A each source, represented by ellipses 2101, 2102, and 2103, is providing a dataset on reference data topic T1. In the context of a reference data utility, this corresponds to the T1 introduced as box 22 in FIG. 1A. Arrows 2132, 2133, and 2134, represent control transfers when single source DCVE processing is complete and multiple source DCVE processing in FIG. 12 can be initiated. FIG. 12A describes at a high level how source attributes are processed for this dataset. Source items are processed in a similar manner. More detail on source and attribute processing is given in FIG. 14.

In general, data is received and processed for multiple topics in this component. Topics are properties that enable hierarchical organization within the repository. Examples of separate reference topics in a financial reference data repository include:
reference data on financial instruments;
corporate hierarchy and counterparty information; and
corporate action event notification.

The DCVE processing of separate topics is independent. However, the same source descriptions are used for any common concepts and, in the advantageous embodiment, the received qualified reference data values are stored into the same repository. The source description contains information describing structure, contents and constraints on data within datasets provided by a particular source.

FIG. 12A shows the DCVE processing for three data sources supplying reference data values, source S1, source S2 and source S3 represented as ellipses 2101, 2102, and 2103, respectively. There can be any number of sources of data values on a specific topic divided between licensed vendors, free public sources and qualified on-demand sources. In our description of this figure we are assuming that the sources are supplying data for the same topic. This assumption allows us to illustrate cross source processing in FIG. 12B. However, the DCVE processes data from multiple sources on different topics concurrently. The DCVE processes as many sources and topics as are available and is not limited to processing three concurrently. DCVE processing treats each source as an independent dataset of reference data values. Elements 2105, 2111, 2120, 2129, 2114, and 2123 deal with source S1 values; elements 2106, 2112, 2121, 2130, 2115, and 2124 deal with source S2 values, and elements 2107, 2113, 2122, 2131, 2116, and 2123 deal with source S3 values. The repository is represented by elements 2108, 2109 and 2110. We represent this as separate storage for each stream to show that the intermediate processing results during the DCVE processing are managed independently for each stream. In an advantageous implementation of a reference data utility using this DCVE method for input processing, this storage would be provided within a single utility repository as shown as element 20 in FIG. 1A. Separate DCVE processing of each source dataset enables the recording of the source of each processed value.

DCVE processing for source S1 values is described in greater detail; the corresponding processing of the other sources is similar. DCVE processing of a single source proceeds in steps:
attribute and item validation and creation of ETSDT, represented by box 2105 and ellipse 2129 for source S1;
attribute and item normalization, represented by box 2111 and ellipse 2114 for source S1; and
source-specific attribute and item value cleansing, represented by box 2120 and ellipse 2123 for source S1.

The modified attribute and item values are stored in the repository. All of the events and sources used to create the modified values are recorded as ETSDT annotations also contained in the repository. The repository is represented by element 2108. These steps are sometimes followed by a step that applies one or more processes of cross-source attribute value comparison, potentially using data from a variety of sources providing data on this topic. This is illustrated in FIG. 12B described below. Box 2105 represents the first step inside the DCVE component; receiving and processing datasets arriving from source S1. This step handles the receive protocol and getting the dataset from source S1 into the repository. Attribute validation processing usually includes:
authentication of source, acknowledge, protocol and format handling;
assignment of unique identifiers and/or timestamps to input records;
verification that the source attribute values conform to the source description; and
manual validation for any elements of the dataset that cannot be automatically validated.

After receiving the dataset and validating it for acceptance into the DCVE component, the validated attributes are stored in the repository and events arising from validation of the attributes from source S1 are logged, as represented by arrow 2181, into the ETSDT(s), which are also stored in the repository. The repository is represented by box 2108. This logging is done by recording the results of validation, actions taken during validation, and the completion of the attribute validation as ETSDT annotations.

It is possible that anomalies are present in the received dataset that cannot be validated automatically. When this occurs, those parts of the dataset are passed to manual validation, represented by ellipse 2129, where a human with business knowledge corrects the errors if possible. After manual validation, the validated attributes are stored in the repository and the events that arise during manual validation from source S1 are logged, as represented by arrow 2151, as ETSDT annotations.

Box 2111 represents the automated attribute normalization processing of the arriving data from source S1. This step deals with the issue that particular reference data attributes may be referred to with different attribute names by different dataset sources. Furthermore, particular attribute values for the reference data item may be represented in a different way in different sources. Dashed arrow 2171 shows validated data from the preceding manual or automatic validation step being made available as input to automatic normalization 2111.

The target description contains information describing the structure, contents and constraints on repository entity information, including item instances, versioned attributes and attributes as they are stored in the repository. Received attributes for a reference data item are translated into a standard representation. Attribute normalization processing usually includes mapping the source attribute from the source description to a target attribute based on the target description. This process looks up the reference data attribute supplied by source S1 in a source description so that the standard attribute name is matched. Looking up and translating the attributes is done automatically by applying a set of lookup and automated rule steps for efficiency reasons. This includes transforming source attribute values to target attribute values. The normalized attribute names and values are stored in the repository. The events and sources used to created the normalized attribute names and values are recorded as ETSDT annotations, as represented by arrow 2182.

Sometimes attribute name and value lookup fails or other anomalies are detected during the automated attribute normalization step. For each exception case the problem reference data is forwarded to the manual attribute normalization processing step represented as ellipse 2114. In this step, a human with business knowledge and skilled in the subject topic decides whether to accept or how to modify the anomalous value. For example, the human decides whether a financial instrument entity whose name was not in the source description is a newly created type of financial instrument which has not been seen before and needs to be added to the source description or whether the name is a misspelling or other data input error of an existing named instrument. The normalized attribute names and values are stored in the repository. The events and sources used to create the normalized attribute names and values are recorded as ETSDT annotations and stored in the repository, as represented by arrow 2152.

After a received reference data attribute is normalized, either by automatic processing or after inspection and possible manual correction, the normalized attributes are stored in the repository and the events used to normalize the attributes from source S1 are logged, as represented by arrows 2182 and 2152 respectively, into the ETSDT(s). This logging is done by recording the results of normalization, actions taken during normalization, and the completion of the attribute normalization as ETSDT annotations.

After attribute normalization is completed, arriving reference data from source S1 goes through a source-specific item cleansing process as represented by boxes 2120 and 2123. The purpose of source-specific item cleansing is to verify the correctness of the data content through the application of business rules, without reference to any other source.

The first step is an automatic cleansing phase, which is represented by box 2120. Dashed arrow 2172 shows normalized data saved in the previous normalization step being made available as input to automatic cleansing. In step 2120, automated cleansing checks for missing data, garbled data, data values out of expected range (range tolerance), data which has changed by some unreasonable shift from the previously known value (rate of change), how well-formed the data is, consistency with the target item instance (described by the target description), compatibility with well known referred entities of similar target description, sensitivity to recent news, and other programmable source attribute value checks. These checks are based on the information contained in the source and target descriptions. Again, for efficiency reasons, in order to filter through the bulk of arriving data which will be required to pass all of these tests, it is advantageous for the initial cleansing phase to be automated. The cleansed attributes are stored in the repository and the events and sources used to create the cleansed attributes are recorded as ETSDT tag annotations and also stored in the repository, as represented by arrow 2183.

Some items fail the automatic cleansing checks represented by box 2120 and are separated out as exceptions and passed to manual cleansing represented as ellipse 2123. At this point, a human with business knowledge and skilled in the subject topic reviews the excepted items and decides whether to accept, reject, or to correct the arriving anomalous normalized value. This source specific item cleansing is still done only with reference to data arriving from source S1. Freely distributed public information is used to improve, cleanse or augment data, but no other vended licensed data is used. This constraint is necessary in order to avoid contaminating data ownership and right of access to the other sources. The use of freely available information can also be logged. The cleansed attributes are stored in the repository and the events and sources used to created the cleansed attributes are recorded as ETSDT tag annotations, also stored in the repository, as represented by arrow 2153.

After a normalized attribute is cleansed, either by automatic processing or after inspection and possible manual correction, the cleansed normalized attribute is stored in the repository and the events used to create the cleansed normalized attribute from source S I are logged to the repository, as represented by arrows 2183 and 2153 respectively, in the ETSDT(s). This logging is done by recording the results of cleansing, the actions taken during cleansing, and the completion of the cleansing as ETSDT annotations.

In an alternate embodiment cleansing of the arriving dataset from a source is performed first and normalization afterwards. The advantage of the ordering shown above is that the valuable human resource used to inspect and manually cleanse arriving data is more freely assignable from one source to another if they are familiar with reviewing already normalized values.

Error detection usually results in manual steps: manual normalization (ellipse 2114), manual validation (ellipse 2129), and manual cleansing (ellipse 2123); and/or causes the feedback or problem reporting, represented by arrows 2135, 2150, and 2176, to the dataset source (ellipse 2101). Typically, if an error or problem is found or thought likely in a reference data value received from source S1, the data provider is notified and asked to confirm or correct the provided value.

This style of feedback between DCVE processing and sources is best handled by making further use of the ETSDT. Values which have passed through the DCVE processing without issue are tagged as normal. Other values are passed on for potential use but tagged as ‘questionable’ or ‘awaiting confirmation’. Values tagged this way are typically used by those repository tenants who need to receive updated values in real-time despite the probability of error. When a source provides an updated or confirmed value in response to notification that a previous value received from them was tagged ‘questionable,’ the updated value is processed with a corresponding normal tag.

After single source validation, normalization, and cleansing is complete, the cleansed and enhanced data is made available for one or more multiple source DCVE processes. Arrow 2132 shows the flow of control conveying single source DCVE processed data from source S1 to a multiple source DCVE process in FIG. 12B. Similarly arrows 2133 and 2134 represent single source DCVE processed data from sources S2 and S3 respectively being made available to the same example multiple source data cleansing process in FIG. 12B. The single source DCVE processing of data from sources S2 and S3 were handled by independent parallel processing similar of structure to the method we have describe in detailed as applied to the single source DCVE processing for the data from source A.

In the example shown here with FIGS. 12A and 12B we show three sources each being cleansed individually then the results being used as input to a single multiple source DCVE process. The method can be generalized from this description and can be applied to individual single source cleansing of any number of sources, followed by a stage of delivering the results from any one single source DCVE process to any number of multiple source DCVE processes.

Automated workflow management techniques may be used to facilitate coordination and management of the manual steps 2129, 2114, 2123, 2130, 2115, 2124, 2131, 2116, and 2125. There are a number of alternative implementations such as semaphores or loosely coupled distributed processes. Those skilled in the art know how to coordinate asynchronous processes. The exact mechanism used to coordinate the individual steps of the described flows is not important to this process. There are many techniques known to the practitioners of the art which can be used for these purposes.

FIG. 12B illustrates the cross-source cleansing value enhancement portion of the Data Cleansing and Value Enhancement process (DCVE) that is applied after source-specific item cleansing has been completed. The DCVE process may apply one or more cross-source item comparisons and/or cross-source item cleansing processes. One example of such a cross-source process provides the selection of a recommended value for a normalized attribute across all source datasets. This example is used for illustration of the concepts of this figure. The basic components of this process are represented by box 2138 and ellipse 2170.

Arrows 2132, 2133 and 2134 from FIG. 12A to the automatic select and enhance step represented by box 2138 represent transfer of control to the multiple source DCVE processing of FIG. 12B when new single source DCVE processed data becomes available from sources S1, S2 or S3. The method of synchronization is not important for the invention. In general as soon as new data from any of the input sources is available this can be compared with previously received values from this and other sources and a level of multisource DCVE processing can occur. In other cases it may be efficient to batch the multisource processing following some fixed schedule or when a full set of single source cleansed data is a available for a particular reference entity from all expected sources. The processing of box 2138 uses the separately normalized and cleansed values from some subset of source datasets for this topic, applying automated business rules to select a preferred or recommended value for this reference data item. Arrows 2191, 2192 and 2193 represent retrieval of these values from the repository where they were stored in as saved data during the single source processing of FIG. 12A represented by store elements 2108, 2109, 2110.

The resulting recommended cross-source compared and cleansed values are then stored in the repository, as represented by arrow 2194. The events and sources used during the process of cross-source cleansing, as well as the completion of the cross-source cleansing process are recorded as ETSDT annotations, which is reflected by arrow 2194 as well. ETSDTs are also stored in the repository represented by element 2140. As noted above this element shows that the results of a particular multiple source DCVE process are saved to make them accessible to subsequent requesters entitled to values from this value creation process. In the context of a reference data utility, store element 2140, along with store elements 2108, 2109, 2110 would share a common store for entitlement managed entity data as was represented as element 50 in FIG. 1B as part of the utility repository 20.

When the automated process cannot arrive at desired results, manual intervention is employed, as shown by element 2170. The resulting recommended cross-source compared and cleansed values are then logged, as represented by arrow 2175, in the ETSDT. The events arising from this manual process are similarly logged as ETSDT annotations in the repository 2140. This logging is also shown by element 2175.

All source datasets received, validated, normalized, cleansed and prepared as target datasets, along with any attribute values enhanced through cross-source comparison and/or cleansing processes, are stored separately in the ETSDT repository. Each of these datasets of reference data values has clearly understood sourcing. Multiple cross-source dataset processes in the DCVE result in datasets in an ETSDT tagged with all the referenced sources. All cross-source processes that produce datasets store the actions undertaken in ETSDTs with all referenced sources logged. The ETSDTs are stored in the repository represented by element 2140. In an alternate embodiment it is possible to use a different number of ETSDTs as appropriate.

Automated workflow management techniques facilitate coordination and management of the control transfers 2132, 2133, 2134 and processing steps 2138, and 2170. There are a number of alternative implementations such as semaphores or loosely coupled distributed processes. Those skilled in the art know how to coordinate processes.

The detailed flow for DCVE processing for a single topic is described herein. This processing is repeatable for each reference data topic, with the understanding that:
there may be qualitative differences in that some topics are driven almost entirely by licensed feeds with atomic instrument data; and
topics such as corporate and counterparty hierarchies may have more coupled records and require more activist data gathering.

Despite these qualitative differences in emphasis, the pattern and structure of data, acquisition, quality assurance and enhancement are essentially the same across topics. The net effect of the data acquisition, cleansing and enhancement process is to provide a “production line” approach for receiving and engineering a high level of quality of reference data while completely preserving auditable and transparent ownership of the data.

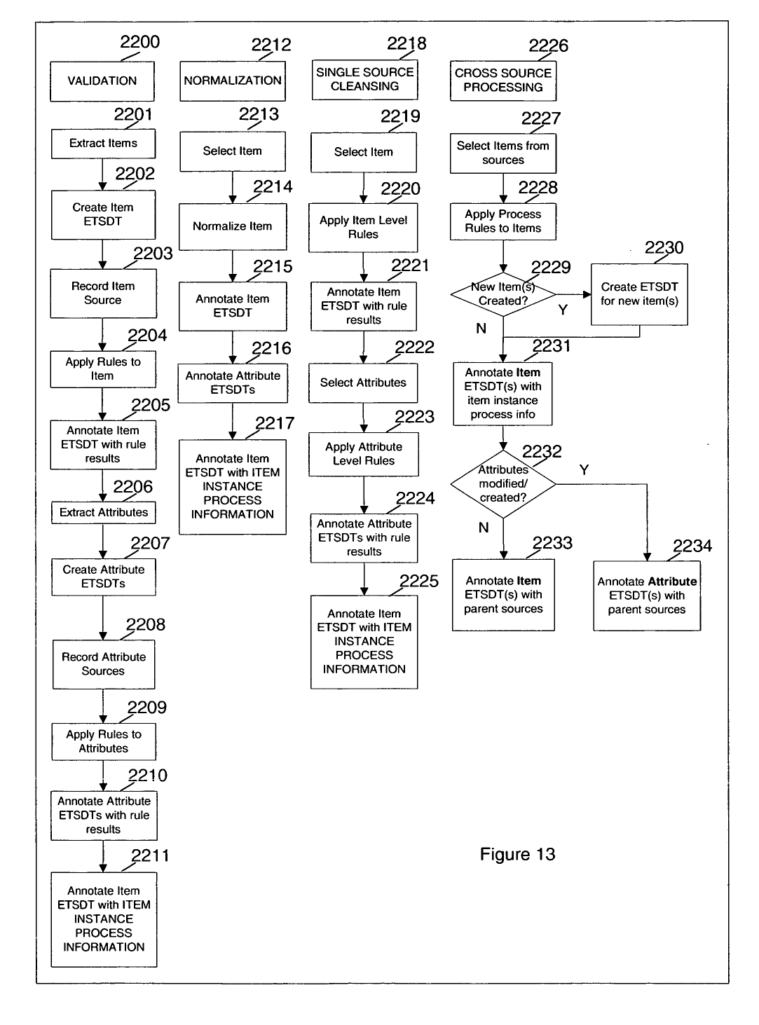

FIG. 13 provides a high level overview of the processes of validation, normalization, single-source cleansing and multi-source processing. The term “multi-source processing” rather than “multi-source cleansing” is used to denote that multi-source processes vary greatly in nature and encompass not only basic quality assurance of data, but also select between incompatible values, generate new values based on several sources, or any other programmable process which references multiple sources of data. FIG. 13 particularly stresses the interactions with ETSDTs of respective information elements at the various steps of the described processes.

The first column, headed by box 2200, describes the validation process. This corresponds to the processing of steps 2105,2106, 2107, for an automated version, and 2129,2130 and 2131 for a manual version in FIG. 12A Validation is typically the first process applied to an arriving dataset, and its function is to perform basic structure and content validation. The first step is to extract source items from the dataset, represented by box 2201. This is typically done based on the source dataset description supplied by the data provider, which normally details headers, record structures or delimiters and similar information. Once source items are extracted, a fully tracked history for each source item begins. Box 2202 represents the creation or update of an ETSDT for each source item to record the events of the source item's history. One of the first pieces of information recorded in the ETSDT is the source of the item, represented by box 2203. Because later on the information collected in items may no longer be grouped by source, it's very desirable to preserve source information at the lowest level available. Once this is done, validation rules are applied to the source item, as represented by box 2204. The rules are typically created based on source description information and exist at source item level and attribute level. In some embodiments there may be no rules which apply to a source item. Box 2205 represents annotation of the ETSDT to reflect the application of source item level rules. The information stored includes which rule was applied and the outcome of applying the rule (e.g. pass/fail). If a correction was applied, that is recorded as well. When corrections are applied (at any level), the original record is not overwritten, but kept as a previous version, with the ETSDT serving as the history detailing such information as when, why, and during which processes corrections were made. If the correction has a specific source (for instance, if a correction was applied manually by an employee who used an original business document as a source), this is recorded in the ETSDT as well.

Once source item level validation rules are applied, processing moves to the attribute level. Similar to the process applied to extract source items from the source dataset, box 2206 represents extraction of attributes from each source item. Following this, an ETSDT is created for each attribute and the original source of the attribute is recorded in the ETSDT, actions represented by boxes 2207 and 2208, respectively. Attribute level rules are applied (box 2209) and all the resulting events and sources associated with rule application are recorded in the ETSDT (box 2210).

The process, 2200-2211, is repeated for all source items and attributes. Box 2211 represents a notation to the ETSDT indicating that a source item processed in the above manner has gone through validation. Validation is an example of an item instance process in which information in a dataset has been affected in some manner by the repository. Recording the item instance processes which have been applied to a source item is a desirable operation as this is essential to maintaining an auditable history of the data.

The second column of FIG. 13, headed by box 2212, describes the process of normalization, which typically follows validation. This corresponds to the processing of blocks 2111, 2112, 2113, for an automated version and 2114, 2115 and 2116 for a manual version in FIG. 12A. At this point, the source items have already been extracted from the original source dataset, and are selected one by one to be normalized, a process represented by box 2213. Each source item (box 2214) is normalized in the manner employed by standard extract-transform-load (ETL) processes—structure modifications, code lookups, application of standards, and similar processes. Changes made during this process can be at the source item level (e.g. structural) and/or attribute level (e.g. date format), and are recorded as annotations in the ETSDT at the source item level, as represented by box 2215, or attribute level, as represented by box 2216. As with the validation process, the original version of the item is retained. Box 2217 represents annotation of the item ETSDT at completion of the normalization process, indicating that the item has undergone the process of normalization (Box 2217).

Single-source cleansing, headed by box 2218, is shown in the third column. This corresponds to the processing of boxes 2120,2121 and 2122 in an automated version and boxes 2123, 2124 and 2125 in a manual version. Box 2219 represents the first step of selecting an item for cleansing. As not all source items need to be cleansed, performance of this step is based on preliminary flagging, a random sampling algorithm or some other algorithm as necessary. During cleansing there are rules that apply at source item level (e.g. problems with correlation between different attributes of an item) or at an attribute level (e.g. a price is too far beyond a certain threshold). As box 2220 represents, source item level rules are applied first. Then, as represented by box 2221, events generated during the application of these rules are recorded in the item level ETSDT as before. Attributes are selected and rules are applied at attribute level, as represented by boxes 2222 and 2223, respectively. The events are recorded, represented by box 2224, in the attribute level ETSDT. As with the other processes, the final box 2225 represents annotation of the source item level ETSDT at completion of the process to show that the item has gone through the single source cleansing item instance process.

The final column of FIG. 13 shows cross-source processing headed by box 2226. This corresponds to the processing of box 2138 in automated form and 2170 in manual form in FIG. 12B. Cross-source processing is especially interesting because items from multiple sources which refer to the same real-life entity (referred entity) are involved. This requires especially careful recording of the item and attribute sources.

Cross-source processing begins with selection of all of the source items that contain information describing the same referred entity. This is represented by box 2227. For example, if IBM common stock is the referred entity, the item from source A, source B and source C, representing IBM common stock as provided by these different sources, would be selected. Next, box 2228 represents application of the rules to the source items and/or attributes of the items. Because a rather large number of possible cross-source processes exist, further detail is not shown. However, most cross-source processes tend to fall into one of the following categories:
processes that only select the “best” or otherwise preferred or recommended item from the alternatives provided by the different sources;
processes that create new items based on some combination of attributes provided by the different sources; or
processes that modify in place the items provided by the different sources.

For those processes that create a new item or items, a new corresponding ETSDT is created. This is represented by the decision box 2229 and box 2230. Box 2231 represents the annotation of the ETSDT at the source item level with the information about the cross-source processing applied to the item. At runtime, this annotation identifies exactly what kind of cross-source process was applied. Box 2232 represents a decision point that distinguishes handling of cross-source processes that only select preferred or recommended item from the other processes. If the cross-source process was of this type, i.e. an existing item was selected but no attributes were actually modified, then an annotation is made at the source item level to denote which parent sources matched the selection made, as represented by box 2233. For instance, if an item representing IBM common stock with price of $95.50 was selected, it's possible that more that one source participating in the cross-source process contributed the same data. In this case, the annotation represented by box 2233 would include all such sources. Alternatively, if the cross-source process is of one of the two other types, that is, if it includes either modification of data at an attribute level or a creation of a new source item altogether, then it is necessary to annotate the exact set of sources for each attribute separately. In this case, box 2234 represents appropriate annotations at the attribute level for each impacted attribute. Multiple sources per attribute are also possible.

The exact mechanism used to coordinate the individual steps of the described flows is not important to this process. There are many techniques known to the practitioners of the art that are used for these purposes.

FIG. 14 shows the processing required to perform single-source dataset validation. This process was first described in FIG. 12A, box 2105 and elaborated in FIG. 13, elements 2200 through 2211.

During this process the original item values and original attribute values as well as all modifications to those values are stored in the repository. Box 2320 represents where the item ETSDT is updated and box 2321 represents where the attribute ETSDT is updated.

Commencement of validation is represented by box 2305. All of the rules applied in this step are source-specific; no cross-source processing is allowed. Next, as represented by box 2307, the source is validated and the dataset is received. If the source is invalid the dataset is recorded and the entire dataset is sent to manual processing for source validation. Otherwise, a record of the receipt of the dataset is made and the rules for validating this dataset are acquired, activities represented by boxes 2309 and 2310, respectively. These rules are in a file, database, or other appropriate store. Box 2312 represents extraction of the first source item from the dataset. The item and its source are recorded and the ETSDT is created; boxes 2314 and 2316 represent these activities.

The first applicable rule is applied to this item, represented by box 2318. If the item passes rule application, a decision represented by diamond 2322, then an additional query is performed, as represented by diamond 2350, to search for additional rules. If an additional rule is found, the rule is applied to the item, again represented by box 2318. If an item does not pass rule application as represented in diamond 2322, then the error is recorded in the ETSDT, represented by box 2325. After the error is recorded, the system attempts automatic correction, represented by box 2330, based on the information in the applied rule or in rules for correcting errors. Success or failure of the attempted correction is represented by diamond 2335. Box 2345 represents the action taken if the problem cannot be corrected, where the item is flagged as needing correction. After item flagging, the process continues to search for more rules, the same query represented by diamond 2350 as explained above. If the item is automatically corrected, the correction and the rule used to make the correction are recorded in the ETSDT, represented by box 2340. The process continues to search for more rules.

If the query represented by diamond 2350 returns no additional rules that apply to the item, then extraction of an attribute associated with this item occurs, as represented by box 2360. The attribute and its source are recorded and the ETSDT is created or updated, as represented by boxes 2362 and 2364, respectively. Box 2366 represents application of the first applicable rule to the attribute. If the attribute passes the rule application, a decision represented by diamond 2368, then an additional query is performed, as represented by diamond 2390, to search for additional rules. If an additional rule is found, the rule is applied to the item, again represented by box 2366. If an attribute does not pass rule application as represented by diamond 2368, the error is recorded in the ETSDT, represented by box 2370. After the error is recorded, the system attempts automatic correction, represented by box 2372, based on information contained in the applied rule or in rules for correcting errors. Success or failure of the attempted correction is represented by diamond 2374. If the error is automatically corrected, the correction and the rule used to make the correction are recorded in the ETSDT, represented by box 2378. The process continues to check for more attribute rules. Box 2376 represents the action taken if the error is not automatically corrected, where the attribute is flagged as needing correction. After item flagging, the process continues to search for more rules, the same query represented by diamond 2390 as explained above.

If the query represented by diamond 2390 returns no additional rules that apply to the attribute, then the process searches for additional attributes, as represented by diamond 2392. If another attribute is found, it is extracted (box 2360) and the rule check for the new attribute proceeds. If the query represented by diamond 3292 returns no additional attributes for the item, the process searches for additional items in the dataset, a query represented by diamond 3294. If this query finds an additional item, then, as represented by box 2312, item and attribute checking starts for the new item. If the query represented by diamond 2394 returns no additional items, we check to see if any errors were found during source dataset processing, as represented by diamond 2396. If no errors are found the validation process terminates (block 3280). If errors are found, all of the items and attributes determined as needing correction are scheduled for manual validation (or manual correction), represented by box 2385, and the validation process terminates (block 2380).

The exact mechanism used to schedule manual validation and pass control to it while concurrently continuing processing of the parts of the dataset that are not in error is not important to this process. There are many techniques known to the practitioners of the art which can be used for these purposes.

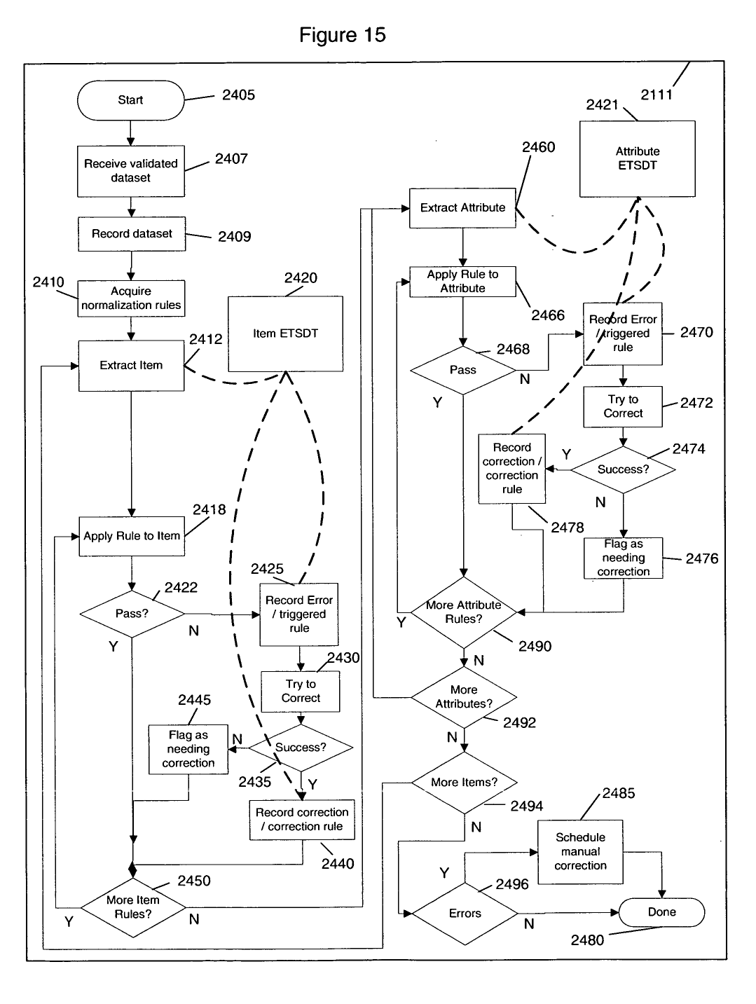

FIG. 15 shows the processing required to perform normalization of a source input stream, which is represented as box 2111 in FIG. 12A. This process is elaborated in boxes 2212 through 2217 of FIG. 13.

During this process the original item values and original attribute values as well as all modifications to those values are stored in the repository. Box 2320 represents where the item ETSDT is updated and box 2321 represents where the attribute ETSDT is updated.

Box 2405 represents commencement of normalization. Next, as represented by box 2407, the validated dataset is received. A record of the receipt of the dataset is made and the rules for normalization of this dataset are acquired, as represented by boxes 2409 and 2410, respectively. Because this is a single-source normalization process, all of the rules are source specific and do no rely on data or information from any other source. These rules are in a file, database, or other appropriate store.

The first item is extracted from the dataset, as represented by box 2412, followed by application of the first rule to this item, as represented by box 2418. If the item passes the rule application, as represented by decision diamond 2422, then the dataset is checked for additional applicable rules, as represented by diamond 2450. If an additional rule is found, it is applied to the item (box 2418). If an item does not pass rule application as represented by decision diamond 2422, then the error is recorded in the ETSDT, represented by box 2425. After the error is recorded, the system attempts automatic correction, represented by box 2430, based on the information in the applied rule or in rules for correcting errors. Success or failure of the attempted correction is represented by diamond 2435. Box 2445 represents the action taken if the problem cannot be corrected, where the item is flagged as needing correction. After item flagging, the process continues to search for additional rules, the same query represented by diamond 2450 above. If the item is automatically corrected, the correction and the rule used to make the correction are recorded in the ETSDT, represented by box 2440. The process continues to search for more item rules.

If the query represented by diamond 2450 returns no additional rules that apply to the item, then extraction of an attribute associated with this item occurs, as represented by box 2460. The first applicable rule is applied to the attribute, as represented by box 2466. If the attribute passes the rule application, a decision represented by diamond 2468, the dataset is checked for more attribute rules, as represented by diamond 2490. If an additional rule is found, it is applied to the attribute (box 2466). If an attribute does not pass the rule application represented by diamond 2468, then the error is recorded in the ETSDT, represented by box 2470. Box 2472 represents attempted automatic correction of the error based on information contained in the applied rule or in rules for correcting errors. Success or failure of the attempted correction is represented by diamond 2474. If the error is successfully corrected then the rule that corrected the error along with the correction is recorded in the ETSDT, as represented by box 2478. The process continues to check for more applicable attribute rules. If the error is not automatically corrected, the attribute is flagged as needing correction, as represented by box 2476. After item flagging, the process continues to check for more applicable attribute rules.

If no additional rules are found in decision diamond 2490, the item is checked for additional attributes, as represented by decision diamond 2492. If another attribute is found, it is extracted and the rule check (2460) for the new attribute proceeds. If no additional attributes are found, the dataset is checked for additional items, as represented by diamond 2494. If an additional item is found, it is extracted, box 2412, from the dataset and item and attribute checking starts. If no additional items are found, the process checks to see if any errors were found during source data processing, as represented by diamond 2496. If no errors were found, the normalization process terminates (box 2480). If any errors are found, all of the items and attributes determined as needing correction are scheduled for manual normalization (or manual correction), represented by box 2485, and the automatic normalization terminates (box 2480).

The exact mechanism used to schedule manual normalization and pass control to it while concurrently continuing processing of the parts of the dataset that are not in error is not important. There are many techniques known to the art which can be used for these purposes.

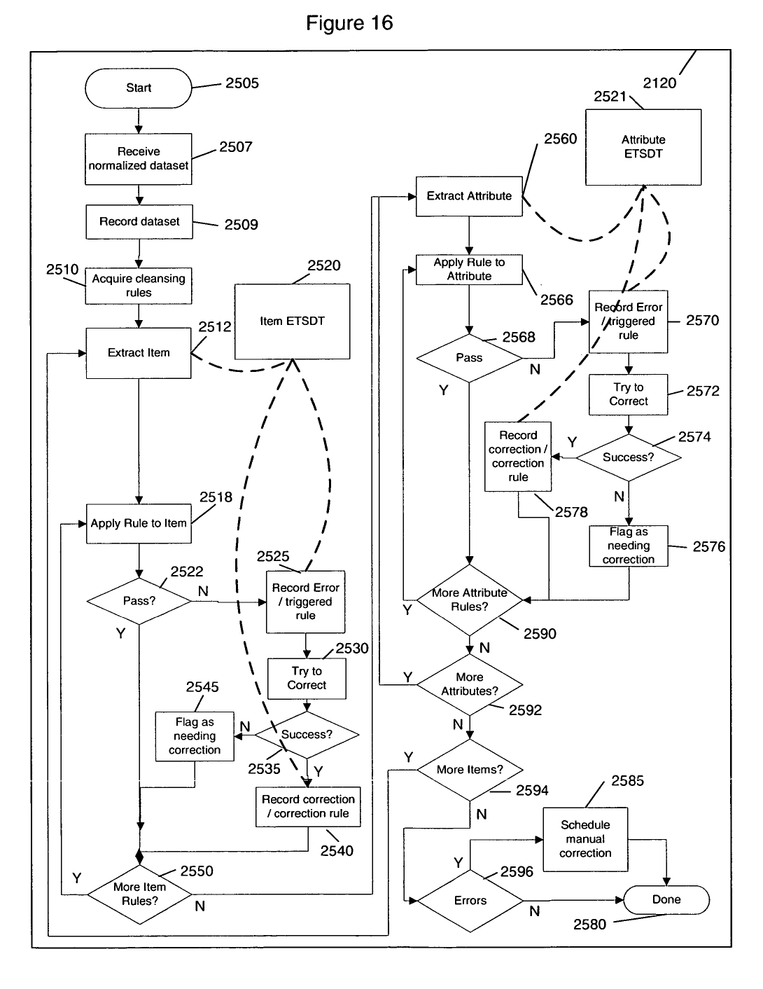

FIG. 16 shows the processing required to do perform dataset cleansing, which is represented as box 2120 in FIG. 12A. This process is elaborated in boxes 2218 through 2225 of FIG. 13.

During this process the original item values and original attribute values as well as all modifications to those values are stored in the repository. Box 2520 represents where the item ETSDT is updated and box 2521 represents where the attribute ETSDT is updated.

Box 2505 represents the commencement of cleansing. Next, box 2507 represents receipt of the validated dataset. A record of the receipt of the dataset is made and the rules for cleansing this dataset are acquired, as represented by boxes 2509 and 2510, respectively. Because this is a single source cleansing process all of the rules are source specific to the dataset and do not rely on data or information from any other source. These rules are in a file, database, or other appropriate store.

The first item is extracted from the dataset and the first applicable rule is applied to this item, as represented by boxes 2512 and 2518, respectively. If the item passes rule application, represented by decision diamond 2522, then the dataset is checked for more applicable rules, as represented by diamond 2550. If an additional rule is found, it is applied to the item in box 2518. If an item does not pass rule application, represented by decision diamond 2522, then the error is recorded in the ETSDT, as represented by box 2525. After the error is recorded the system attempts automatic correction, represented by box 2530, based on the information in the rule or in rules for correcting errors. Success or failure of the attempted correction is represented by diamond 2535. Box 2545 represents the action taken if the problem is not corrected, where the item is flagged as needing correction. After item flagging, the process continues to search for additional rules, the same query represented by diamond 2550 above. If the item is automatically corrected the correction and the rule used to make the correction are recorded in the ETSDT, as represented by box 2540. Then processing continues to search for more applicable item rules.

If the query represented by diamond 2550 returns no additional rules that apply to the item, then extraction of an attribute associated with this item occurs, as represented box 2560. The first applicable rule is applied to the attribute, as represented by box 2566. If the attribute passes the rule application, a decision represented by diamond 2568, the dataset is checked for more applicable rules, as represented by diamond 2590. If an additional rule is found, it is applied to the attribute (box 2566). If an attribute does not pass the rule application represented by diamond 2568, then the error is recorded in the ETSDT, represented by box 2570. Box 2572 represents automatic correction of the error based on information contained in the rule or on rules for correcting errors. Success or failure of the attempted correction is represented by diamond 2574. If the error is successfully corrected then the rule that corrected the error along with the correction is recorded in the ETSDT, represented by box 2578. Then processing continues to check for additional applicable attribute rules. If the error is not automatically corrected, the attribute is flagged as needing correction, as represented by box 2576. After item flagging, the process continues to check for more applicable attribute rules in decision diamond 2590.

If no additional rules are found, the item is checked for additional attributes, as represented by decision diamond 2592. If another attribute is found, it is extracted in box 2560 and the rule check for the new attribute proceeds. If no additional attributes are found, the dataset is checked for additional items, as represented by diamond 2594. If an additional item is found, it is extracted in box 2512 from the dataset and item and attribute checking starts. If no additional items are found, the process checks to see if any errors were found during source data processing, as represented by diamond 2596. If no errors were found, the normalization process terminates (box 2580). If any errors are found, all of the items and attributes determined as needing correction are scheduled for manual cleansing (or manual correction), represented by box 2585, and the automatic cleansing terminates (box 2580).

The exact mechanism used to schedule manual cleansing and pass control to it while concurrently continuing processing of the parts of the dataset that are not in error is not important. There are many techniques known to the art which can be used for these purposes.

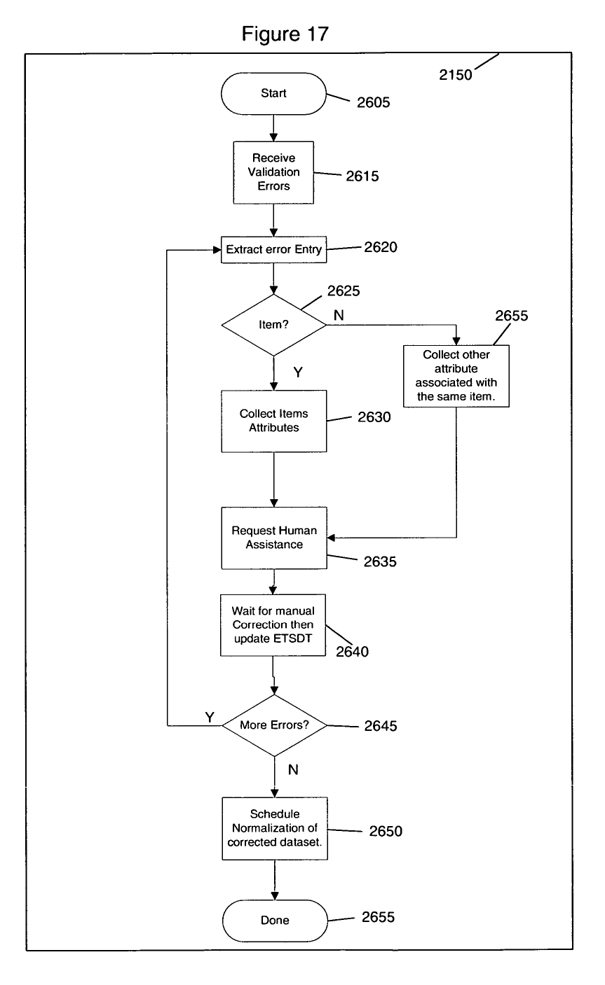

FIG. 17 shows the process of correcting validation errors, a manual validation process which is represented by box 2129 in FIG. 12A.

Box 2605 represents commencement of manual validation. The first thing done, represented by box 2615, is receipt of the list of validation errors. When these errors are received, the activation of the manual validation process is recorded in the ETSDT. After this an error entry is extracted, as represented by box 2620. Decision diamond 2625 represents the identification of the error entry as either a source item or an attribute. If this error entry is for a source item all of the associated attributes and any other relevant information are collected, as represented by box 2630. Otherwise all the attributes that have the same source item and are in question and any other relevant information are collected, as represented by box 2665. The collection represented by box 2655 is a set of attributes with errors all of which are associated with the same item, but the item is not included as it does not contain any errors. As represented by box 2630, if the item has errors all of its attributes, with or without errors, are collected. This is done since, in some instances, the item error affects the attribute processing. In either case human assistance is requested, represented by box 2635, and the identity of the human working on the errors is recorded in the ETSDT. The information is passed to that person who corrects the errors. The manual correction process waits until the error is, box 2640 and then records the corrections in the ETSDT. The process to continues and checks to see if there are additional errors, a query represented by decision diamond 2645. If there are additional errors, the next error entry is extracted. Otherwise, all the errors have been corrected, which means validated, so processing proceeds and the validated items and attributes are scheduled for automatic normalization, as represented by box 2650. Lastly, manual validation terminates (box 2655).

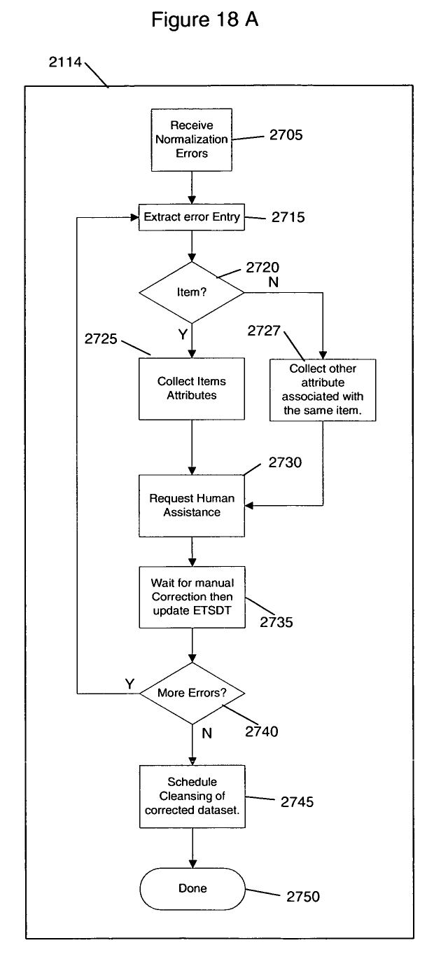

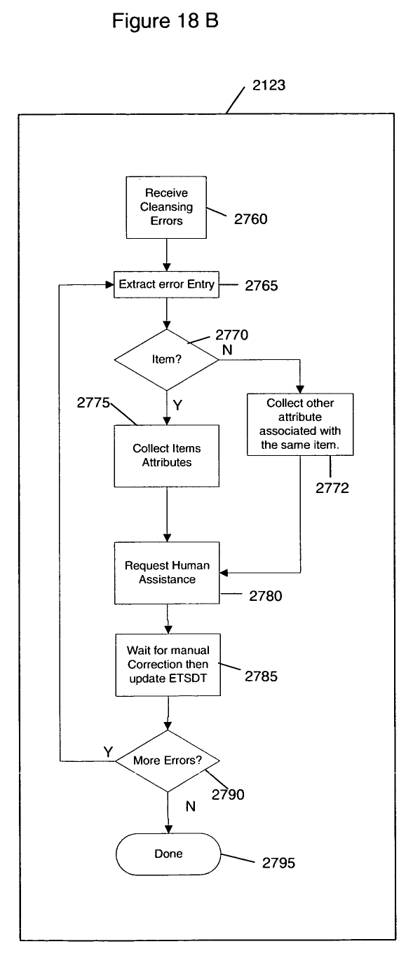

FIG. 18A shows the process of correcting normalization errors, a manual normalization process which is represented by box 2114 in FIG. 12A. Box 2705 represents commencement of manual normalization, with receipt of the list of normalization errors. The activation of the manual normalization process is recorded in the ETSDT. After this an error entry is extracted, as represented by box 2715. Decision diamond 720 represents the identification of the error entry as either a source item or an attribute. If this error entry is for an item all of the associated attributes and any other relevant information are collected, as represented by box 2725. Otherwise all the attributes that have the same item and are in question and any other relevant information are collected, as represented by box 2727. The collection represented by box 2727 is a set of attributes with errors all of which are associated with the same item, but the item is not included as it does not contain any errors. As represented by box 2725, if the item has errors all of its attributes, with or without errors are collected. This is done since, in some instances, the item error affects the attribute processing. In either case human assistance is requested, represented by box 2730, and the identity of the human working on the errors is recorded in the ETSDT. The information is passed to the person who corrects the errors. The manual correction process waits until the error is corrected, box 2735, and then records the corrections in the ETSDT. The process to continue and checks for additional errors, a query represented by decision diamond 2740. If there are additional errors, the next error entry is extracted. Otherwise, all the errors have been corrected, which means normalized, so processing proceeds and the normalized items and attributes are scheduled for automatic cleansing, as represented by box 2745. Lastly, manual normalization terminates (box 2750).

FIG. 18B shows the process of correction cleansing errors, a manual cleansing process which is represented by ellipse 2123 in FIG. 12A. Box 2760 represents commencement of manual cleansing, with receipt of the list of cleansing errors. The activation of the manual cleansing process is recorded in the ETSDT. After this an error entry is extracted, as represented by box 2765. Decision diamond 2770 represents the identification of the error entry as either a source item or an attribute. If this error entry is for an item all of the associated attributes and any other relevant information are collected, as represented by box 2775. Otherwise all the attributes that have the same item and are in question and any other relevant information are collected, as represented by box 2772. The collection represented by box 2772 is a set of attributes with errors all of which are associated with the same item, but the item is not included as it does not contain any errors. As represented by box 2775, the item has errors, and all of its attributes, with or without errors are collected. This is done since, in some instances, the item error affects the attribute processing. In either case human assistance is requested, represented by box 2780, and the identity of the human working on the errors is recorded in the ETSDT. The information is passed to the person who corrects the errors. The manual correction process waits until the error is corrected, box 2785 and then records the corrections in the ETSDT. The process to continue and checks for additional errors, a query represented by decision diamond 2790. If there are additional errors, the next error entry is extracted. Otherwise, all the errors have been corrected, which means cleansed, so manual cleansing terminates (box 2795).

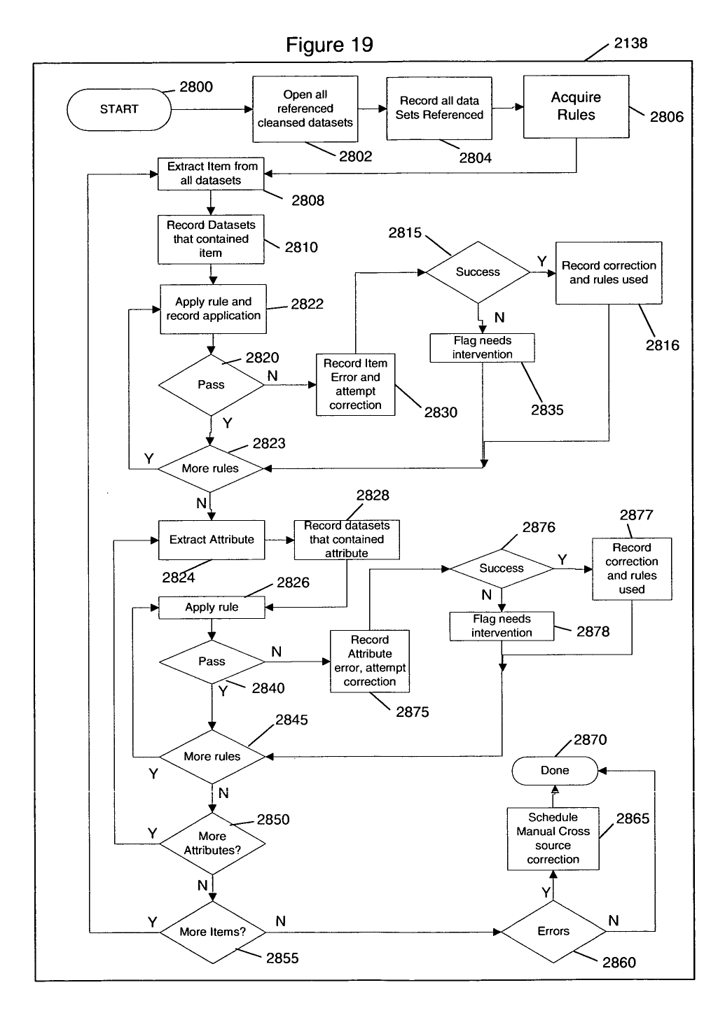

FIG. 19 shows a flowchart of the generic framework used to implement a cross-source process which is represented by box 2138 in FIG. 12B. Recommended value is an example of a cross-source process. This description illustrates application of a cross-source process after single-source cleansing is complete. This is the advantageous embodiment. However, it is possible to apply cross-source processes at different stages if required.

Ellipse 2800 represents commencement of processing commences when all of the candidate datasets are ready for processing. Standard techniques initiate a cross-source process when the source datasets are ready. First, all of the cleansed candidate source datasets are opened, as represented by box 2802. Next, box 2804 represents the recording of all referenced datasets. If the output is a new dataset, this will require the creation of ETSDTs for the new dataset. If the output is an update to an existing dataset produced by the same process then the existing dataset ETSDTs of are updated. All of the rules for the cross-source process are acquired, as represented by box 2806. Box 2808 is the beginning of a loop where on each iteration an item is extracted from all datasets that contain it. If a new dataset is created, a new ETSDT is created for this new item, and the dataset containing the item is recorded in the ETSDT, as represented by box 2810. Box 2822 represents application of a rule to the available items, which produces a new item value. The purpose of cross-source processing is to produce values. Sometime new values are produced which did not previously exist. Other processes produce their values by selecting one of the previously known values. Cross-source processing result in new values by either method. If the item passes rule application, represented by diamond 2820, then additional rules are checked (diamond 2823). If more rules are found, the rules are applied (box 2822).

If the new item does not pass the rule application, the error and the attempt to correct it are recorded, as represented by box 2830. Next, diamond 2815 represents performance of a check to see whether the correction was successful. If the correction is successful, the new value and the rule used for the correction are recorded in the ETSDT, as represented by box 28216. If the correction was not successful, then the current value is flagged for intervention, as represented by box 2835. In either case, successful or non successful correction, processing proceeds to a check for more rules, a query represented by diamond 2823.

In cases where attribute level processing is involved, when no additional rules are found, box 2824 represents extraction of an attribute from all datasets that contained the extracted item. The attribute and all datasets that contained it are recorded in the ETSDT, as represented by box 2828. If this attribute is being created for a new dataset then a new attribute ETSDT is created at this point. If this attribute is updated in an existing dataset, then the recording is done to the ETSDT of the existing dataset. Sometimes for an existing dataset a new attribute is found which results in the creation of a new ETSDT. Next, a rule is applied, represented by box 2826. Success or failure of the rule application is represented by diamond 2840. If the attribute passes the rule application, processing checks for additional applicable rules, represented by diamond 2845. If additional rules are found, the next rule is applied box 2826. If the attribute did not pass the rule application, represented by diamond 2840, the error is recorded (box 2875) and a correction is attempted. Success or failure of the attempted correction is represented by diamond 2876. If the correction is successful, then all of the rules use to correct the attribute and the new attribute value are recorded in the ETSDT, as represented by box 2877. If the correction was not successful, then the attribute is flagged for intervention, as represented by box 2878. In both cases, successful or non successful, correction processing proceeds to check for more rules (box 2845).

If no additional rules are found, processing checks for additional attributes, as represented by decision diamond 2850. It is worth noting that it is not assumed that all source datasets have the same attributes associated with each item when they contain the same item. More attributes will continue to be processed until all of the attributes in each of the source datasets have been processed. However, each attribute is processed once no matter how many source datasets it occurs in.

If no additional attributes are found, processing checks for more items, as represented by diamond 2855. It is worth noting that it is not assumed that all source datasets contain the same items. The result of the query represented by diamond 2855 is true as long as any items remain in any source dataset. However, each item is processed once, no matter how many source datasets contain it. Effectively, each item is marked as processed in every source dataset that contains it once it is found in one of them. Once all items have been exhausted, by the query represented by diamond 2855, processing proceeds to check for errors, represented by diamond 2860. If any items or attributes have been flagged as needing intervention, manual cross-source correction is scheduled, as represented by box 2865. This process is similar to single-source correction in that it request human intervention to correct the error. The scheduling of the process, the human who intervenes and the values produced are all recorded in the ETSDT. After manual cross-source correction has been scheduled, the cross-source process terminates (box 2870). If no errors were found the cross source process terminates (box 2870).

This concludes the description of the flow diagrams for this data cleansing and quality enhancement aspect of the invention. In our preferred embodiment workflows are used to implement the process and flows described herein. Alternative embodiments use script, discrete distributed process, or a mixture of all of these. Any suitable mechanism or programming language is used to implement the flows and processes described herein.

D. On-Demand Dataset Delivery Processing

This aspect of the invention provides a flexible scalable multi-tenant information retrieval and delivery system that supports multiple independent client organizations each having their own data interests, data entitlements and data delivery requirements. This aspect of the invention effectively enables a data delivery mechanism that interacts with a single repository to serve multiple clients and/or requesters, even though each requester is only entitled to some subset of the data in the multi-source multi-tenant data repository (further referred to as “repository”) or, in a broader context, of the reference data available from the reference data utility.

Requests for information retrieval and delivery are presented by requesters as a request for the production and delivery of an on demand dataset. The specification of an on demand dataset allows the requester to control (1) the information to be supplied in the dataset, (2) preferences on which information sources to use in supplying values for the selected information elements, (3) the mode of the data delivery, (4) the format of the data when provided and (5) communication and data transfer control information for establishing connections with the requester and effecting delivery. The data to satisfy an on demand dataset request is retrieved by the method described above in section B for multi-source multi-tenant data repository. Enforcement of data entitlements—ensuring that requestors never receive values from information sources to which they are not entitled—is provided either by the repository or by additional logic in the on demand dataset delivery processing. Delivery modes supported by the invention include (1) on demand datasets which may consist of a single one time delivery instance as needed for an ad-hoc query, (2) recurring batched delivery instances and (3) quasi real time delivery.

The described apparatus and method for on demand dataset delivery supports multiple customers with each customer having multiple requests for on demand datasets concurrently outstanding. The method is flexible and able to support a wide range of requester delivery and retrieval requirements because different aspects of this task have been separated out into separate specification units of the on demand dataset request specification. The method is scalable to allow concurrent processing of multiple requests and to support multiple requesters with multiple requests from each because it exploits this separation of concerns to allow automated processing on demand dataset requests. Each arriving on demand dataset request has its specification automatically compiled into an on demand dataset production process which is then executed to retrieve the required data and deliver it to the requester. The invention supports any combination of allowed specifications for each of the separate on demand dataset aspects listed above.

This aspect of the invention also provides the capability for the customer to specify the output format for delivery of the data in customer specific format or an industry standard format. The invention allows for delivery of information to a customer to take the form of loading the identified data into a data mart own by that customer. This invention provides audit and logging capability to ensure complete process transparency, non-repudiation, billing and other auditing purposes.

The method is effectively an on demand approach to data delivery for reference data. The ability to support a wide range of client requirements for different topics, sources, qualities, modes and formats, organized as an automated extensible system provides a valuable service by enabling the complex but critical delivery functions to be centralized and highly leveraged.

The described invention supports customer and data source privacy. Since independent production processes are generated for each on demand dataset request, and data entitlements are enforced, no customer or data source is able to discover information about another's data, queries or other actions to retrieve and deliver information to them.

The method is described herein as it applies to reference data used by Financial Services businesses. This method for enabling flexible scalable delivery of on demand datasets in the context of a multi-source multi-tenant data repository 20, as described above, has many other possible areas of application. The multi-source multi-tenant data repository 20 manages and provides permanent storage for repository information elements, associated metadata, entitlements, value add functions and documents. Access to consumer credit information, government regulation and registration information, and telecommunications usage information are three additional examples where the method has use. Characteristics of contexts where the method has use and of reference data are: (1) the information comes from many sources; (2) there are multiple users, potentially in independent organizations, that need access to the same information but potentially with different source entitlement rights; (3) the referenced information is accessed by users largely in read-only mode except when they participate in correcting invalid values; (4) high quality timely information is both valuable and complex to gather, hence the efficiencies from a utility approach, shared infrastructure and shared data quality enhancement provide significant benefit; and (5) entitlement enforcement and privacy management must be provided by such a utility. Although the invention is described in the context of financial services reference data, which is one important area of application, the approach revealed herein, enabling an effective utility to provide data access meeting the requirements above, has value in any context with these requirements.

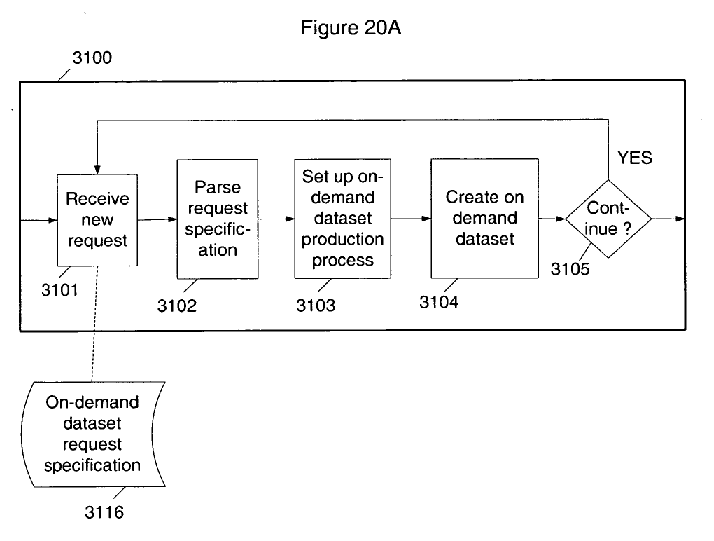

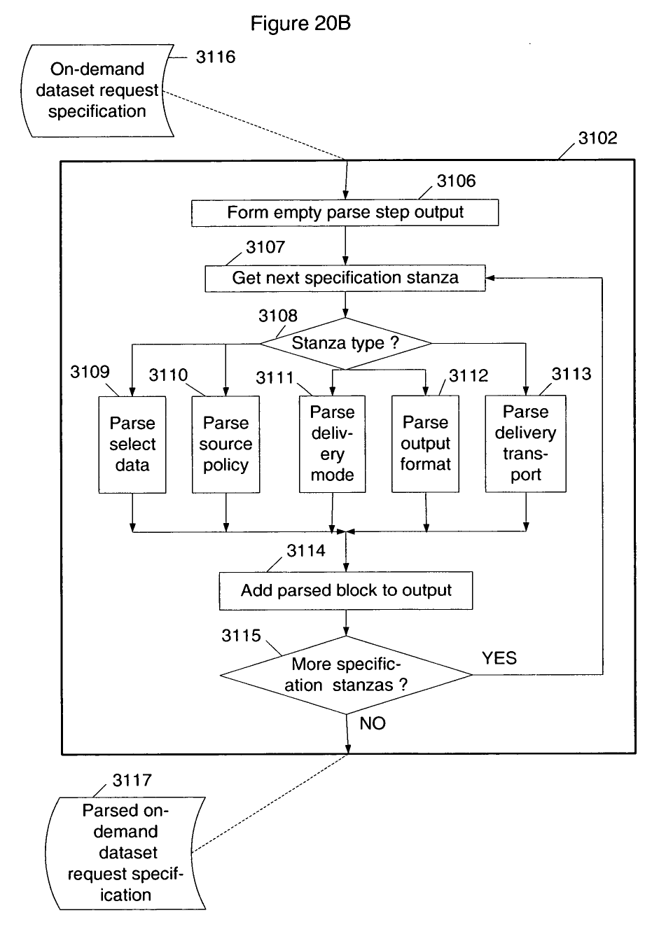

FIG. 20A is a flow chart for producing an on demand dataset in response to an on demand dataset request. Box 31 00 in this figure is the outer box representing the overall method. In the context of a reference data utility this corresponds to the client data delivery processing first introduced as block 21 in FIG. 1A. The initial step in this flow chart, box 3101, represents receipt of a single on-demand dataset request to produce a single on demand dataset.

Box 3101 represents receipt of the on demand dataset request. This invention does not specify the type of channel through which the request is passed. The invention defines the content of the requests and allows the input request to be formatted in a manner that is consistent with the way it is delivered. The invention supports the receipt of requests via any number of communication protocols and semantics. Requester authentication and authorization is handled in this step with unauthorized requests logged and discarded.

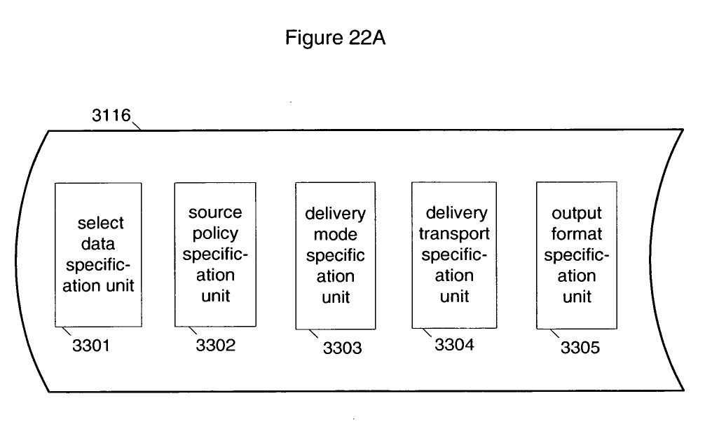

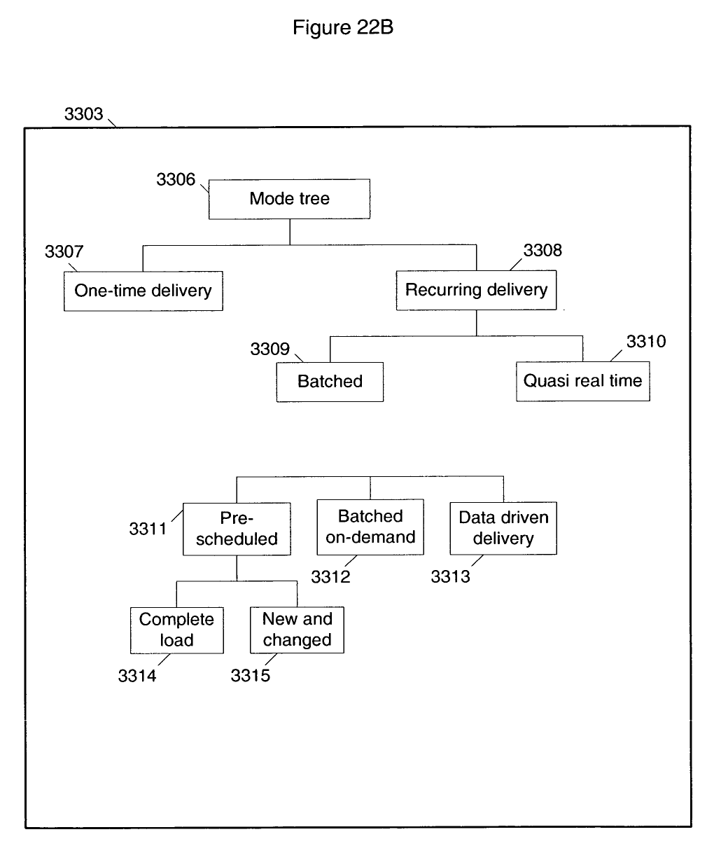

Valid requests are saved in an internal form as represented by data element 3116, which is described in more detail in FIG. 22A. Receipt of on demand dataset requests is also logged for traceability and non-repudiation purposes.

The dashed line connecting box 3101 with data element 3116 shows that the on demand dataset request specification is received as part of the on demand dataset request received in box 3101. The on demand dataset request specification represented by data element 3116 is available as input during subsequent processing steps.

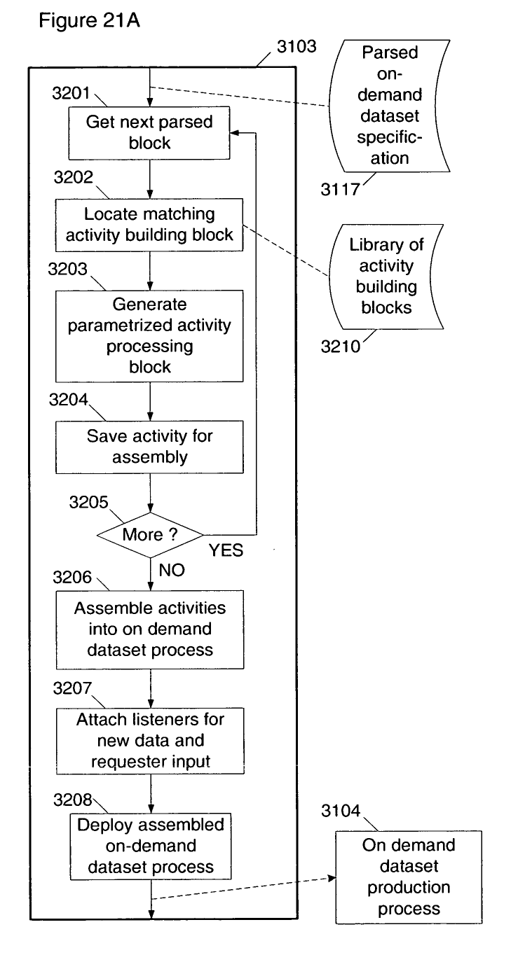

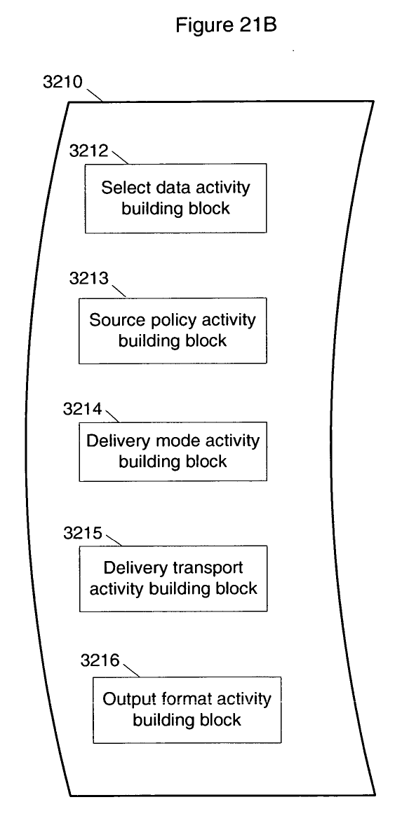

Box 3102 represents the actions of parsing, validation and analysis of the on demand dataset request specification (data element 3116) received in the on demand dataset request. The parsing, validation and analysis step is described in more detail in FIG. 20B. This is followed by box 3103, which represents the action of setting up the process to produce the on demand dataset. This process is created by assembling a workflow process out of parameterized activity building blocks. An alternative embodiment is to accomplish this by parameterizing the parts of a workflow used for all on demand datasets. Anyone skilled in the art understands the technologies needed to build a script or workflow for a pre-specified task, either statically or dynamically. The processing represented by box 3103 is described in more detail in FIG. 21A. Box 3104 represents the execution of the on demand dataset production process assembled and deployed, as represented by box 3103; this will produce the requested dataset and deliver it to the requester. Decision box 3105 shows that the outer structure of the method is a loop; after processing an on demand dataset request, control loops back and logically handles the next request for an on demand dataset.

FIG. 20A shows the simplest logical form of the method in which requests for on demand datasets are handled sequentially in a single loop. An advantageous embodiment extends this representation using concurrency techniques well understood to those skilled in the art to allow multiple instances of the loop formed by boxes 3101, 3102, 3103, 3104, and 3105 to be handled concurrently. Such an extension enables the method to handle multiple requests for on demand datasets simultaneously.

The on demand dataset requests are able to modify or terminate the results of previous on demand dataset requests. This is handled as a dynamic replacement or termination of the process created as a result of the previous request. How to schedule these requests, or where to schedule them or building schedulers which allow termination or replacement of previously scheduled tasks is not the focus of this invention. These functions are well known to those skilled in the art.

FIG. 20B shows a flowchart of the steps in the parsing and analysis of an on demand dataset request specification, describing in more detail the action represented by box 3102 from FIG. 20A where an on demand dataset request specification is parsed, analyzed and validated.

The outer box of FIG. 20B is box 3102 which was first introduced in FIG. 20A. The output of the parse and analyze step is a parsed block of data representing the information in the specification but now organized for assembly of a process tailored to produce exactly the requested data. Box 3106 represents the initialization step to set up an empty output structure into which parsed blocks can be added. The on demand dataset request specification is a parameter block or text structure which is organized as a number of lexically distinct sections or stanzas, each dealing with a specific aspect of the on demand dataset. Each stanza is expected to contain information about an aspect of the on demand dataset. Box 3107 obtains the next stanza of the input specification and is the heading block of the stanza processing loop. Decision box 3108 resolves the stanza type. The key stanza types are: select data process, the sourcing policy, the delivery mode specification, data output format choices, and data delivery and transport characteristics. The stanza types and the information provided in each stanza type are discussed in more detail in FIGS. 22A and 22B. Boxes 3109, 3110, 3111, 3112, and 3113 provide different parsing analysis and validation logic for each of these stanza types. Although these stanzas represent the key required aspects of an on demand dataset request specification, additional stanza types are possible. The architecture of this component is extensible. In an alternative embodiment requester specific stanza types are allowed. The result of the stanza type specific parsing is a parsed output block. Box 3114 in the flow shows that on completion of the stanza type specific parsing, the resulting parsed output block is added into the output. Decision box 3115 tests whether the on demand dataset request specification has been completely processed or whether there are additional stanzas still to be parsed. If more stanzas are available to be parsed, control loops back to box 3107 to process the next one. If the input specification is fully parsed, control flows out of box 3102 and parsing, analysis and validation are complete.

An important aspect of the on demand dataset processing is that each distinct aspect of the on demand dataset is specified and then parsed separately. This separation of concerns enables on demand datasets to meet a wide range of data selection and delivery needs required to provide delivery of data to many customers from within a shared multi-source multi-tenant data repository. An advantageous embodiment of the method described herein provides initial elaborations of options for each of these aspects. Simple extensions of the method are made by providing richer options in each of these independent aspects of an on-demand dataset.

Data element 3116, originally introduced in FIG. 20A, is a representation of the data structure used by the requester to supply the on demand dataset request specification. This specification is the input to the parsing, analysis and validation processing represented by box 3102. The data structure of the on demand dataset request specification is elaborated in FIGS. 22A and 22B.

Data element 3117 represents the parsed on demand dataset specification produced as output from the flow of box 3102. This parsed specification is used as input in FIG. 21A where the customized on demand dataset workflow for producing the specified on demand data set is assembled.

FIG. 21A is a flowchart that shows the steps in setup of a customized on demand dataset production process, describing in more detail the action represented by box 3103 that was introduced in FIG. 20A. This is the step of assembling and deploying a customized on demand dataset production process tailored to the requirements of a parsed on demand dataset request specification, as represented by data element 3117.

The flow starts with box 3201 in FIG. 21A, in which the next available block from data element 3117 is picked up. Box 3202 locates the matching activity building block from a library of available activity building blocks. The library is represented as data element 3210 and is described in more detail in FIG. 21B. Box 3203 represents the action of applying the information and parameters obtained from data element 3117 to the matching activity building block to produce a specific activity tailored to provide the exact function needed for this phase of the process to create the requested on demand dataset. Box 3204 saves this tailored activity so that it is available subsequently for assembly into a complete process. Decision box 3205 is a test to determine whether all blocks in the parsed data have been handled and had tailored activities produced for them. If not, control loops back and resumes at box 3201 for the next iteration.

Box 3206 is reached when all parsed specification information has been processed and converted into a set of parameterized (tailored) activity blocks. The processing represented by box 3206 is to sort these activity blocks into the correct order, insert default activity blocks for any phases for which no specification has been supplied and provide an overall flow of control yielding a set of tailored activities which is the basis of the on demand dataset production process. Box 3207 involves adding specific listeners into this process.

Listeners are needed if the process has to be sensitive to the arrival of new information in the multi-source multi-tenant data repository from which data elements are being selected for the on demand dataset. The presence of listeners makes the on demand dataset production process sensitive to execution time control commands from the user such as prompts for when additional data is to be delivered. An alternate embodiment is for the attachment of listeners to be included in individual building blocks from the library of activity building blocks and to parameterize these listener functions for the specific connection needed. Any technique for enablement of asynchronous receipt of information is applied to enable these listeners.

Although the stanzas and library of building blocks described herein represent the key required aspects of an on demand dataset request specification, additional stanza types are also possible.

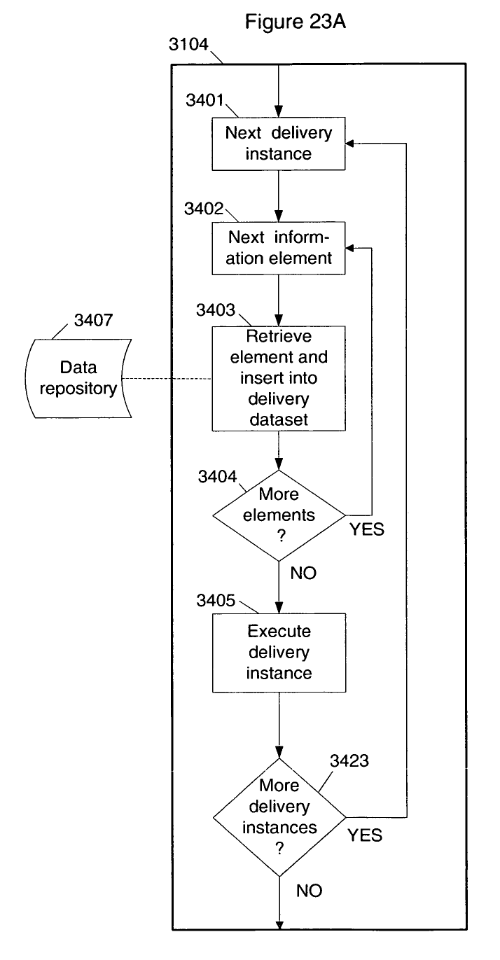

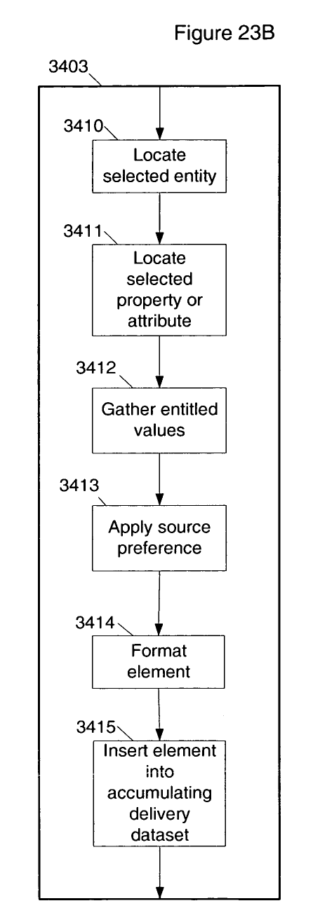

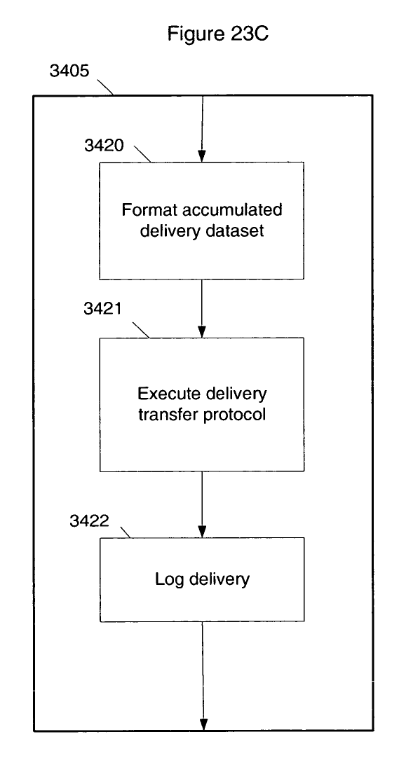

Box 3208 represents the action of deploying the assembled on demand dataset production process so that it is ready to be executed for run time production and delivery of the requested on demand dataset. This is shown with a dashed arrow to box 3104. Box 3104 is described in more detail in FIGS. 23A and 23B.

After completion of the activities represented by box 3208, control flows out of box 3103. Initiation of the deployed process is represented by box 3104 of the top level flow in box 3100 described in FIG. 20A.

Techniques such as workflow processing, well known to those skilled in the art, are used to implement and manage the generated on demand dataset production process. An advantageous embodiment of this process represented by box 3103 tailors the same basic process template to produce a specified process, customized to produce the requested on demand dataset. An alternative embodiment, obvious to those skilled in the art, is to generate a separate process for each on demand dataset request using the same phase by phase construction process. Another alternative is to use parameterized static workflows. Another embodiment is to use a compiler. Those skilled in the art realize that there are many technologies that can be used to produce the process which produces the on demand dataset. The appropriate scheduling mechanism is used in box 3104.

FIG. 21B shows the contents of the library of activity building blocks. The library of basic activity building blocks was introduced as data element 3210 in FIG. 21A. Basic activity building blocks are provided for each of the main phases of the on demand dataset production process. Box 3212 shows the activity building block for the item selection phase; box 3213 shows the activity building blocks for the sourcing policy; box 3214 shows the activity building block for the delivery mode; box 3215 shows the activity building block for the delivery and transport phase and box 3216 shows the activity building block for the output format phase.

The specific capabilities of each of these activity building blocks are described in more detail in FIGS. 23A and 23B wherein the steps and phases of the on demand dataset production process that produces and delivers an on demand dataset are elaborated.

In an alternative embodiment, additional activity building blocks are added into the library. An example of an additional activity building block is a special activity building block to handle the loading of a customer datamart with the information in the on demand dataset instead of just delivering the data to the requester as described herein. In another embodiment these processes are factored in a way to distribute part of this processing to the requester or increasing the number of activity building blocks or decreasing the number of activity building blocks. The point of this invention is that these processes occur; the exact factorization used in any specific implementation is left to those skilled in the art.

FIG. 22A shows the organization of an on demand dataset request specification. The request represents a single request specification from one requester. The method allows a single person, application or organization making requests to have multiple on demand dataset requests outstanding concurrently. From the perspective of the delivery method there is no difference in the processing of multiple concurrent on demand dataset requests from a single end user and multiple concurrent on demand dataset requests from independent end users.

The separate components of an on demand dataset request specification are shown as boxes 3301-3305, each of which is described in detail below. Each of these sections of an on demand dataset specification is a separate stanza which can be parsed and processed by a separate iteration of the parse processing as represented by box 3102 in FIG. 20B. The components of the on demand dataset request specification described herein represent the key required aspects necessary for the successful assembly and delivery of the on demand dataset. Additional aspects specified in the specification are also possible.

Box 3301 represents the select data specification unit. This specifies the information elements whose values are to be delivered in the requested on demand dataset. The specification unit is in the form of a filter or query against the repository entity metadata and properties using predicates on topic, subtopic and other attributes and values of the repository entity. Specifically, the filter determines the repository entities of interest and the properties and attributes of those repository entities for which values are to be returned in the dataset. The selection criteria include any reasonable criteria by which items are selected, such as interest lists, temporal constraints, various classifications, etc. A relational query is one possible implementation. The requester receives one or more current values from the set of entitled available current values for each selected attribute or property of each selected repository entity.

Box 3302 represents the source policy specification unit, sometimes called source preference, where a source preference can be specified. The preferred embodiment uses a simple preference order on sources and item instance processes producing attribute values. If there is a choice of available values entitled to this requester for a specific element, the first such value in the supplied preference order is used. In addition to actual data origins, item instance processes appear in this preference order. For example, the requester specifies a preference order between explicitly using a particular data origin and using a recommended value derived by some input cleansing and enhancement process that selects a value after comparing the values received from multiple data origins. In an alternative embodiment, a default ordering on sources is provided to handle the case where this was not specified by the requester.

Another alternative embodiment supplies a more sophisticated sourcing policy that is sensitive to the information element on which it applies. This policy specifies a conditional source preference ordering, subject to a predicate on the properties, attribute values or metadata of the information element. For example, in a financial reference information context, a requester specifies that source A is preferred to source B on common stocks but that source B is preferred to source A on public and government bonds. Preferences are flexibly described through the predicates. A requester expresses a preference, for example, for particular sources for stocks traded on a specific exchange, or that recently arriving or unconfirmed data from a particular source could be discounted.

An alternative embodiment of sophisticated sourcing policy uses a set of rules, each with the form of a simple preference order or a conditional preference sensitive to values in, and properties of, the item as described above. When applying the sourcing policy to select values for inclusion in the on demand dataset, these rules are evaluated in turn by the sourcing policy step and the resulting preferred value selected.

Box 3303 represents the delivery mode specification unit. The delivery mode is a feature that gives on demand datasets significant flexibility to respond to different requester requirements. It allows the requester to create on demand datasets with a single one-time delivery instance or on demand datasets with recurring delivery instances. A more complete description of the delivery mode is provided in FIG. 22B below.

Box 3304 represents the delivery and transport specification unit. The customer supplies information governing connection and communications protocols and the authentication checks required for each delivery instance in the on demand dataset. The dataset delivery and transport specification unit also provides network addressing, protocol and authentication information needed to establish a connection for each delivery instance. This includes “outbound” connection and authorization specifics used to initiate delivery instance connections from the repository and delivery method to the requester. It also includes inbound connection and authentication information to allow the requester to connect in and initiate a delivery instance. If an outbound connection is specified, the requester defines where and how the connection is to be set up; if the connection is inbound, it specifies the necessary authentication. In either case the file or data transfer protocol used to pass the delivery dataset is specified. A datamart is specified as the target of delivery with the requester supplying appropriate database load parameters. Technologies such as table replication mechanisms are then applicable in enabling this transport option.

In an advantageous embodiment described herein, the scheduling information governing exactly when the next delivery instance of an on demand dataset occurs is provided in the specifics of the delivery mode specification unit. An alternative embodiment packages this information with the dataset delivery transport specification unit.

Box 3305 represents the output format specification unit, which allows the requester to specify data formats and transformation rules governing the delivery format of the on demand dataset and its contained information elements. Each information element in the repository has one or more preferred data output formats. For example, when adding financial instrument data to an on demand dataset, a public standard such as Market Data Description Language (MDDL) or the ISO financial instruments structure 20022 is used. The output format unit allows the requester to choose between standard formats or to specify some customized format.

Part of the value of on demand dataset request specification is that the specification is structured as separate units, allowing for separation of concerns.

FIG. 22B shows the on demand mode case tree, elaborating the different delivery modes introduced in FIG. 22A. As such, it is an expanded description of box 3303, which represents the delivery mode specification unit. FIG. 22B is a tree structure with lower levels of the tree being sub-cases of their parent element. Box 3306 is the root node representing delivery modes. An on demand dataset has either a one time delivery, as represented by box 3307, or a recurring delivery, as represented by box 3308.

Box 3307 represents one time delivery. An on demand data set with one time delivery mode is produced by applying one or more retrieval operations to the current state of the repository, assembling the retrieved information in and delivering it to the requester as the single delivery instance for this on demand dataset.

Box 3308 represents recurring delivery. An on demand dataset with recurring delivery mode specifies that multiple delivery instances are requested. Each delivery instance represents a separate retrieval of information form the repository. The exact method used to accumulate the data is determined by other predicates. The delivery dataset returned to the requester in each delivery instance contains information that has been retrieved over time and accumulated in a delivery dataset in preparation for use with the next delivery instance of this on demand dataset. Alternatively, a delivery data set is created when it is needed for delivery by applying one or more retrieval operations on the state of the repository at that time.

A recurring delivery is either a batched delivery, as represented by box 309, or a quasi-real time delivery, as represented by box 3310. Box 3309 represents batched delivery. Processing for each delivery instance is done by making the delivery method aware of new information arriving in the repository, by periodic retrieval operations on the repository or by a retrieval action on the state of repository at the time the delivery dataset is needed. Box 3310 represents quasi-real time delivery mode. This is a case of recurring delivery mode where relevant new arriving information is delivered to the requester as soon as it is detected. This typically leads to a fine grained sequence of delivery instances with each delivery dataset containing only a small amount of data. The term quasi-real time is used since providing updated information in frequently updated transfers is the key characteristic.

This completes the description of the main delivery modes. Boxes 3311, 3312, 3313, 3314 and 3315 represent additional parameters that can be applied to boxes 3309, 3310 and 3307. For simplification purposes they are described in the context of box 3309.

Box 3311 represents a prescheduled batch where there is a fixed predetermined schedule controlling when the delivery instance occurs. Box 3312 represents the case of on demand delivery instances. In this case the requester explicitly requests that the delivery instance be instantiated and delivered. The requester also indicates when the next delivery instance is required. Box 3313 represents the case of data driven delivery which is based on some function of the state of the data, such as the volume of data, or arrival of particular data elements.

A delivery instance contains either a complete set of all selected values or only new and changed values since the last delivery instance (or over some period of time). These two options are represented by boxes 3314 and 3315, respectively. These options are represented as sub-cases of prescheduled batched delivery mode, represented by box 3311, but they can obviously be applied to boxes 3312 and 3313. The usefulness varies depending upon the context.

Alternative embodiments include an on demand mode that allows the requester to specify that the selected information elements be loaded into a private working database or datamart set up exclusively for that requester's use. The choice of a datamart for delivery influences the delivery transport specification. In a one-time query, the on demand mode indicates whether additional research and data gathering is to be launched to gather new values in the event that there is no appropriate value currently in the repository for a specified information element. Additional modes include an alert mode, in which event notices are sent if the value of some reference item crosses a pre-specified threshold, or a summary report mode, in which aggregated summary reports on reference item values sets are sent at specified intervals.

FIG. 23A describes the flow of an on demand dataset production process used at runtime to produce an on demand dataset and deliver it to the requester. This process was first introduced in FIG. 20A, represented by box 3104. FIG. 21 A explains how a customized on demand dataset production process is generated to meet the requirements of a particular on demand dataset specification. As previously noted, the effect of executing an on demand dataset production process is to retrieve information from a repository subject to the requester's selection and sourcing specification, assemble this information into a delivery dataset subject to the requesters, delivery mode and format specification, then delivering the data to the requester subject to their dataset delivery and transport specification.

Control enters box 3104 in FIG. 23A from the top and first passes to box 3401 where processing of the next delivery instance is started. This reflects the fact that recurring on demand datasets are delivered to the requester as sequence delivery instances. The outer control structure of the flow to produce an on demand dataset is a loop; each iteration of this loop results in the production of one delivery dataset transferred to the requester as one delivery instance.

The next step in the flow is represented by box 3402, where processing of the next information element is started. The inner control structure of the flow to produce the next delivery instance of an on demand dataset is a loop; each iteration of the loop will add one information element into the delivery dataset.

The next step in the flow is represented by box 3403. This step retrieves and formats one information element from a multi-source multi-tenant data repository. Elements are only retrieved if the requester is entitled to the information. The retrieved element is inserted into an accumulating delivery dataset. As noted by the dashed line connecting this box to data box 3407, this step uses information from the repository. That repository could be an entitlement enforcing repository as described in section B or more broadly in the context of a reference data utility the entitlement managed entity data, box 50 in FIG. 1A. More detail on the processing of box 3403 is provided in FIG. 23B below.

The next step in the flow is represented by decision box 3404 which results in the flow either terminating the element loop and moving on to delivery instance processing or returning to box 3402 to add the next information element into this delivery dataset. When there are no more elements, control passes to box 3405, execute delivery instance.

This is the processing to take all information elements which have accumulated in the temporary delivery dataset waiting for a delivery instance, organize them into a delivery instance and transfer them to the requester. The logic for this is described in greater detail in FIG. 23C below.

Finally, box 3423 represents a query for additional delivery instances and, if one is found, schedules the next delivery instance in the case of continued datasets. Box 3401 is scheduled with a pointer (or reference) to the parsed on demand dataset request specification. Whether or not anything is scheduled is determined by the delivery mode of the on demand dataset. If the on demand dataset is on-time and has been completely delivered by preceding data delivery instances, nothing is scheduled. If more instances are needed to complete the delivery of currently available data, or, the on demand dataset is recurring and the delivery mode is not on demand, box 3401 is scheduled immediately. If the on demand dataset is recurring and the delivery mode is on-demand then a listener is also activated to wait for the next delivery request. When the listener receives the request it schedules the immediate execution of box 3401.

As noted elsewhere, a user request is used to terminate an existing recurring on demand dataset. When such a request arrives, either the next scheduled instance is terminated or, because it is active, a flag is set indicating that no more requests are to be allowed. Finally, control flows out of box 3104; execution of the workflow producing the on demand dataset is complete.

FIG. 23B shows a flowchart that elaborates the processing represented by box 3403 introduced in FIG. 23A, retrieving a new information element and adding it into the delivery dataset of accumulated values waiting for delivery to the requester.

The first step in this flow is represented by box 3410, which locates the repository entity containing the new information element. In general, the element selection unit of the dataset specification (box 3301 in FIG. 22A) provides property values such as entity name or entity topic which enables the relevant entity to be located in the repository. Parsing and process assembly of the dataset request specification in boxes 3102 and 3103 of FIG. 20A have converted its item select unit into a specific selection operation on the repository, which returns the entity.

In addition to selecting a specific repository entity, the element selection unit of the dataset specification indicates which attributes or properties of that entity are returned in the dataset. Requesting all available attributes or all properties is a special case. The property and attribute selection is compiled into repository operations, which are then executed in the following step, represented by box 3411.

Box 3412, represents the step of gathering from the repository those values of the selected properties and attributes of the selected entity that the requester is entitled to receive. This processing requires knowledge of the entitlements of the requester and the sourcing of information elements in the repository. It may involve gathering values from multiple item instances of the selected repository entity. In an advantageous embodiment entitlement enforcement is provided as a function of the repository. An alternate embodiment implements an entitlement enforcement scheme as part of this processing block. As a result of the processing of box 3412 the entitled set of values is gathered for the identified attributes and properties of the selected entity. Any values that the requester specified to which the requester is not entitled will not be included.

Box 3413 represents application of the sourcing preference rules specified in the source preference unit (box 3302 in FIG. 22A). Hence, if multiple values with different sourcing are available for a particular attribute the value from the source appearing earlier in the requester preference list will be selected. Sourcing preference is specified as a preference between identified item instances in the repository. For example, a requester can specify a preference for values from a recommended value process over the values provided by a particular source or vice versa.

An advantageous embodiment allows for multiple variations in the specification of sourcing preferences. First, a source preference can be specified to apply only to a particular attribute or property of particular entity. Or, a preference could be specified to apply uniformly over all attributes of all selected entities in a dataset. Preference can also apply to one attribute of all entities in a particular subclass. An example is the use of one preference on ratings of municipal bonds but a different preference on all definition of common stocks. Finally, a requester can specify that values from multiple entitled sources are included in the dataset allowing the requester to make their own comparisons between the values from different sources or repository processing. All of these functions are included in the processing of box 3403.

Control then flows to box 3414 where data format conversions are applied to the values obtained from the repository following the format specifications from the requester provided in box 3305 in FIG. 22A. This format processing is compiled into executable logic by tailoring a formatting activity building block as part of the process assembly processing in FIG. 21A. Requester specified transformation rules are applied to the on demand dataset to convert it to the required delivery data format. For each category of provided data, the on demand dataset delivery supports preferred data output formats for passing data values to the requester. For example, when passing instruments data a public standard such as Market Data Description Language (MDDL) or the ISO financial instruments structure ISO 20022 is used.

Finally, box 3415 adds the formatted selected values into the temporary dataset, which is being accumulated for delivery to the requester in the next delivery instance. The on demand mode of the dataset may also affect this processing step. If only new and changed values of a pre-scheduled batched dataset are to be delivered, this step will only add the value to the temporary dataset if this is a new or changed value since the last delivery instance.

After box 3415 processing is complete, control flows out of box 3403; a new information element has been formatted and added into the accumulating data waiting for delivery to the requester in the next delivery instance.

FIG. 23C shows a flow chart of the processing steps comprising execution of a delivery instance originally introduced as box 3405 in FIG. 23A. This processing is responsible for gathering the accumulated delivery dataset of selected, formatted values and transferring this to the requester.

The outer box of FIG. 23C is box 3405; more detail on the processing of this block is provided in the form of a flow chart. Control enters from the top and passes to the first step, represented by box 3420, where final formatting of the accumulated delivery dataset is done following format specifications provided in box 3305 of FIG. 22A. This formatting of the complete accumulated dataset includes actions such as packaging up the entire dataset in a particular way, adding summary and aggregated information. Formatting of the individual information elements in the delivery dataset has been handled in an advantageous embodiment of the step represented by box 3414 in FIG. 23B when the element was first added into the accumulated data. Alternative embodiments relocate format processing without changing the substance of this invention.

Box 3421 represents processing of the actual delivery and transfer protocols following the specification provided in the step represented by box 3304 in FIG. 22A. This processing involves establishing a network connection to the requester at some known network address, authenticating on this connection and executing a file transfer protocol. Alternatively, it involves returning data as a response parameter in a call setting up a one-time on demand dataset request.

Box 3422 represents logging or creating an audit trail for this delivery. This capability ensures complete traceability of the on demand dataset. Non-repudiation services are provided to ensure the integrity of the on demand dataset. When use in the context of a reference data utility, client delivery logs as represented by box 29 in FIG. 1B would be updated as a result of this logging. After completion of this step, control flows out of box 3405. The delivery instance has now been executed.

This concludes the description of the flow and other diagrams for the on demand dataset delivery processing aspect of the invention. In a preferred embodiment workflows are used to implement the process and flows described herein. Alternative embodiments use script, discrete distributed process, or a mixture of all of these. Any suitable mechanism or programming language is used to implement the flows and processes described herein.

Published U.S. patent application No. 2005/0216416 of Abrams et al., entitled “Business Method for the Determination of the Best Known Value and Best Known Value Available for Security and Customer Information as Applied to Reference Data”, and assigned to the same assignee as the present invention, is incorporated herein by reference in its entirety. This document is directed to a reference data facility that is structured to insure that no customer receives data or benefits from the knowledge of data content from a vendor with whom they do not have a contractual arrangement or to whose data they are otherwise not entitled.

The present invention can be realized in hardware, software, or a combination of hardware and software. It may be implemented as a method having steps to implement one or more functions of the invention, and/or it may be implemented as an apparatus having components and/or means to implement one or more steps of a method of the invention described above and/or known to those skilled in the art. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods. Methods of this invention may be implemented by an apparatus which provides the functions carrying out the steps of the methods. Apparatus and/or systems of this invention may be implemented by a method that includes steps to produce the functions of the apparatus and/or systems.

Computer program means or computer program in the present context include any expression, in any language, code or notation, of a set of instructions intended to cause a system having an information processing capability to perform a particular function either directly or after conversion to another language, code or notation, and/or after reproduction in a different material form.

Thus the invention includes an article of manufacture which comprises a computer usable medium having computer readable program code means embodied therein for causing one or more functions described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. An information delivery method for satisfying at least one on-demand dataset request, comprising:
processing said at least one on-demand dataset request from at least one requester;
producing at least one parsed on-demand dataset request specification;
configuring at least one on demand dataset production process to produce at least one on-demand dataset satisfying said at least one on-demand dataset request; and
executing said at least one on demand dataset production process to return said at least one on-demand dataset to said at least one requester;
wherein said on-demand dataset is limited to data derived from sources and data enhancements to which said requester is entitled.

2. A method as recited in claim 1, wherein said on demand dataset request comprises at least one on demand dataset request specification enabling said requester to specify characteristics taken from a group of characteristics comprising:
information items to be returned; selection of information items to be returned; sourcing preference to select between alternate available values; delivery mode; delivery timing; transport protocol; transport protocol ports; security tokens; preferred data format; data transformation rules; custom functions to be invoked; custom filtering rules; exception handling instructions; annotation instructions; data delivery feedback mechanism instructions; delivery endpoint; delivery intermediaries; metadata handling instructions; logging instructions; routing instructions; data merging instructions; and data splitting instructions.

3. A method as recited in claim 1, further comprising receiving information assembled in an on demand dataset from a multi-source multi-tenant data repository.

4. A method as recited in claim 1, wherein said at least one requester is taken from a group of requesters comprising:
a tenant of a multi-source multi-tenant repository;
an agent acting on behalf of said tenant;
an agent acting on behalf of said repository;
a program acting on behalf of said repository; and
a program acting on behalf of said tenant.

5. A method as recited in claim 1, further comprising using a delivery mode to deliver said at least one on demand dataset, said delivery mode including at least one delivery modality from a group of delivery modalities comprising:
quasi real time delivery; scheduled batch delivery; datamart delivery; one time query delivery; e-mail delivery; fax delivery; online delivery; printed hard copy delivery; automated voice delivery; magnetic tape delivery; optical disc delivery; digital media delivery; video delivery; and condition triggered delivery.

6. A method as recited in claim 1, wherein the configuring said at least one on demand dataset production process is enabled by employing at least one activity building block for separable steps of said at least one on demand dataset production process.

7. A method as recited in claim 6, wherein said at least one activity building block is taken from a collection of activity building blocks wherein each block enables at least one function taken from a group of functions comprising:
information element selection; sourcing selection; entitlement enforcement; data assembly; delivery scheduling; transfer protocol handling; standard format transformation; database load; custom data transformation; logging; function execution; filtering; annotating; routing; data splitting; data merging; and data transmission.

8. A method as recited in claim 1, wherein said step of configuring at least one on demand dataset production process comprises:
employing said at least one parsed on demand dataset request specification;
selecting at least one activity building block for inclusion in the on demand dataset production process, wherein said at least one activity building block satisfies at least one characteristic of said at least one parsed on demand dataset request specification;
parameterizing any selected activity building block with execution parameters; and
assembling selected parameterized activity blocks into said at least one on demand dataset production process.

9. A method as recited in claim 1, wherein the executing said on demand dataset production process includes at least one step taken from a group of steps comprising:
executing logic of an assembly flow included within said on demand dataset production process;
executing each parameterized activity building block of said on demand dataset production process as many times as indicated by said logic;
transmitting said at least one on demand dataset to said at least one requester;
recording aspects of actions taken in response to said at least one request to enable repetition of said step of executing at a later time; and
logging at least one aspect of delivery taken from a group of aspects including:
time of delivery; date of delivery; contents of delivery; requester of the delivery; mode of the delivery; size of the delivery; execution time of the delivery process; identifier of the delivery; any error of the delivery process; any warning of the delivery process; success of the delivery process; feedback of the delivery process; non-repudiation information associated with the delivery process; security features of the delivery; and said at least one on demand dataset request.

10. A method as recited in claim 1, wherein said on demand dataset request is initiated by an action taken from a group of actions comprising: a manually initiated request; an automatically initiated request; a one-time request; a data arrival event; a data availability event; a data deletion event; a data change event; a data temporal event; a scheduled request; a request received through an intermediary; and an on-line initiated request.

11. A method as recited in claim 1, the method being scalable to permit delivery of information via multiple delivery requests from multiple requesters, the method utilizing automated handling of information delivery requests, the method being specifically configured for needs of each delivery request.

12. A method for returning reference data from a multi-source multi-tenant data repository in response to requests from requesters, comprising:
receiving at least one request from a requester;
parsing said at least one request to extract the request specification;
configuring at least one workflow to deliver the requested reference data based on entitlements of said requester, as well as the selection criteria, sourcing preferences and other preferences contained in requester's request; and
executing said workflow and delivering said requested reference data to the requester.

13. A method as recited in claim 12, wherein said request specification includes at least one preference taken from a group of preferences comprising:
selection criteria; sourcing preferences; data format preferences; delivery transport preferences; and preferences particular to said requester.

14. A method as recited in claim 12, wherein the configuring includes at least one action taken from a group of actions comprising:
retrieving said requested reference data;
filtering said requested reference data; and
formatting said requested reference data.

15. An article of manufacture comprising a computer usable medium having computer readable program code means embodied therein for causing information processing, the computer readable program code means in said article of manufacture comprising computer readable program code means for causing a computer to effect the steps of claim 1.

16. An information processing apparatus for satisfying at least one on demand dataset request, comprising:
a processor for processing said at least one on demand dataset request,from at least one requester;
a computer program component executable for producing at least one parsed on demand dataset request specification;
a program configuration means for configuring at least one on demand dataset production process to produce at least one on-demand dataset satisfying said at least one on demand dataset request; and
computer code for executing said at least one on demand dataset production process to return said at least one on-demand dataset to said at least one requester;
wherein said on-demand dataset is limited to data derived from sources and data enhancements to which said requester is entitled.

17. An apparatus as recited in claim 16, wherein said processor processes an on demand dataset request comprises at least one on demand dataset request specification enabling said requester to specify characteristics taken from a group of characteristics comprising:
information items to be returned; selection of information items to be returned; sourcing preference to select between alternate available values; delivery mode; delivery timing; transport protocol; transport protocol ports; security tokens; preferred data format; data transformation rules; custom functions to be invoked; custom filtering rules; exception handling instructions; annotation instructions; data delivery feedback mechanism instructions; delivery endpoint; delivery intermediaries; metadata handling instructions; logging instructions; routing instructions; data merging instructions; and data splitting instructions.

18. An apparatus as recited in claim 16, further comprising means for receiving information assembled in an on demand dataset from a multi-source multi-tenant data repository.

19. An apparatus as recited in claim 16, further comprising means for receiving said on demand dataset request from at least one requester taken from a group of requesters comprising:
a tenant of a multi-source multi-tenant repository;
an agent acting on behalf of said tenant;
an agent acting on behalf of said repository;
a program acting on behalf of said repository; and
a program acting on behalf of said tenant.

20. An apparatus as recited in claim 16, further comprising a delivery component, wherein said delivery component including at least one delivery modality from a group of delivery modalities comprising:
quasi real time delivery; scheduled batch delivery; datamart delivery; one time query delivery; e-mail delivery; fax delivery; online delivery; printed hard copy delivery; automated voice delivery; magnetic tape delivery; optical disc delivery; digital media delivery; video delivery; and condition triggered delivery.

21. An apparatus as recited in claim 16, further comprising at least one activity building block for building separable steps of said at least one on demand dataset production process so as to configure said at least one on demand dataset production process.

22. An apparatus as recited in claim 21, wherein said at least one activity building block is taken from a collection of activity building blocks wherein each block enables at least one function taken from a group of functions comprising: information element selection; sourcing selection; entitlement enforcement; data assembly; delivery scheduling; transfer protocol handling; standard format transformation; database load; custom data transformation; logging; function execution; filtering; annotating; routing; data splitting; data merging; and data transmission.

23. An apparatus as recited in claim 16, wherein said program configuration means comprises:
means for employing said at least one parsed on demand dataset request specification;
means for selecting at least one activity building block for inclusion in the on demand dataset production process, wherein said at least one activity building block satisfies at least one characteristic of said at least one parsed on demand dataset request specification;
means for parameterizing a selected activity building block with execution parameters; and
means for assembling selected parameterized activity blocks into said at least one on demand dataset production process.

24. An apparatus as recited in claim 16, wherein the computer code for executing said on demand dataset production process includes at least one computer code component taken from a group of computer code components, comprising:
computer code for executing logic of an assembly flow included within said on demand dataset production process;
computer code for executing each parameterized activity building block of said on demand dataset production process as many times as indicated by said logic;
computer code for transmitting said at least one on demand dataset to said at least one requester;
computer code for recording aspects of actions taken in response to said at least one request to enable repetition of said step of executing at a later time; and
computer code for logging at least one aspect of delivery taken from a group of aspects including:
time of delivery; date of delivery; contents of delivery; requester of the delivery; mode of the delivery; size of the delivery; execution time of the delivery process; identifier of the delivery; any error of the delivery process; any warning of the delivery process; success of the delivery process; feedback of the delivery process; non-repudiation information associated with the delivery process; security features of the delivery; and said at least one on demand dataset request.

25. An apparatus as recited in claim 16, further comprising means for initiating said on demand dataset request in response to an action taken from a group of actions comprising:
a manually initiated request; an automatically initiated request; a one-time request; a data arrival event; a data availability event; a data deletion event; a data change event; a data temporal event; a scheduled request; a request received through an intermediary; and an on-line initiated request.

26. An apparatus for returning reference data from a multi-source multi-tenant data repository in response to requests from requesters, comprising:
means for receiving at least one request from a requester;
means for parsing said at least one request to extract the request specification;
means for configuring at least one workflow to deliver the requested reference data based on entitlements of said requester, as well as the selection criteria, sourcing preferences and other preferences contained in requester's request;
means for executing said workflow and delivering said requested reference data to the requester; and
means for limiting said on-demand dataset to data derived from sources and data enhancements to which said requester is entitled.

27. An apparatus as recited in claim 26, comprising means responsive to said request specification including at least one preference taken from a group of preferences comprising:
selection criteria; sourcing preferences; data format preferences; delivery transport preferences; and preferences particular to said requester.

28. An apparatus as recited in claim 26, wherein said means for configuring includes at least one means taken from a group of means comprising:
means for retrieving said requested reference data;
means for filtering said requested reference data; and
means for formatting said requested reference data.

29. An apparatus for returning reference data from a multi-source multi-tenant data repository in response to requests from requesters, comprising:
means for receiving at least one request from a requester;
means for parsing said at least one request to extract the request specification;
means for configuring at least one workflow to deliver the requested reference data based on entitlements of said requester, as well as the selection criteria, sourcing preferences and other preferences contained in requester's request; and
means for executing said workflow and delivering said requested reference data to the requester.

31. An article of manufacture comprising a computer usable medium having computer readable program code means embodied therein for causing information processing, the computer readable program code means in said article of manufacture comprising computer readable program code means for causing a computer to effect the steps of claim 12.
